(19) United States
(12) Patent Application Publication
(10) Pub. No.: US 2013/0246633 A1
(43) Pub. Date: Sep. 19, 2013

(54) System and method for communications

(71) Applicants: Curtis Gibbs Giesen, New York, NY (US); David Drew Pinsky, New York, NY (US)

(72) Inventors: Curtis Gibbs Giesen, New York, NY (US); David Drew Pinsky, New York, NY (US)

(21) Appl. No.: 13/573,762

(22) Filed: Oct. 3, 2012

Related U.S. Application Data
(60) Provisional application No. 61/542,788, filed on Oct. 3, 2011.
(60) Provisional application No. 61/551,911, filed on Oct. 26, 2011.
(60) Provisional application No. 61/635,891, filed on Apr. 20, 2012.
(60) Provisional application No. 61/662,348, filed on Jun. 20, 2012.
(60) Provisional application No. 61/662,347, filed on Jun. 20, 2012.
(60) Provisional application No. 61/661,339, filed on Jun. 18, 2012.
(60) Provisional application No. 61/661,805, filed on Jun. 19, 2012.
(60) Provisional application No. 61/662,116, filed on Jun. 20, 2012.

(51) Int. Cl. H04L 29/06

(52) U.S. Cl. CPC H04L 65/10
USPC 709/227

(57) ABSTRACT

A system, tool, device, method, are provided to allow for two parties to communicate with a third party observing. A communication with a specific entity is offered for sale or for auction via a website or web feed or twitter or other. Once the communication is purchased, an operator effects the connection between the parties. If the operator is human, the operator is allowed opportunity to watch and chat individually with each entity. If the operator is a voice recognition software robot or other automated device, the operator is preprogrammed with certain terms and topics and indicators that are unacceptable and require an alarm for an actual operator or halt a connection altogether, among other options.

### CROSS-REFERENCE TO RELATED APPLICATIONS

This application claims priority to U.S. Provisional Patent Application No. 61/542,788, filed on Oct. 3, 2011, entitled “Method and System for Communications,” U.S. Provisional Patent Application No. 61/551,911, filed on Oct. 26, 2011, entitled “Method and System for Communications Interface,” U.S. Provisional Patent Application No. 61/635,891, filed on Apr. 20, 2012, entitled “Method and System for Communications,” U.S. Provisional Patent Application No. 61/661,339, filed on Jun. 18, 2012, entitled “Method and System for Communications,” U.S. Provisional Patent Application No. 61/661,805, filed on Jun. 19, 2012, entitled “Method and System for Communications,” U.S. Provisional Patent Application No. 61/662,347, filed on Jun. 20, 2012, U.S. Provisional Patent Application No. 61/662,348, filed on Jun. 20, 2012, U.S. Provisional Patent Application No. 61/662,116, filed on Jun. 20, 2012, each of which is herein incorporated by reference in its entirety.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### SUMMARY

An embodiment of the present invention enhances the overall efficiency and functionality of the entity experience with communication systems by introducing systems, devices, and methods for communications and payment, in a secure, safe manner. An embodiment of the present invention provides capability for a user to interact with Internet, Wi-LAN, and cellular communications systems, as well as other systems available.

An embodiment of the present invention provides a system and method for providing a secure communication of two entities and an operator via video and audio streaming, video and audio recording, and chat functions. An embodiment of the present invention provides a system and method for providing a peer-2-peer communication in which the video-audio stream is effected so that two entities can view and hear each other, and a third entity can participate in the video-audio stream as well in a specific capacity.

An embodiment of the present invention provides for a two-way conversation between two persons, with an operator being able to watch and hear the entire two-way conversation.

An embodiment of the present invention provides a system and method for providing a peer-2-public communication in which the video-audio stream is broadcast so that multiple users at one end of the transmission path can watch. In an embodiment, the transmission occurs via the Wowza server.

In an embodiment of the present invention, there is never any three way conversation, just individually between Operator and the VIP or Guest. The operator does not interfere unless a participant hits “operator assistance”. In an embodiment, the Operator serves as a concierge and/or security detail.

In an embodiment of the present invention, a VIP or Guest may purchase the meeting with the VIP as a gift or video autograph. Further, in embodiments of the present invention, a Guest or VIP or potential Guest can put links via their social network pages and feeds. Further, a Guest or VIP may display the recorded video session or “souvenir” on their social network page, Instagram, Twitter, post to Youtube, or the like.

In embodiments of the present invention, operators are available for when Guests have paid for an upcoming communication with a VIP or at other times, e.g., a relatively immediate timing situation.

In embodiments of the present invention, an email address or other identifier or identifier contact information is provided by the user or Guest at the start or in the near beginning of the Greenroom communication process or system.

Embodiments of the present invention provide for an open and automated platform for access to persons such as experts, celebrities, doctors, among others.

In an embodiment of the present invention, a dating site operates using the operator tool embodiment(s) described herein. Such a system and method allows for two persons to meet securely in a video chat along with a monitoring operator or chaperone. In an embodiment of the present invention, company talks and conferences can be transmitted, along with an operator who ensures that the communication occurs as seamlessly as possible. In embodiments of the present invention, the operator tool, system, device can be used in other ventures and venues as well.

In embodiments of the present invention, other implementations of the “have a conversation” mechanism are provided that are not P2P based. For example, the advantages of such system(s) can allow for easier support of mobile/iPad application development and firewall blocking issues.

In embodiments of the present invention, the “Talk Now” features provides for an entity to offer a chat or communication in short time, unlike the previously pre-scheduled meetings. The “Talk Now” communication can be paid via an auction of the moment, or via a straight payment of what the chat-offering entity decided was appropriate to charge. Once a second entity accepts the Talk Now, the second entity is assigned a user identification, and then transferred outside the Greenroom system to a financial processing center which intakes the user id, and then requests additional information from the purchasing entity in order to effect payment. For example, a credit card number or bank routing information or Paypal information is provided by the purchasing entity. Once the payment is in effect, the purchasing entity is returned to the Greenroom system with its associated user id and a transaction id to identify payment.

### BRIEF DESCRIPTION OF THE DRAWINGS

FIG. 1 shows an example diagram according to an embodiment of the present invention.

FIG. 2 shows an example diagram according to an embodiment of the present invention.

FIG. 3 shows an example diagram according to an embodiment of the present invention.

FIG. 4 shows an example diagram according to an embodiment of the present invention.

FIG. 5 shows an example session from the moderator interface according to an embodiment of the present invention.

FIG. 6 shows a flowchart of an example dynamic talk session according to an embodiment of the present invention.

FIG. 7A shows a flowchart of a click through of the system pages.

FIG. 7B shows a flowchart of a click through of the system pages.

FIG. 7C shows a flowchart of a click through of the system pages.

FIG. 8 shows a flowchart of a click through of the system pages.

FIG. 9A shows a flowchart of a click through of the system pages.

FIG. 9B shows a flowchart of a click through of the system pages.

FIG. 10 shows a flowchart of a click through of the system pages.

FIG. 11 shows an embodiment of a site map of a home page.

FIG. 12 shows an embodiment of a site map of an account page.

FIG. 13 shows an embodiment of a site map of a conversations action in the home page.

FIG. 14 shows an embodiment of a process for registering an account.

FIG. 15 shows an embodiment of a process for accepting a requested conversation.

FIG. 16 shows an embodiment of a process for rejecting a requested conversation.

FIG. 17 shows an embodiment of a process for accepting or rejecting a requested conversation.

FIG. 18 shows an embodiment of a process for bidding on a conversation.

FIG. 19 shows an embodiment of a process for searching and bidding on a conversation.

FIG. 20 shows an embodiment of a process for auctioning a conversation.

FIG. 21 shows an embodiment of a process for creating conversation alerts.

FIG. 22 shows an embodiment of a process for accepting or rejecting pending conversations.

FIG. 23 shows an embodiment of a process for verifying a registration of an account.

FIG. 24 shows an embodiment of a process for logging into an account to make a bid or offer a conversation.

FIG. 25 shows an embodiment of a process for logging into an account to make a bid or offer a conversation.

FIG. 26 shows an embodiment of a process for authenticating a login attempt.

FIG. 27 shows an embodiment of a process for accessing a user profile.

FIG. 28 shows an embodiment of a process for offering a conversation for auction.

FIG. 29 shows an embodiment of a process for offering a conversation for fixed bid.

FIG. 30 shows an embodiment of a process for offering a conversation.

FIG. 31 shows an embodiment of a process for logging into an account.

FIG. 32 shows an embodiment of a process for creating a public profile.

FIG. 33 shows an embodiment of a process for setting a profile as public or private.

FIG. 34 shows an embodiment of a process for logging into an account.

FIG. 35 shows an embodiment of a process for accessing frequently asked questions.

FIG. 36 shows an embodiment of the GreenRoom home page.

FIG. 37 shows an embodiment of a registration page.

FIG. 38 shows an embodiment of a log-in page using Facebook.

FIG. 39 shows an embodiment of a registration confirmation page.

FIG. 40 shows an embodiment of a confirmation page after a user completes registration.

FIG. 41 shows an embodiment of an error page.

FIG. 42 shows an embodiment of an account setup page.

FIG. 43 shows an embodiment of a confirmation page after submitting user account information.

FIG. 44 shows an embodiment of an account setup page.

FIG. 45 shows an embodiment of a profile creation page.

FIG. 46 shows an embodiment of a confirmation page after submitting user account and profile information.

FIG. 47 shows an embodiment of a sign-in page for a registered user.

FIG. 48 shows an embodiment of a search bar provided on the page.

FIG. 49 shows an embodiment of suggesting an expert and/or celebrity.

FIG. 50 shows an embodiment of a “Happening Now” page.

FIG. 51A shows an embodiment of a “Live, Breaking Conversations” page.

FIG. 51B shows an embodiment of a “Live, Breaking Conversations” page.

FIG. 52A shows an embodiment of how to find an expert and/or celebrity.

FIG. 52B shows an embodiment of how to find an expert and/or celebrity.

FIG. 53 shows an embodiment of how a user searches conversations.

FIG. 54 shows an embodiment of an offer details page.

FIG. 55 shows an embodiment of a review page a user sees prior to submitting a bid.

FIG. 56A shows an embodiment of a credit card information page after submitting the bid.

FIG. 56B shows an embodiment of a credit card information page after submitting the bid.

FIG. 57A shows an embodiment of a public profile page for an expert and/or celebrity.

FIG. 57B shows an embodiment of a public profile page for an expert and/or celebrity.

FIG. 58 shows an embodiment of a page to begin a conversation with an expert and/or celebrity.

FIG. 59 shows an embodiment of a video call conversation page of a user.

FIG. 60 shows an embodiment of a video call conversation page of an expert and/or celebrity.

FIG. 61 shows an embodiment of a Thank You screen at the end of the conversation.

FIG. 62 shows an embodiment of an account page for experts, celebrities, and/or guests.

FIG. 63 shows an embodiment of a calendar page for experts, celebrities, and/or guests.

FIG. 64A shows an embodiment of a page for an expert and/or celebrity to offer a conversation.

FIG. 64B shows an embodiment of a page for an expert and/or celebrity to offer a conversation.

### DETAILED DESCRIPTION

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

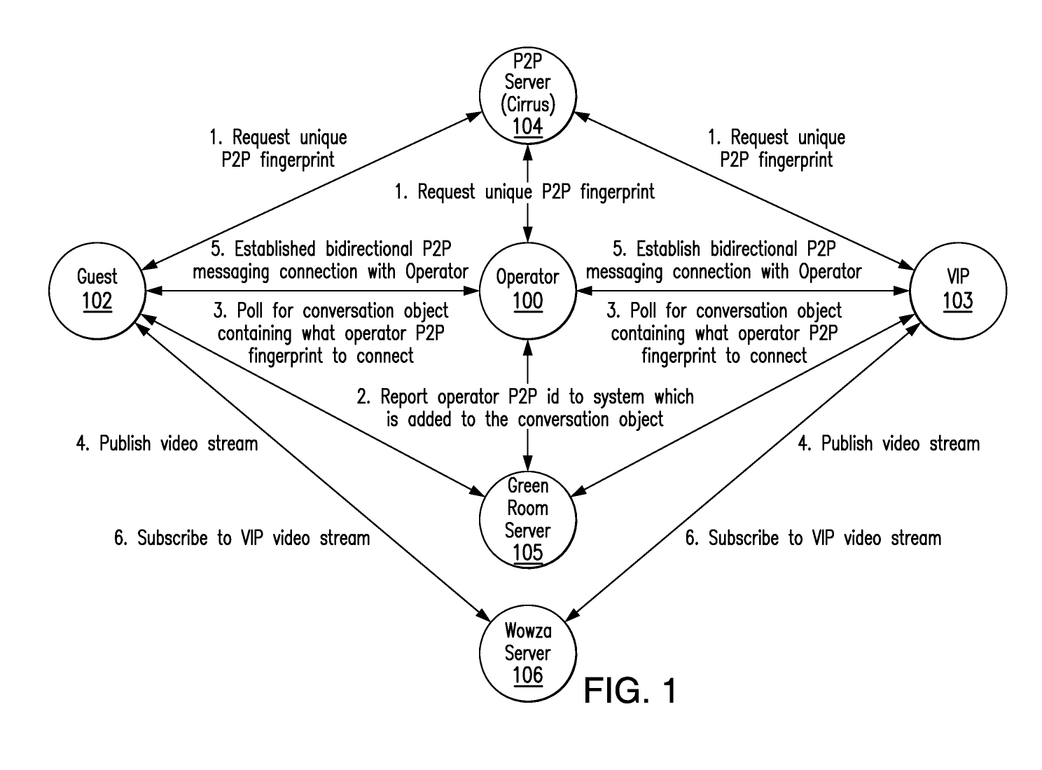

FIG. 1 shows an embodiment for a backend system, device, and method, for communications involving an operator or moderator. In FIG. 1, Guest 102, Operator 100, and VIP 103, request a unique p2p fingerprint ID from P2P Server 104. Operator 100 reports its P2P ID to GreenRoom Server 105, which adds the ID to the conversation object. The Guest 102 and VIP 103 then poll the GreenRoom Server 105 for the conversation object containing what operator P2P fingerprint they should connect to. The GreenRoom Server 105 replies with the Operator 100 ID. Guest 102 and VIP 103 publish their individual video streams to the Wowza Server 106. Guest 102 and VIP 103 then initiate a one way call to Operator 100 ID, which Operator 100 accepts, which establishes a biderectional P2P message connection. Operator 100 then sends P2P text message to Guest 102 and VIP 103 instructing them to subscribe to each other's streams. Guest 102 and VIP 103 subscribe to each other's video streams on the Wowza Server 106, connecting the video call.

In an alternative embodiment, an Operator 100 is connected to Guest 102 (e.g., entity who purchases access/communication with a VIP or other entity) by establishing a bidirectional Peer-to-Peer (P2P) messaging connection. An Operator 100 is also connected to VIP 103 (e.g., entity whose time/access is offered for auction/sale/donation/gift; here, the VIP may be a celebrity, a sports star, a Youtube star, a CEO or other business person, a model, a doctor, a scientific expert, a person, a thing, etc.) by establishing a bidirectional P2P messaging connection. The Greenroom server 105 is associated with each of the Guest 102, VIP 103, and Operator 100. The Operator 100 P2P id is reported to a system and which is added to the conversation object. The conversation object is stored or accessible by the Greenroom server 105. The Guest 102 polls the Greenroom server 105 for the conversation object which contains the Operator P2P fingerprint to establish the connection securely. The VIP 103 polls the Greenroom server 105 for the conversation object which contains the Operator 100 P2P fingerprint for the connection. The P2P server 104 (e.g., a Cirrus system) identifies unique P2P fingerprints for each of the Guest 102, the Operator 100, and the VIP 103. Upon secure connection, the Operator 100 can allow for the videostream to flow. The Guest 102 is associated with the Wowza server 106, provided by Amazon.com. The Guest 102 subscribes to the VIP videostream, and once the connection is allowed, the videostream is then published from the Wowza server 106 to the Guest 102. The VIP 103 is associated with the Wowza server 106, provided by Amazon.com. The VIP 103 subscribes to the Guest videostream [FIG. 1 contains a typo and should read VIP subscribes to the Guest videostream], and once the connection is allowed, the videostream is then published from the Wowza server 106 to the VIP 103.

The use of the term “Operator” is used in some embodiments herein to depict a moderator or supervisor or witness of a conversation. Please note that in an embodiment of the present invention, the Operator may be a person. In an embodiment, the Operator may be a processor or other automated tool or device reacting to predefined conditions.

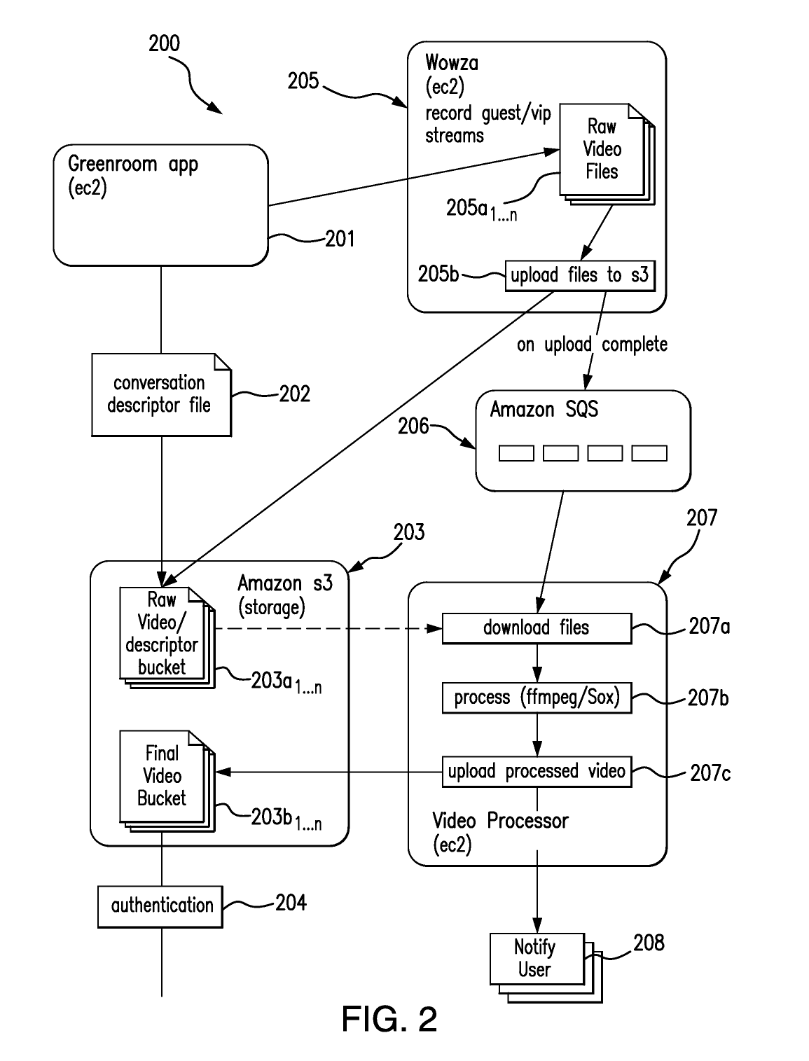

FIG. 2 shows a flowchart of the backend video processing architecture according to an example embodiment of the present invention. Specifically, the Greenroom application 201 sends a conversation descriptor file 202 to the Amazon.com storage server or device or cloud 203. The conversation descriptor file 202 is then put into a raw video and/or descriptor “bucket” 203a. The Greenroom application 201 is also associated with the Amazon.com Wowza server 205. The Wowza server 205 records the Guest and/or VIP communication streams and is stored as raw video files 205a in the Wowza server 205 or in an associated storage device or cloud. The raw video file(s) 205a are then transmitted in order to be uploaded 205b to the Amazon.com storage 203. Once the upload is complete, the files are sent to Amazon Simple Queue Service (SQS) 206 which provides a hosted queue for storing messages as they are being transmitted between computers or other devices, allowing for building an automated workflow. The files are transmitted to the Video Processor 207 in which the files are downloaded 207a, processed 207b, and then the processed video is uploaded 207c to the final video bucket 203b in the Amazon.com storage 203. An authentication procedure is then effected 204. The video processor 207 can be arranged to notify a user or a Guest 208 that the video souvenir or final video file is ready for transmission or is being transmitted.

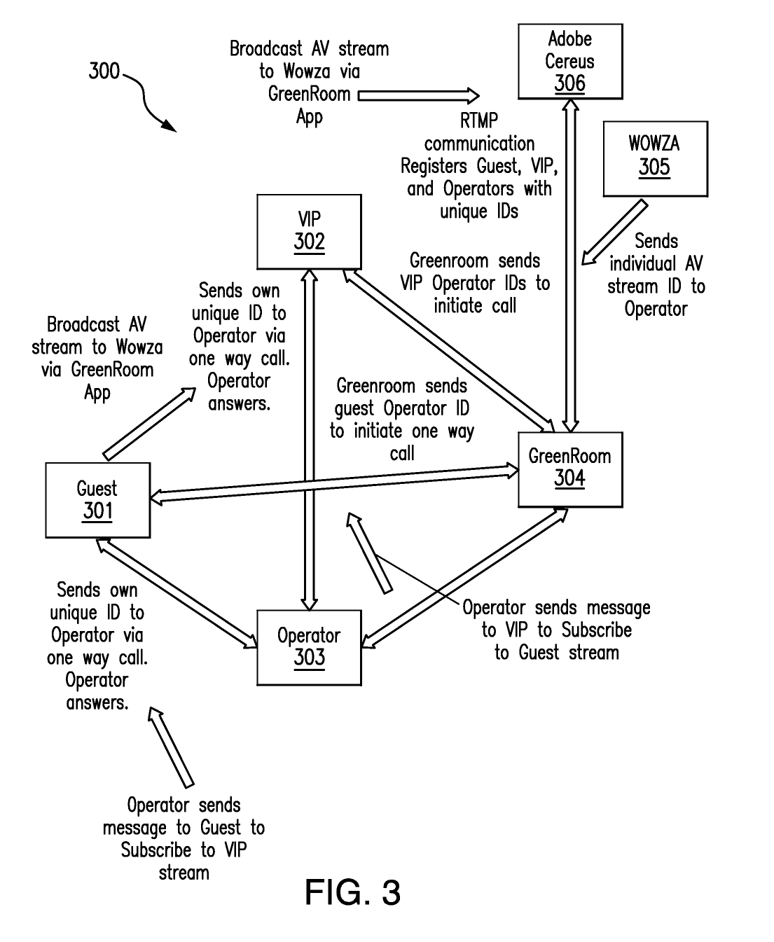

FIG. 3 shows an example embodiment of a backend side of the operator device, system, and method. In FIG. 3, the GreenRoom Server 304 registers Guest 301, VIP 302, and Operator 303 with Adobe Cirrus Server 306 via an RTMP communication and receives unique IDs for each. The GreenRoom Server 304 sends the Guest 301 and the VIP 302 the Operator 303's unique ID, and then Guest 301 and VIP 302 send Operator 303 their unique IDs, who then establishes a p2p connection. Once the P2P connection is established, guest 302 and Vip 302 broadcast their audio/visual streams to WOWZA server 305. WOWZA 305 sends individual AV streams of guest 301 and VIP 302 to Operator 303. Operator 303 then sends p2p text message to VIP 302 and guest 301 instructing them to subscribe to each other's AV streams. Guest 301 and VIP 302 know each other's stream names, as they are sent to each from the GreenRoom server 304.

Operator Device and Method Embodiment (See Figure with Block Arrows): Stream 1: P2p Connection, RTMP, Message Stream

When the user and VIP connect to the greenroom app, there is a p2p connection set up with the adobe cereus server that registers the Guest, VIP, and Operator with a unique ID. Once registered, the Greenroom app sends the guest and VIP the Operator's ID. The VIP and Guest send their ID to the operator with a one way call. The Operator then connects to each of them individually, establishing a p2p connection.

Stream 2: Broadcast, AV Stream

Guest and VIP broadcast their AV streams to the Wowza server. Even if there is no operator available this would take place, its just no one could access it as a safety precaution. When the operator clicks the button to connect the calls it sends a message to the guest and VIP to subscribe to each other's streams. For example, the GreenRoom app does use the Secure Token add on with the Wowza Server for stream authentication. This is in addition to the tokens that the app assigns to Guests, VIPs, and Operators itself.

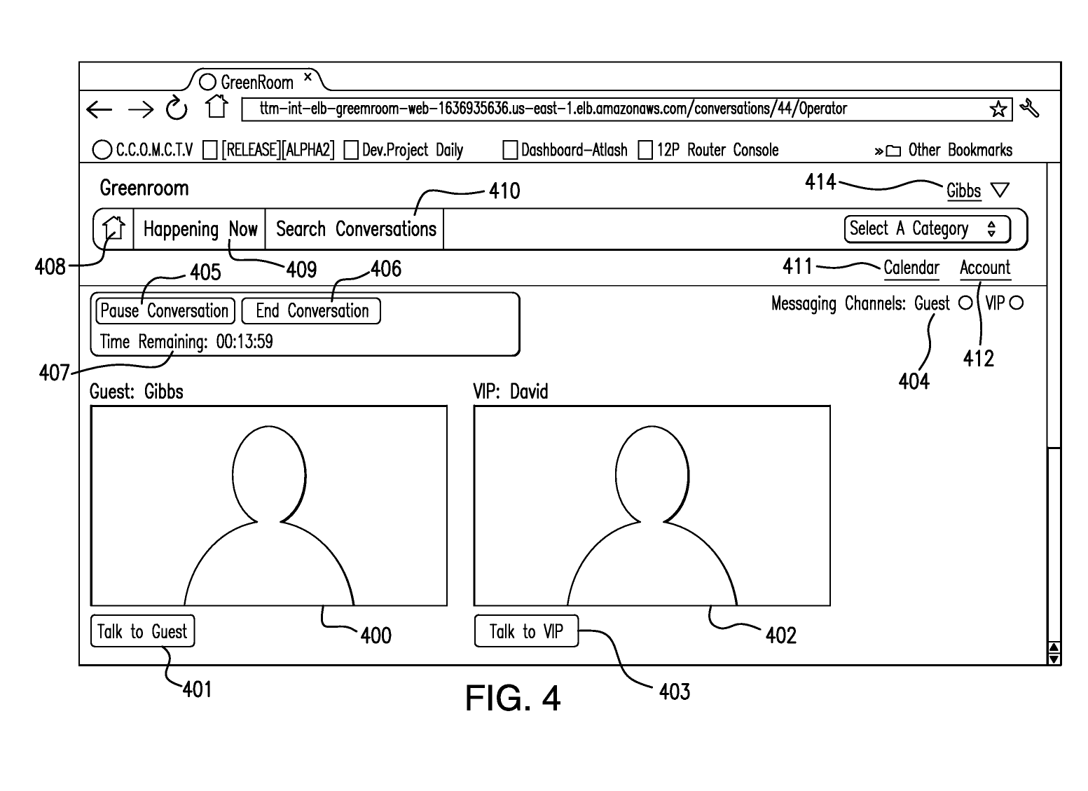

FIG. 4 shows a screenshot of the Operator user interface. For example, a Guest named Gibbs is displayed in a first screen 400. A button 401 is provided just below the Guest screen 400 to allow the Operator to talk to the Guest. When the Operator presses the button 401 to talk with the Guest, the VIP is effectively “on hold” and does not hear the communication between the Operator and the Guest. Likewise, when the Operator presses the button 403 to talk with the VIP pictured in the second screen 402, then the Guest is effectively “on hold” and does not hear the communication between the VIP and the Operator. In this example Operator interface, a “place conversation” button 405 begins the connection of the video and audio feeds between the VIP and the Guest. The “end conversation” button 406 ends the connection of the video and audio feeds between the VIP and Guest. A time clock or unit measurement indicator 407 is displayed for information to the Operator. The interface also provides a link 414 of the Guest's/VIP's name so that the Guest/VIP can track his/her account and schedule information. There is a button for the Guest's/VIP's calendar 411 and account 412 for easy access by the Guest/VIP, respectively. There are additional buttons including a homepage 408 button to bring one to the Greenroom homepage, a Happening Now 409 button to bring a user to current activity, and a Search Conversations 410 to bring a user to search engine access for finding a specific conversation or other.

In an embodiment such as FIG. 4, an operator or moderator has a dual screen showing the Guest and the VIP. This allows the operator to see what is happening at both ends of the communication. For example, if the Guest or the VIP has a mute button on, the Operator may notice this limit in the communication, and can press the message button to alert the appropriate entity accordingly. In this embodiment example, the screen includes two video feeds and a feature for the operator to speak separately to each entity. In an embodiment, the operator may pull up a conversation in browser. The conversation, however, does not begin until the operator sees the participants, who are verified through security measures, and are ready. The operator then permits the conversation. This operator feature can be done by an automatic device or robot such that specific events would be checked and tested. In embodiments, the operator can pause the communication to talk to one or both of the participants individually on the video chat or call. In an embodiment, when the communication is halted, then the time stops automatically to preserve the Guest's purchased time segments. The time starts again when the communication between the Guest and the VIP is on. For the souvenir discussed later—i.e., the video recording of the conversation—the “stopped” or “halted” time is not included. Instead, that portion is either not recorded or is stitched out, and a counter keeps track of the timing, for example,

In an embodiment, if there is any abuse of the system or of the VIP or Guest, the Operator can end the call promptly.

In an embodiment, a high quality video is displayed via a web browser to the Operator who can observe both parties in a conversation. No download is required of the Operator.

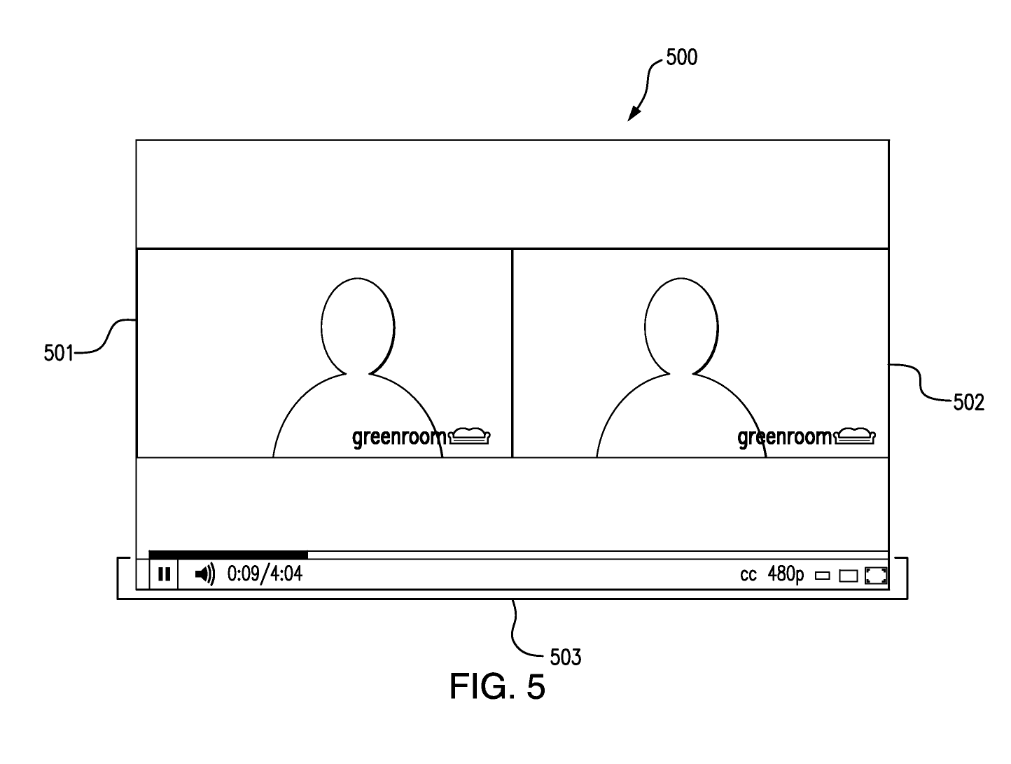

FIG. 5 shows a stitched souvenir 500. When a Guest and a VIP have concluded their communication, if the conversation has “public” access, then a video souvenir is prepared. The video souvenir 500 is a stitched together recording of both the Guest and VIP views 501, 502, such that when played, the conversation or other communication are in sync with each other. At the bottom 503 of the video souvenir may be a time/unit indicator of the length of the recorded communication, a selection to increase and/or decrease the size of the video displayed, etc.

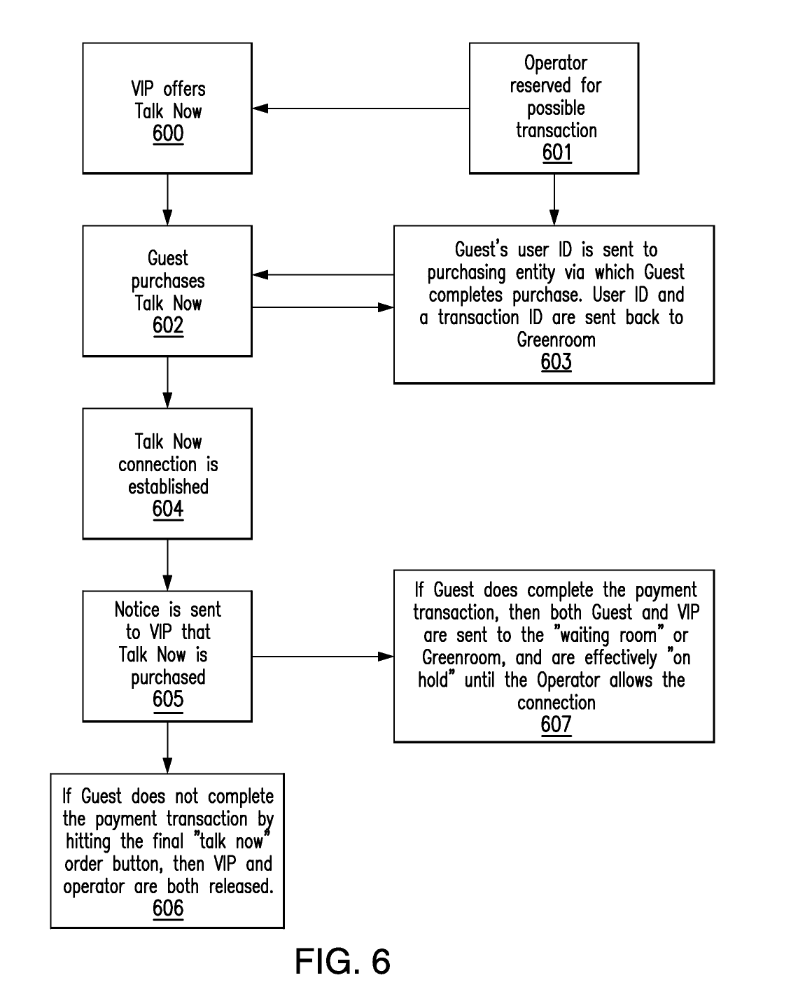

In FIG. 6, a VIP offers an “instant” or “dynamic” talk session without the usual pre-arranged efforts. That is, for example, a VIP has some downtime between flights or scenes and is available to talk with a Guest. In this manner, a VIP can earn money for him/herself or for a charity, during small increments of downtime when they occur. Once a VIP offers a Talk Now opportunity 600, then an operator is reserved for the possible transaction 601. In an alternative embodiment, the operator is not reserved so quickly in the process, and instead is reserved later once a Guest initiates purchase of the Talk Now opportunity, or after the Guest has finished payment of the Talk Now activity or any other suitable time.

The Guest then is forwarded as a user id to a purchasign body which effects the payment from the Guest. The purchasing entity transmits back the user is associated with a transaction id roving payment. The Guest then purchases the Talk Now with the VIP 602. The Operator established the connection 604. The Notice is sent to the VIP that the Talk Now has been purchased, In embodiments, the VIP is given a buffer time of some minutes, e.g., 5 to 10 minutes. In the event the VIP becomes occupied and does not indicate that the VIP is ready for the connection, then a certain time limit is imposed and the Guest will be released upon expiration of the waiting time. In an embodiment, fees are imposed upon the entity who caused the waiting time, and may be withdrawn by the same purchasing company once the Greenroom transmits the user's ID to the purchasing entity with instructions to extract an additional payment. In an embodiment, if the Guest does complete the payment transaction and both entities are available, then both the Guest and VIP are sent to the “waiting room” or Greenroom, and are effectively “on hold” until the Operator allows the connection to be established 607.

In an embodiment of the present invention, the Operator can decide to continue recording the session even if one entity is on hold, for security reasons. In embodiments of the present invention, only the operator can pause the communication feed. In embodiments of the present invention, the operator does not have video feed. In embodiments of the present invention, the operator does not have audio feed with the different entities. In embodiments of the present invention, the operator can message chat with one or both entities without pausing the video-audio connection between the VIP and Guest.

In embodiments of the present invention, the video souvenir is a stitch of two recorded video feeds. In embodiments, the recording can be made available for public download. In embodiments of the present invention, when an operator sees that a party is not within the range of the camera, then the operator can put the communication on hold until the party returns, if ever. In embodiments of the present invention, there are charges for the auction to have a conversation prearranged with a VIP, there are charges for coming late or missing or rescheduling conversations.

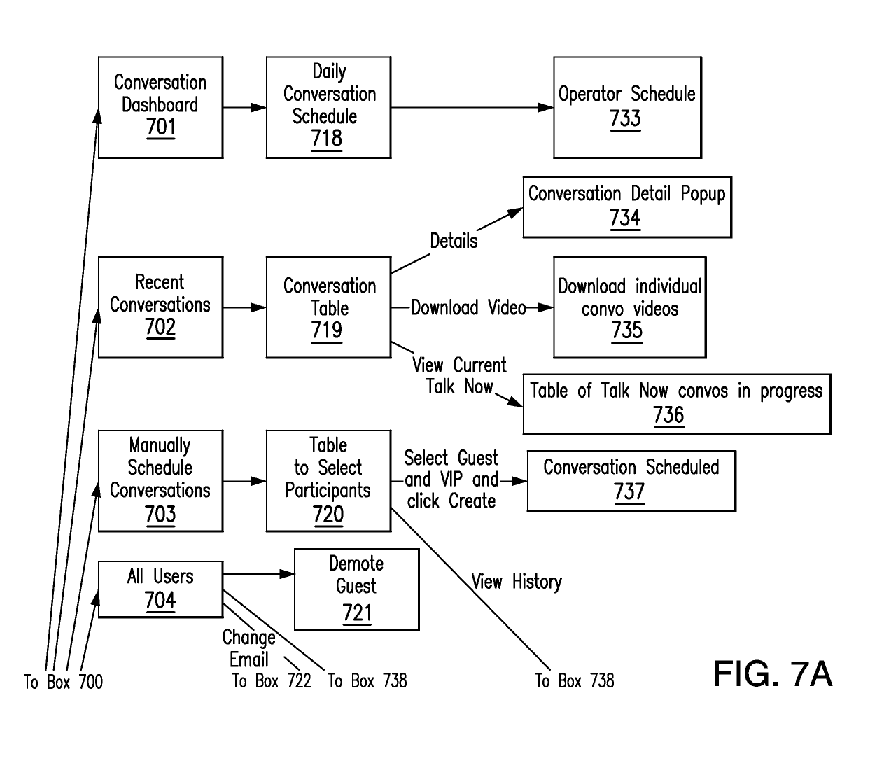

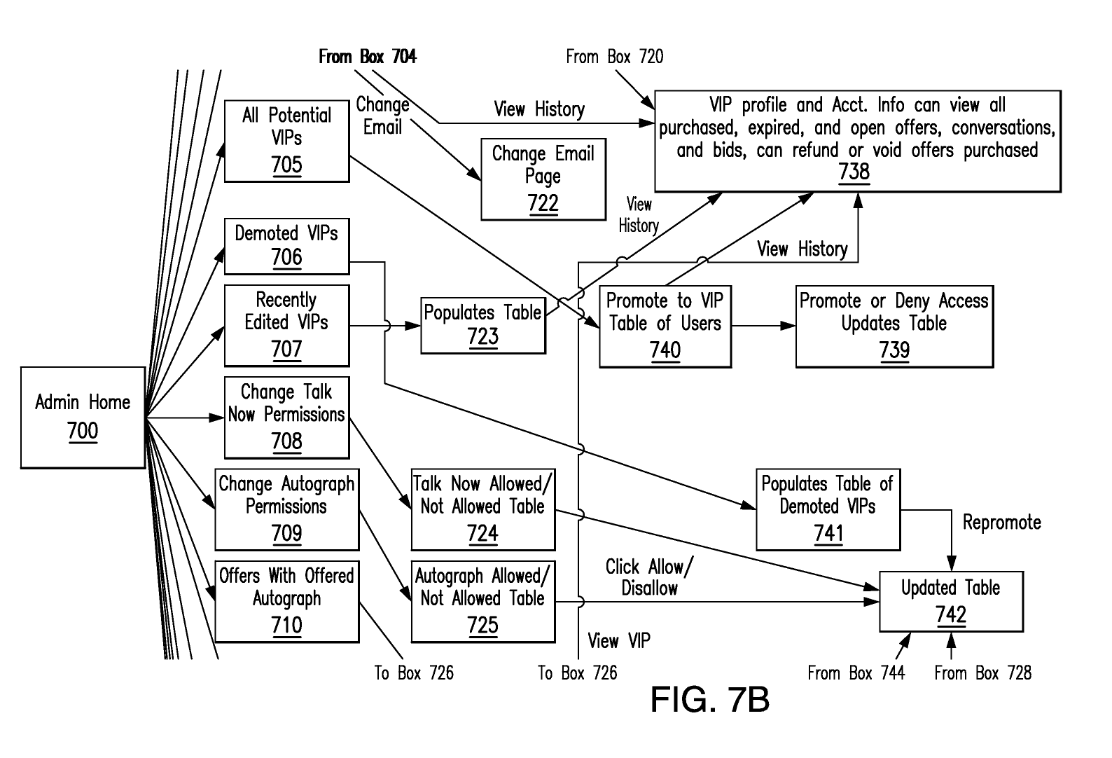

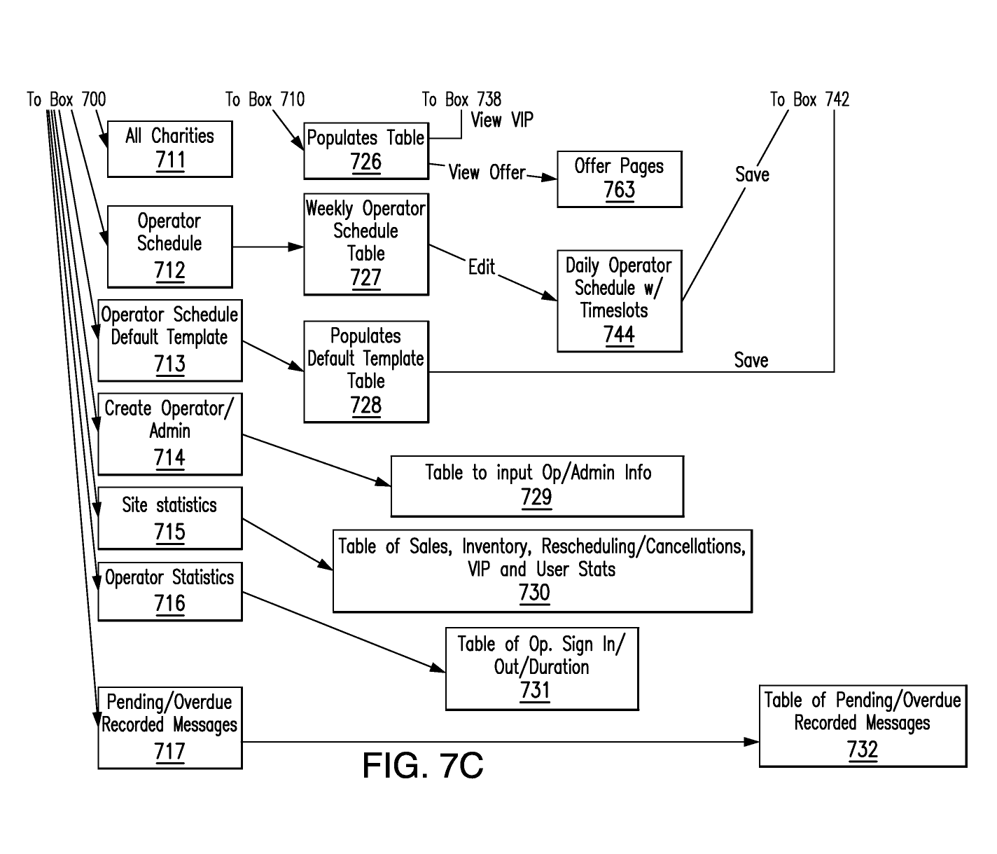

In FIG. 7, Admin clicks on Conversation Dashboard 701 from Admin Home 700. Admin can then click Daily Donversation Schedule 718 and then click on Operator Schedule 733. Admin can click on Recent Conversations 702 from Admin Home 700. Admin can then view Conversation Table 719 and click on Conversation Detail Popup 734 or Download Video 735 or View Current Talk Now 736.

Admin can click on Manually Schedule Conversations 703 from Admin Home 700. Table to Select Participants 720 populates. Admin selects Guest and VIP and clicks Create. The conversation is then scheduled 737. From Table to Select participants 720 admin can also view history and is taken to VIP profile 738.

Admin can click on All Users 704 from Admin Home 700. Admin can then Demote Guest 721 or view history and go to VIP profile 738. Admin can also change email 722 from All Users 704. Admin can click on All Potential VIPs 705 from Admin Home 700. Admin then goes to Promote to VIP Table 740 and can then Promote or deny access 739. Admin can click on Demoted VIPs 706 from Admin Home 700. Admin goes to Table of Demoted VIPs 741 and can then Repromote to update table 742. Admin can click on Recently Edited VIPs 707 from Admin Home 700. Populates Table 723. Admin can then view VIP profile 738.

Admin can click on Change Talk Now Permissions 708 from Admin Home 700. Goes to Talk Now Allowed/Not Allowed Table 724. Admin can click allow or not allowed to update table 742. Admin can click on Change Autograph Permissions 709 from Admin Home 700. Goes to Autograph Allowed/Not Allowed Table 724. Admin can click allow or not allowed to update table 742. Admin can click on Offers With Offered Autograph 710 from Admin Home 700. Populates table 726. Admin can view VIP profile 738 or Offer Page 743. Admin can click on All Charities 711 from Admin Home 700. Admin can click on Operator Schedule 712 from Admin Home 700.

Populates Weekly Operator Schedule Table 727. Admin can click Edit to get Daily Operator Schedule 744, then Save to Update Table 742. Admin can click on Operator Schedule Default Template 713 from Admin Home 700. Populates Default Template 728. Admin can change fields and click Save to Updated Table 742.

Admin can click on Create Admin/Operatior 714 from Admin Home 700. Populates Table to input Operator or Admin Info 729. Admin can click on Site Statistics 715 from Admin Home 700. This populates Table of Sales 730. Admin can click on Operator Statistics 716 from Admin Home 700. This populates Table of Operator Sign In 731. Admin can click on Pending/Overdue Recorded Messages 717 from Admin Home 700. This populates table of pending/overdue recorded messages 732.

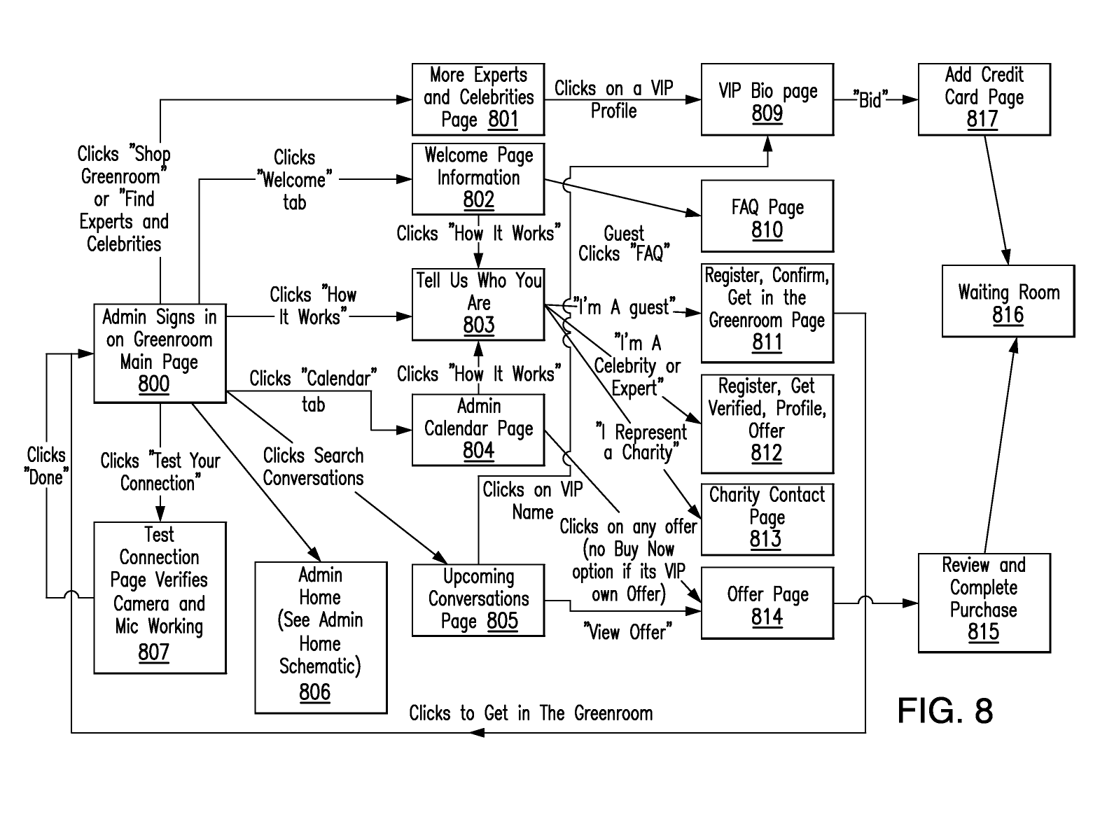

In FIG. 8, Admin (e.g., acting administrator for the service provider) signs in on GreenRoom Main Page 800. Admin Clicks “Test Your Connection,” Test Connection Page Verifies Camera and Mic Working 807. Admin clicks done and is sent to Main page 800. Admin Clicks “Shop Greenroom” or “Find Experts and Celebrities,” and is sent to More Experts and Celebrities Page 801. Admin can then click on a VIP Profile, and Admin is sent to VIP Bio page 809. Admin can then click Bid and guest is sent to Add Credit Page 817. After adding credit card and purchasing, admin is sent to Waiting Room 816. Admin clicks Welcome tab from Main Page 800 and is sent to Welcome Page Information 802. Admin can then click FAQ and is sent to FAQ page 810.

Admin can also click How It Works from Welcome Page 802 and is sent to Tell Us Who you are page 803. Admin can then click I'm a Guest and is sent to Register, Confirm, Get in the Greenroom page 811. After Registering, and confirming, Admin can click get in the Greenrrom and is sent to Main Page 800. From Tell Us Who You Are page 803 admin can also click I'm a Celebrity or Expert and is then sent to the Register, Get Verified, Profile, Offer page 812. From Tell Us Who You are page 803 guest can also click I Represent a Charity and is sent to Charity Info Page 813.

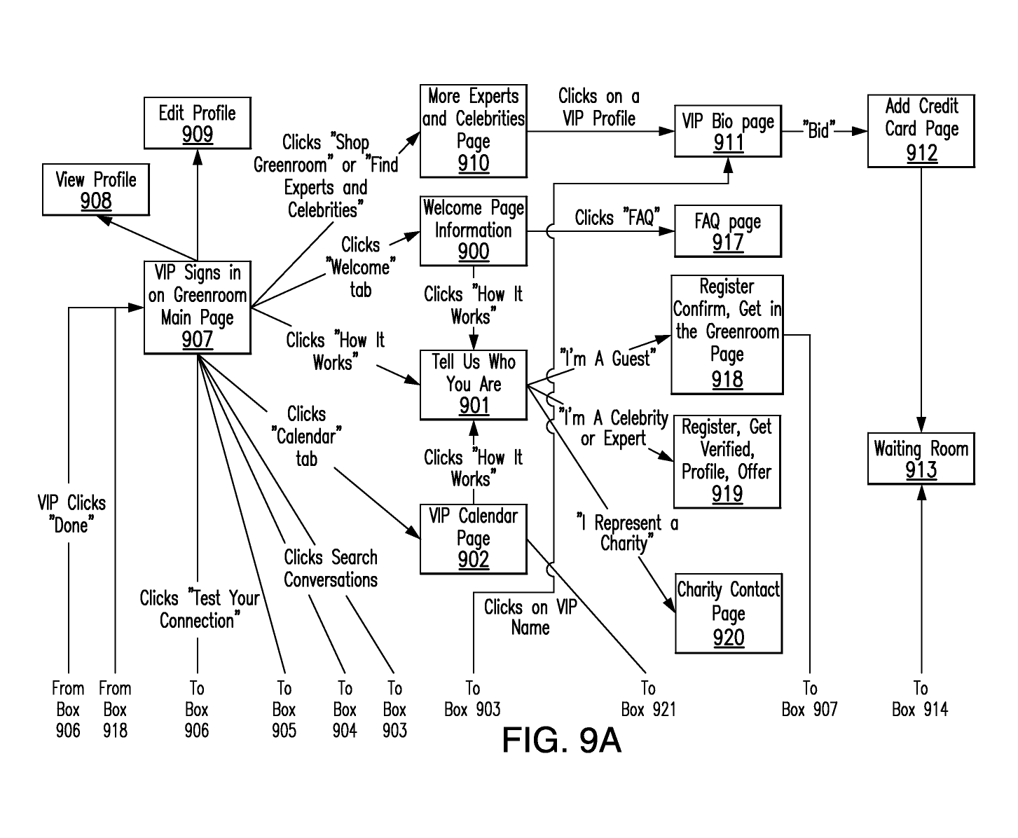

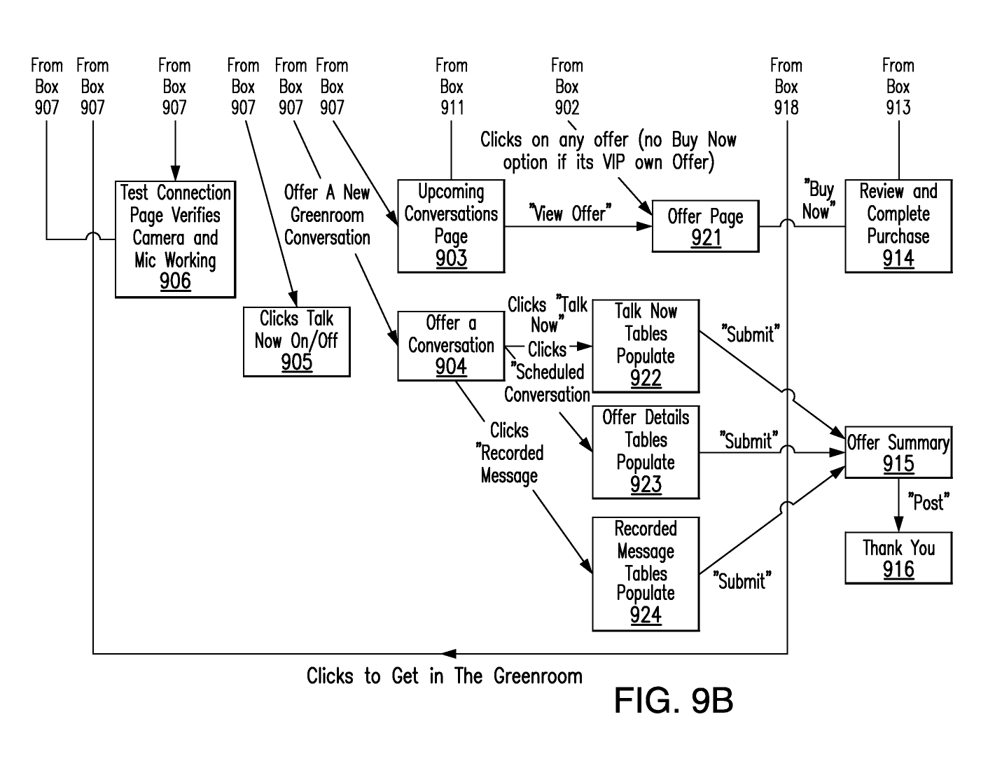

Admin clicks How It Works from Main page 800 and is sent to Tell Us Who You Are 803. Admin Clicks Calendar from main Page 800 and is sent to Admin Calendar page 804. Admin Clicks View Offer and is sent to Offer page 814. Guest can click Buy Now and is sent to Review and Complete Purchase 815. Admin completes purchase and is sent to Waiting Room 816. Admin can also click Learn How it works from Calendar page 804 and is sent to Tell Us Who You Are page 803. Admin can also click Find Experts And Celebrities from Calendar page 804 and is sent to More Experts and Celebrities Page 801. Admin Clicks Search Conversations from Main Page 800 and is sent to Upcoming Conversations page 805. Admin clicks View Offer and is sent to Offer Page 814. Admin clicks Admin Home and is sent to Admin Home 806. In FIG. 9, the VIP signs in on the GreenRoom Main Page 907, VIP Clicks “Test Your Connection,” Test Connection Page Verifies Camera and Mic Working 906. VIP clicks done and is sent to main page 907. VIP clicks View Profile 908 to view profile. From main page 907 VIP clicks Edit Profile 909 to edit. From main page 907 VIP Clicks “Shop Greenroom” or “Find Experts and Celebrities,” and is sent to More Experts and Celebrities Page 910. VIP can then click on a VIP Profile, and is sent to VIP Bio page 911. VIP can then click Bid and is sent to Add Credit Page 912. After adding credit card and purchasing, VIP is sent to Waiting Room 913.

VIP clicks Welcome tab from Main Page 907 and is sent to Welcome Page Information 900. VIP can then click FAQ and is sent to FAQ page 917.

VIP can also click How It Works from Welcome Page 900 and is sent to Tell Us Who you are page 901. VIP can then click I'm a Guest and is sent to Register, Confirm, Get in the Greenroom page 918. After Registering, and confirming, VIP can click get in the Greenroom and is sent to Main Page 907. From Tell Us Who You Are page 901 VIPt can also click I'm a Celebrity or Expert and is then sent to the Register, Get Verified, Profil, Offer 919. From Tell Us Who You are page 901 VIP can also click I Represent a Charity and is sent to Charity Info Page 920.

VIP clicks How It Works from Main page 901 and is sent to Tell Us Who You Are 901.

VIP Clicks Calendar from main Page 907 and is sent to VIP Calendar page 902. VIP Clicks View Offer and is sent to Offer page 921. VIP can click Buy Now and is sent to Review and Complete Purchase 914. VIP completes purchase and is sent to Waiting Room 913. VIP can also click Learn How it works from Calendar page 902 and is sent to Tell Us Who You Are page 901. VIP can also click Find Experts And Celebrities from Calendar page 902 and is sent to More Experts and Celebrities Page 910.

VIP Clicks Search Conversations from Main Page 907 and is sent to Upcoming Conversations page 903. VIP clicks View Offer and is sent to Offer Page 921. From Upcoming Conversations page 903 VIP can also click on VIP Name and go to VIP Bio page 911.

From Main Page 907 VIP clicks Offer a New greenRoom Conversation and goes to Offer a Conversation page 904. VIP can Click Talk Now and Talk Now tables populate 922. VIP can click submit and go to Offer Summary 915. Then click Post and go to a thank you page 916. From Main page 907 and Offer a New greenRoom Conversation VIP goes to Offer a Conversation page 904. VIP can Click Scheduled Conversation and Offer Details tables populate 923. VIP can click submit and go to Offer Summary 915. Then click Post and go to a thank you page 916. From Main page 907 and Offer a New GreenRoom Conversation VIP goes to Offer a Conversation page 904. VIP can Click Recorded Message and Recorded Message tables populate 924. VIP can click submit and go to Offer Summary 915. Then click Post and go to a thank you page 916.

From Main page 907 VIP can Click Talk Now On/Off 905.

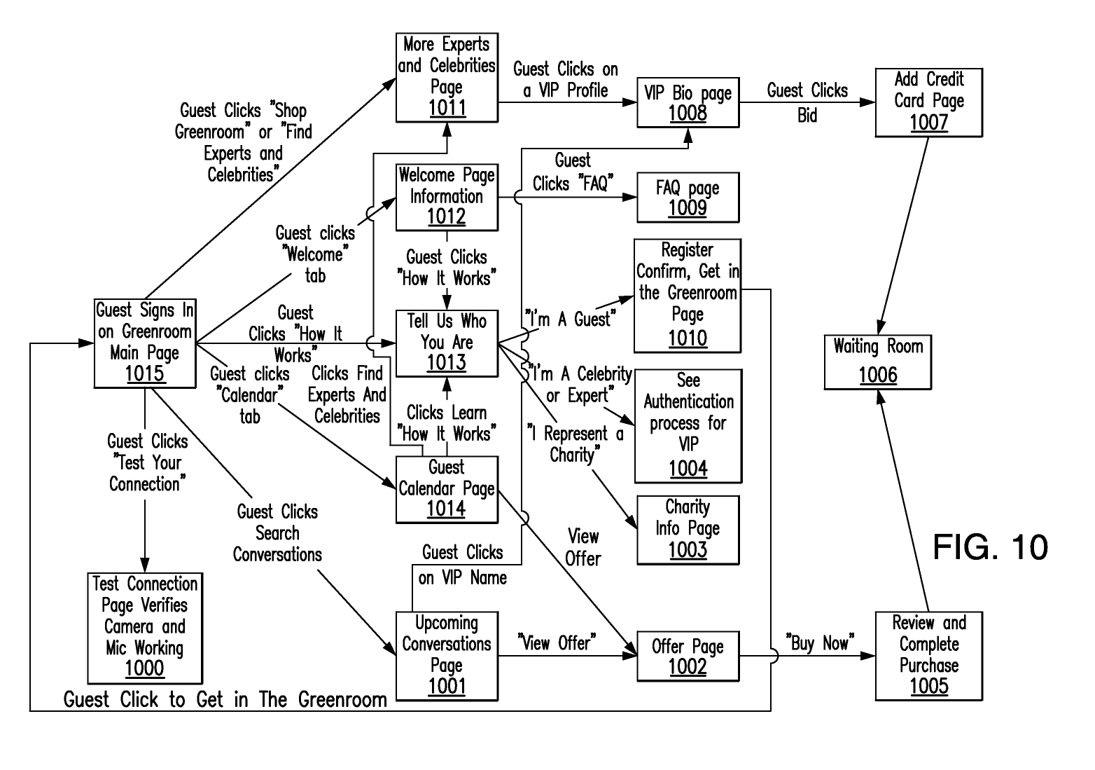

In FIG. 10, the guest signs in on the GreenRoom Main Page 1015, Guest Clicks “Test Your Connection,” Test Connection Page Verifies Camera and Mic Working 1000. Guest clicks done and is sent to main page 1015 Guest Clicks “Shop Greenroom” or “Find Experts and Celebrities,” and is sent to More Experts and Celebrities Page 1011. Guest can then click on a VIP Profile, and guest is sent to VIP Bio page 1008. Guest can then click Bid and guest is sent to Add Credit Page 1007. After adding credit card and purchasing, guest is sent to Waiting Room 1006.

Guest clicks Welcome tab from Main Page 1015 and is sent to Welcome Page Information 1012. Guest can then click FAQ and is sent to FAQ page 1009. Guest can also click How It Works from Welcome Page 1012 and is sent to Tell Us Who you are page 1013. Guest can then click I'm a Guest and is sent to Register, Confirm, Get in the Greenroom page 1010. After Registering, and confirming, guest can click get in the Greenrrom and is sent to Main Page 1015. From Tell Us Who You Are page 1013 guest can also click I'm a Celebrity or Expert and is then sent to the Authentication process for VIP 1004. From Tell Us Who You are page 1013 guest can also click I Represent a Charity and is sent to Charity Info Page 1003.

Guest clicks How It Works from Main page 1015 and is sent to Tell Us Who YouAre 1013. Guest Clicks Calendar from main Page 1015 and is sent to Guest Calendar page 1014. Guest Clicks View Offer and is sent to Offer page 1002. Guest can click Buy Now and is sent to Review and Complete Purchase 1005. Guest completes purchase and is sent to Waiting Room 1006. guest can also click Learn How it works from Calendar page 1014 and is sent to Tell Us Who You Are page 1013. Guest can also click Find Experts And Celebrities from Calendar page 1014 and is sent to More Experts and Celebrities Page 1011. Guest Clicks Search Conversations from Main Page 1015 and is sent to Upcoming Conversations page 1001. Guest clicks View Offer and is sent to Offer Page 1002.

In embodiments of the present invention, money is not used to purchase the communications, and instead tokens or certificates or points or other measurable unit are used. In embodiments of the present invention, an auction for a VIP's conversation time is provided. Once the auction closes, the winner Guest is notified either by automatic email notification or by manual notification. The winner Guest can then check in the calendar associated with the Guest at the Greenroom site. The Calendar shows all conversations upcoming, and can show past conversations too.

In embodiments of the present invention, one can ICS export to download the scheduled communications into a calendar. In embodiments of the present invention, an automated expert calendar is provided which shows all conversations, et al., and an automatic log of contacts made. In embodiments of the present invention, both parties can reschedule the communication. Certain rules will apply. This rescheduling is done as a separate transaction.

In an embodiment of the present invention, the purchasing company does not complete the actual financial transaction, but instead puts a hold of a certain amount of funds on the credit card or payment structure used.

In an embodiment of the present invention, a personalized calendar interface is provided to all users to indicate purchased and completed conversations et al.

In embodiments of the present invention, an “Admin” or administrator—whether a person or a robot/processor—has specific administrative rights in the Greenroom system, method and device.

In embodiments of the present invention, rescheduling of communications is effected automatically, including the transaction. In embodiments, the VIP does not get payment until after the communication occurs.

In embodiments, before the communication begins between VIP and Guest, the Operator may talk first with the VIP and Guest separately to start to ensure comfort and clarity. In an embodiment, if anyone pushes the pause/operator button, the operator can talk to both persons on audio—they cannot see the operator—and the recording for the souvenir is stopped until the communication between the guest and VIP returns.

In embodiments of the present invention, each time the pause button is hit, a new recording record is made when the communication begins. This allows for easy stitching. So, for example, if someone pause the session four times, there would be five different recorded segments to piece or stitch the recorded segments together. In embodiments of the present invention, even though the conversation is paused, the operator can still view both the VIP and the Guest as long as the broadcasting streams are open.

In embodiments of the present invention, the operator records all video and audio streams from start to finish. In embodiments, two separate streams is recorded as one stream. In embodiments of the present invention, various fault tolerance systems have been put into place. For example, there is redundant storing of data and other redundancies.

Some embodiments of the present invention involve using the following: Ruby on Rails, JavaScript, and JQuery. Some embodiments of the present invention involve using Amazon Web Services for system/method architecture, e.g., Amazon RDS for the database. Some embodiments of the present invention involve using at least two non-web servers to handle video processing. Some embodiments of the present invention use FF MPEG—Linux library to record, convert and stream audio and video. Some embodiments of the present invention use Wowza to handle the video feeds and hosts on Amazon. Some embodiments of the present invention use match processing for sending out emails, and processing Credit Card payments. Some embodiments of the present invention use CloudFormation by Amazon to manage stacks (e.g., can specify machines and start a new environment). Some embodiments of the present invention use Puppet (written by Ruby) to manage dependencies—describes the environment to deploy to. In some embodiments, Puppet is a tool used for managing the configuration of Unix-like and Microsoft Windows systems. Puppet discovers the system information via a utility called Facter. Puppet manifests are compiled into a system-specific catalog containing resources and resource dependency, which are applied against the target systems. Any actions taken by Puppet are then reported.

Some embodiments of the present invention use Hook-ins to handle phone functionality. Some embodiments of the present invention use Braintree to handle Payment processing. Some embodiments of the present invention use the Amazon Load Mounter to handle web traffic and to do a health check on the servers. For example, if CPU usage exceeds 60%, the system can be set to automatically increase server capacity.

Some embodiments of the present invention provide for three types of conversation offered: scheduled conversation, talk now, and telephone. The Scheduled Conversation is kept track of via two tables. The first table includes the hours of operation, days of the week, etc. And, for example, the second table includes the specific scheduling for each date.

In embodiments, the system keeps track of how many operators are available at any given time and/or which ones will be available. In embodiments, scheduled conversations are in predetermined time intervals (e.g., 15 minutes), but some predetermined time intervals preceding and following the scheduled conversation is set to ensure availability and assist to prevent overscheduling.

In an embodiment, for Talk Now, for example, there is a default template schedule over a moving 8^{th} week window that can be changed manually by an admin. In an embodiment, for Talk Now, at least one of the following occurs: all conversations are video chats; every video feed goes through the Wowza server; all chats are 15 minutes; fixed price offers have a specified end date.

In an embodiment, the dashboard has an hour by hour breakdown of what operators are available. In an embodiment, an error message comes up if there is only one operator left and an attempt is made to schedule 2 conversations. In an embodiment, the VIP sets the price and posts an offer on the site that anyone can buy. In an embodiment, VIP offer tickles after 5 min. and will log person out if there is no response—this results in the operator going back into the general pool. In an embodiment, if a Talk Now is “bought”, at least one of the following occurs: Operator is reserved while user enters payment purchase; User goes to a waiting room after purchase completed; the video feeds appear side by side for an admin who has the ability to pause or terminate the conversation; a pause will also sever the video communication to the server; user gets a souvenir video that stitches together non-paused footage. In an embodiment, the system does not make a complete record of all video conversation, but there is a complete record of text chat recorded (which is a point 2 point protocol).

In an embodiment, on the user end there is a cookie—the session data goes to the server, only the identifier is in the cookie. In an embodiment, during phone conversations the operator asks for identifying information from each party, similar to the process a bank would use.

In an embodiment, the Admin can act like a super-operator that can access everything the operator can, plus additional things like financial reports. In an embodiment, in order to monitor conversations you must be an operator or admin. In an embodiment, Wowza can also support spectators. In an embodiment, a Guest is provided with a predetermined time interval to complete checkout after purchasing Talk Now, during which time the operator is removed from the general pool of operators. Embodiments of the present invention keeps track of operator log-ins and shows if one is inactive. if so, a pop-up says “are you there?” In an embodiment, a popup can state “there is no operator available at this time, but there will be at X time.”

In an embodiment, the method for determining the next available operator involved: the system increments the # of conversations for each slot, if any conversations fail because they can't fill the conversation, the system will search for available times in the next 3 days for an alternative—with the padding on each side of the conversation accounted for (i.e. operators are blocked for 30 min.-a 15 min. conversation plus the 15 min. of padding). In an embodiment, if an operator doesn't start a conversation for a certain period of time after Talk Now purchase, an alert pops up to all operators and admins. In an embodiment, an operator can manually enter time and schedule a conversation without a transaction (for example if a connection is broken or for gifts of conversations). In an embodiment, Guests get alerts, e.g., 2 min, before conversations start. These specific numbers and times are just for exemplary reasons and not meant to be limiting in scope.

Embodiments of the present invention can include when a VIP offers a call: Record created in GreenRoom system; VIP sent to waiting room where the feed is then sent to the Wowza server; separate AV streams for the VIP and the buyer; Operators have access to the streams; Adobe Cereus server facilitates the p2p connection; Operator sends a signal to start individually to both VIP and buyer; Once both streams are connected, GreenRoom begins recording the streams. In embodiments of the present invention, Wowza can support subscribers to the streams.

In embodiments of the present invention, the Greenroom System uses UDP ports above 1024. Different sessions use different ports. This can present firewall issues. One way to solve the firewall issues is to use the Wowza server rather than a P2P connection. Could send messages to the server in a textstream so other clients can subscribe. This could present delay issues

In embodiments, additional stacks are used. For example, Jazz server (JavaScript based) can allocate conversations wherever sockets are available. The central layer makes it faster to facilitate asynchronous communication. In embodiment, the Wowza server does not come with authentication, but there are 3rd party modules that can be added on (There is no change to the Wowza code itself, just add-on modules).

In embodiments, once user clicks purchase: data is sent to BrainTree or other similar entity; Braintree responds back with a status and transaction ID; BrainTree also creates a UserID token for each user; Payment settles within 24 hrs of purchase (BrainTree tests the bank account to ensure there are sufficient funds); VIPs are paid manually afterwards—but could be paid as part of the automated system; 2 separate payments—one to the celebrity and one to the charity.

In an embodiment of Talk Now, e.g., 7 min. after user clicks buy, if the transaction is not completed by the set time interval, the offer expires. The process is: VIP offers-->Guest buys-->VIP gets a notification and goes to a waiting room-->after 7 minutes or other set interval and no purchase, then the transaction is voided. In an embodiment, the operator must initiate conversations.

In an embodiment of Talk Now, Users and VIPs can check their calendar on the site, and they are sent emails about the procedure, but they must be logged in order to receive pop-up notifications about a call starting. In embodiments, VIPs and guests are advised to use the “test your connection” button in order to prepare for the call and troubleshoot. In embodiments, if there is some user/VIP error once connected to the site (e.g., mute button on) the operator can text chat with either party to troubleshoot. In embodiments, if there is a firewall issue, then the user will not be able to get into the system and a reschedule will be attempted. In embodiments, there is an operator assistance button that guests or VIP can use. In embodiments, the operator can talk to both guest and VIP at the same time or individually. In embodiments, when the operator responds to an assistance request, the conversation is paused, which terminates recording on GreenRoom system. In an embodiment, the pause of the conversation is excluded from the stitched together souvenir video.

In another embodiment, all AV streams are recorded from start to finish, but then is stitched in order to get souvenir and other copies of just the conversation between guest and VIP. For example, one option is to create a separate operator stream with timestamps or other markers

In an embodiment, for the telephone operator system, the following technology, among many others available, may be used: Amazon Web Services/RDS database; Ruby on Rails; Video Processing—Amazon EC2 and FF-MPEG; Wowza video feeds through Amazon; Async batch processing for credit cards/status updates/emails/etc.; Amazon Cloud Technology (scale up and down on demand); Puppet for dependencies/describing environment/parameters; Toolia for phone functionality; Braintree for payment processing; Elastic load balancing and auto-scaling for high/low demand changes; Device used for authentication with cookies used for session identification only (cookies contain no other information).

In an embodiment, for operator scheduling, there are two tables. Table One includes generic operator availability (i.e. M-F at 10 am there should be 4 operators available). Table Two includes details for a particular day (i.e. on Monday, June 1 at 10 am, 5 operators are needed instead of 4 or only 3 out of the 4 are booked). Table Two may be auto populated with data from Table One as dates change and then later updated or changed.

During Talk Now, an operator is assigned to a Talk Now conversation when the user clicks “Buy Talk Now.” Operators is assigned for 5-7 minutes to give user time to complete purchase; otherwise operator unassigned and available for another video chat.

If no operators are available user's and celebs can't select Talk Now feature. A count down timer may inform users and/or celebs when the next operator is free to supervise a Talk Now call/video chat; they can select Talk Now at that time.

During video chats, each video feed from celeb and user goes through Wowza. Operator has access to and views both video feeds. Pausing is done by operator and the pausing triggers Wowza to stops the video feeds until resumed. Recorded video chats exclude any pauses or interruptions. Recorded video feeds are side-by-side videos of user's web cam and celeb's web cam.

In an embodiment, Operator can privately chat/Instant Message (IM) with either user or celeb through (Peer to Peer) P-2-P chat. Operator can also privately talk with either user or celeb (is this through phone or other means?). In an embodiment, lead times may be assigned so that operators have additional time at beginning and end of calls to setup, conclude, and/or prepare for next call. Operator is shown as busy/unavailable during video call time plus lead times at front end and back end.

In an embodiment, alerts may popup if an operator does not start a video chat within a predetermined time (i.e. 5 min) after the chat is scheduled to begin. Another operator may then be reassigned as a backup. In an embodiment, if no operators are available at a user proposed time that the celebrity is available for chatting, an automatic search may be conducted to identify other times that an operator and the celebrity are available within a particular window (i.e. 3 days before or after the user proposed time) At least one of the available time(s) may be presented to the user for selection as a backup time.

In an embodiment, Operators may be able to manually schedule conversations. This may be done if a connection is lost, there is a technical problem, or the celebrity has to postpone because of another issue in the middle of the call etc. After the operator schedules the conversation the parties may then logged back in at the scheduled time to restart the conversation.

In an embodiment, alerts/reminders may be sent the users/celebs after the log in to remind them of upcoming conversations.

In an embodiment, there is a vetting and registration process for buyers. Some celebrities have stalkers or others inappropriate for this site and they are ferreted out either from list from celebrity re blocked persons or usual checking.

In an embodiment, there is a “featured celebrities” piece that lists the higher profile celebrities across all categories. In an embodiment, there is a most requested/most purchased celebrity feature. In an embodiment, if one hits a firewall or otherwise cannot access the site, that person is provided with an error notice regarding this situation.

In embodiments of the present invention, Guests can: Can create own account; Cannot demote anybody; and Can delete own account. VIP can create own account; Cannot demote anybody; Can delete own account. Operators can: Cannot create other Operator accounts, Cannot create Admin accounts; Can promote Guest to VIP; Can demote VIP to Guest; Cannot demote Operator to Guest; Cannot demote Admin; Can re-promote demoted VIP back to VIP; Cannot re-promote demoted Operator back to Operator; Cannot re-promote demoted Admin back to Admin; Can delete Guest; Cannot delete VIP, Operator, or Admin (must demote to guest in order to delete); Can delete own account; Can change VIP Talk Now privileges; Can change VIP autograph privileges; Can manually schedule a conversation; Can manually reschedule a conversation; Can cancel an auction. Can create Operator accounts; Can create Admin accounts; Can promote Guest to VIP; Can demote VIP to Guest; Can demote Operator to Guest; Can demote Admin to Guest; Can re-promote demoted VIP back to VIP; Can re-promote demoted Operator back to Operator; Can re-promote demoted Admin back to Admin; Can delete Guest; Cannot delete VIP, Operator, or Admin (must demote to guest in order to delete); Can delete own account; Can change VIP Talk Now privileges; Can change VIP autograph privileges; Can manually schedule a conversation; Can approve/reject VIP profile edits; Can edit VIP profile; Can manually schedule a conversation; Can manually reschedule a conversation; Can cancel a scheduled conversation; Can cancel an auction; Can see metrics page; Can download CSVs of reports; Can add a charity; Can approve/reject new charity suggested by VIP; Can associate images to charities to be displayed; Can edit Operator schedule; Can download souvenir movies of video conversations; Can download souvenir recordings of audio conversations; Can edit slides on home page; Can edit current events ticker; and Can change a user's email address.

In embodiments, a date search and other searches on the stored data is available. In embodiments, one can “have a conversation” in the phone-only version; have a partnership with American Idol or other type shows or events. They could offer conversations with their 20 contestants, past contestants, judges.

In embodiments, for sports players and other, one can set up a greenroom booth at games and all star games for players to come by and offer calls. The usefulness of this invention is far reaching. In embodiments, talk now (immediate conversations); schedule a conversation in the future; video souvenir for public conversations; personalized recorded message; submit a conversation request with date and price; small groups (simply marketing, this gets people to think of this for children's parties, book groups, corporate events); autographs; gift giving' open to others to view for free; and the mobile opportunity: lighter versions on tablets and smartphones. Ipad apps. Versions taking into account form factors for other devices, including mobile devices, streaming situations and challenges (e.g., when traveling abroad), etc.

In embodiments, people can buy and offer conversations in seconds. They can do this wherever they are, whenever they want. It can be video or phone. There is no software download like Skype. There is a highly trained operator on every call. If it is a public call, both parties receive a souvenir recording after the call.

In an embodiment, this is a social media to the next level by offering fans the opportunity to have live video or phone conversations with NFL players and other celebrities. The platform is designed with enough flexibility to allow players to participate from any location as long as they have computer or phone access. In addition, there will be a Greenroom operator behind the scenes for every call and video chat to facilitate the connection and monitor the conversation.

In an embodiment, Players have the option of auctioning conversations or setting a fixed price for chats and will receive x % of the final price. Players who donate any, or all, of the fees to a charity or foundation will have the ability to make that information available to fans during the bidding and purchase process.

In an embodiment, the system and method is robust for high and low volume. The platform can scale easily and efficiently. Thousands of VIP's and guests can be accommodated by the embodiments by just adding operators and servers. In an embodiment, everything else is automated.

In an embodiment, we developed our souvenir feature, the recording that is sent to a user after a conversation that is not confidential. The actual conversation is a standard picture in picture, but our recording shows both participants equally and clearly. In an embodiment, this is a performance or speech or webcast. In an embodiment, this is a celebrity and a fan hanging out “on a couch” in the Greenroom.”

Embodiments of the present invention has value to contributors who provide entertainment, such as a celebrity or athlete, as well as experts who provide personalized advice. Embodiments of the present invention provide a lasting record of a golf instructor analyzing a video of a swing or a home makeover expert analyzing a user's photos.

In embodiments, a video “souvenir” recording is sent to the guest after a public conversation. In an embodiment, the recording of a conversation is developed and then sent to a guest after a non-confidential conversation. The actual conversation is a standard picture in picture, but the recording places the two participants next to each other and equal size (see attached mock up). This provides a lifetime memory of the conversation. In embodiments, if a party drops out due to internet connectivity issues, then only a portion of the conversation is recorded and may be sent on to the parties if determined to be justified based on the agreed-upon terms of the “chat.”

In embodiments, when a conversation has been started and both parties are in the room with the operator, the timer begins to count down. In embodiments, if one of the parties loses the connection, the conversation is put on pause and the timer stops. The operator can still talk to the party that is connected through the chat interface or by speaking to them. In embodiments, the other party, when they log back in to the greenroom site, gets an alert with a link to rejoin the conversation in progress. In embodiments when that party clicks that link, the operator can see both video streams again and can restart the conversation by clicking the “resume” button. The parties are then reconnected to each other and timer continues to count down. In embodiments, because the conversation was paused, the video souvenir will have the disconnected section already edited out.

In embodiments, there is a Talk Now Feature Method and System and Device “talk now” feature. In embodiments, with two clicks from the homepage, a VIP can offer a 15 minute “talk now” call for a fixed price; video or phone, option for a charity donation, option for a personalized autograph in the session, and video souvenir sent afterwords. word immediately goes out to greenroom guests who are following the vip, the offer appears in the greenroom “happening now” section and on a homepage ticker tape, and word goes out to the VIP's twitter and facebook followers (or other social media). it is like a celebrity sighting. In embodiments, the guest clicks to buy. the system checks to make sure the VIP is ready, an operator is available and credit card is charged. this happens immediately and the conversation begins.

In embodiments of the present invention, the VIP is a celebrity or other person or animal or entity that one would want to connect with in a chat room or other audio and/or visual communication. For example, the VIP could be an animal or a high-tech computer.

Embodiments of the present invention offer live, personal conversations with experts and celebrities, among others, with whom a person can actually talk through web video or telephone.

In an embodiment, the following information is retrieved and stored in a database for each connection case: user id, transaction id, offers, conversation, and purchases.

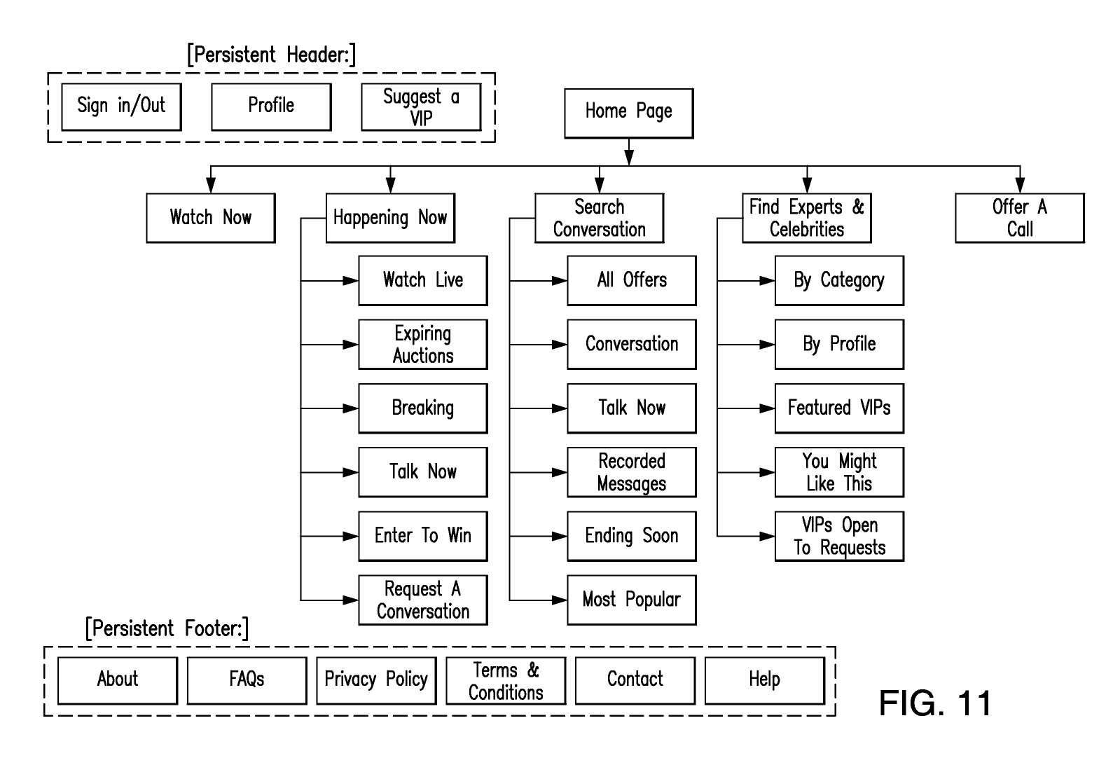

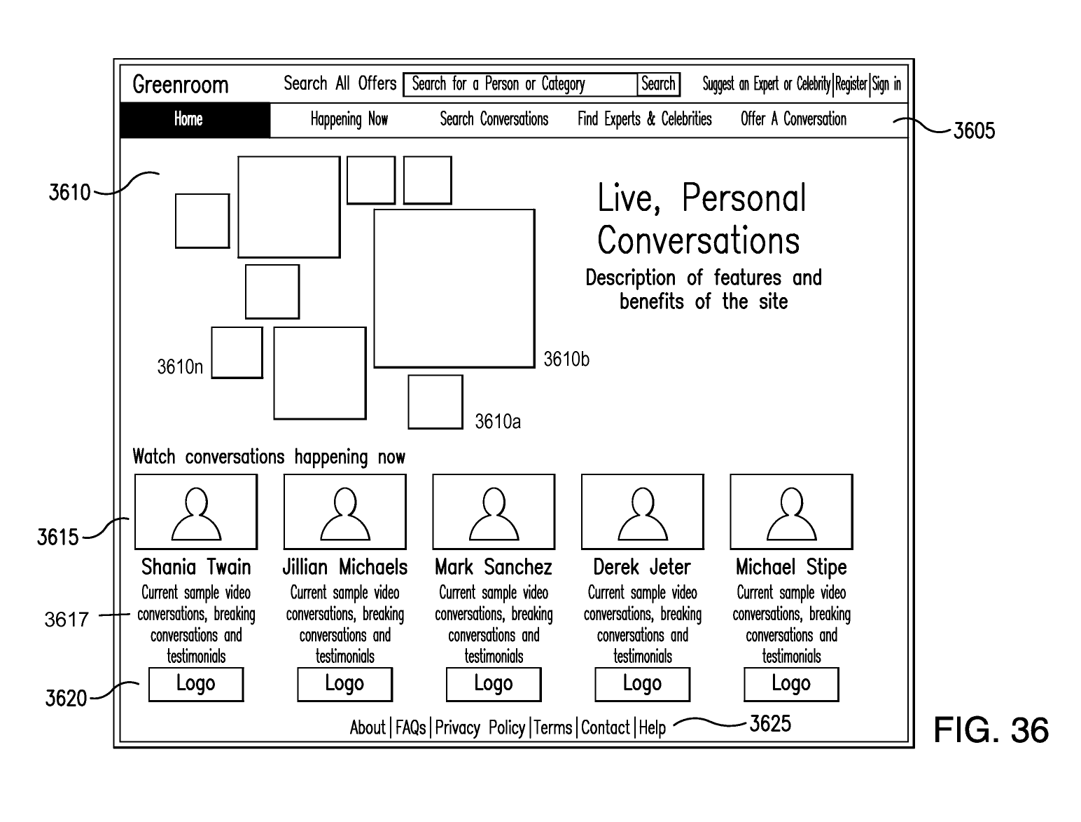

FIG. 36 shows an embodiment of the GreenRoom home page. An embodiment of the Greenroom home page can have an exciting “celebrity sighting” feel, showing an active, engaging, relevant site that can provide unprecedented access to experts and celebrities. The homepage can clearly communicate the features and benefits of the site and can provide an opportunity for a user to explore the site further through a set of top level navigation options 3605 and a rotating hero graphic 3610 that can explain what can be done through the site. FIG. 11 shows an embodiment of site map of the homepage communicating the features and benefits of the site. In an embodiment, the concept and features of the site are immediately conveyed to the user visually, for example, with profile pictures at the top of the homepage. The homepage can also convey the features of the site in writing with a simple descriptive headline highlighting each feature, and by example through the display of current, sample video conversations 3615 (breaking conversations) that can be viewed by the public. Rotating testimonials and static partner logos 3620 lend credibility. The bottom site map 3625 provides direct links to actions throughout the site.

The rotating hero graphic 3610 can include images at the top of homepage that rotate. By rotating, for example, each image can highlight a separate feature or benefit of the site. One embodiment of the present invention includes individual graphics of the rotating hero graphics 3610a, b, . . . n that can each have slight layout variations and unique headlines with descriptions. An embodiment of the invention can have graphics that show profile photos of experts and celebrities that have active Greenroom accounts. The hero graphics can rotate. An embodiment of the invention can allow a user to manually transition the graphics by clicking one of the navigation circles at the bottom of the image. The activity expressed in the graphics adds excitement and the variety of featured experts/celebrities convey relevance to the user by showing that there will be someone within the site of interest to them. The profile photos also legitimize the site and lend credibility to the experience.

In an embodiment of the present invention, extension features and benefits are highlighted in the hero graphic 3610 at the top of the homepage. These include, but are not limited to: Plan a Conversation; Talk Right Now; Offer a Call; Have a Group Conversation; Get a Personal, Recorded Message; Request a Conversation; Give a Gift; Win a Conversation; and Receive a Personalized Autograph.

In embodiments, a guest can send experts and celebrities, who have identified themselves as “open to requests” (discussed below) a proposed time and fee, for example, a child's birthday party on Sunday at 4 pm, etc. for a conversation or recorded message. The experts and celebrities can accept or deny requests. In embodiments, experts and celebrities can offer conversations right now, discussed in more detail below. These offers are all fixed bid and are designed to capture impulse buying. In an embodiment, the expert or celebrity offering a conversation has the option of designating the conversation as “open for public viewing.” This can make the conversation available for other users to watch the conversation in real time, for free on the site. This adds promotion for experts and celebrities while making the winning bidder a star as well. In an embodiment, when experts and celebrities offer a call, the conversation can be with more than one person. The guest on the call with the expert or celebrity can open the conversation up to a maximum of 10 participants. The main guest on the call can have direct interaction with the expert or celebrity. Other guests participating on the call can see and hear the conversation, but can only type to interact. In an embodiment, users can access from different locations and platforms, for example, desktop, laptop, mobile, iPad, etc. Examples of use include a high school football team to get a motivational chat with famous coach or a book group speaking with an author. In an embodiment, when a call is purchased by a guest, they can give it to another user as a gift. In an embodiment, the expert or celebrity can personalize the experience by providing an autograph. For example, an author can sign books for book groups. This feature adds value and excitement to the experience. In an embodiment, a guest can purchase a personalized, recorded video or phone greeting instead of a call.

A guest can watch conversations that are happening in real time between an expert or celebrity and a user on the site. In one embodiment, clicking one of the sampled or featured breaking conversations 3615 can lead the guest to an options page showing all available live conversations to watch.

In an embodiment, testimonials 3617 from media, partners, experts and/or celebrities and guests can add credibility to the site and ease hesitations that anyone interacting with the site can have. In one embodiment, testimonials 3617 can be collected offsite. The testimonials 3617 can display one at a time, and rotate on the page. In embodiments, testimonials 3617 are short, powerful, hand-picked quotes with significant messages.

One or more partner logos 3620 can be placed near the bottom of the page. The logos 3620 can be static and chosen to convey legitimacy. In an embodiment, the logos 3620 are not links.

In one embodiment of the present invention, a site map 3625 is at the bottom of the page. The site map 3625 can have category headings and links to actions and destinations within the site.

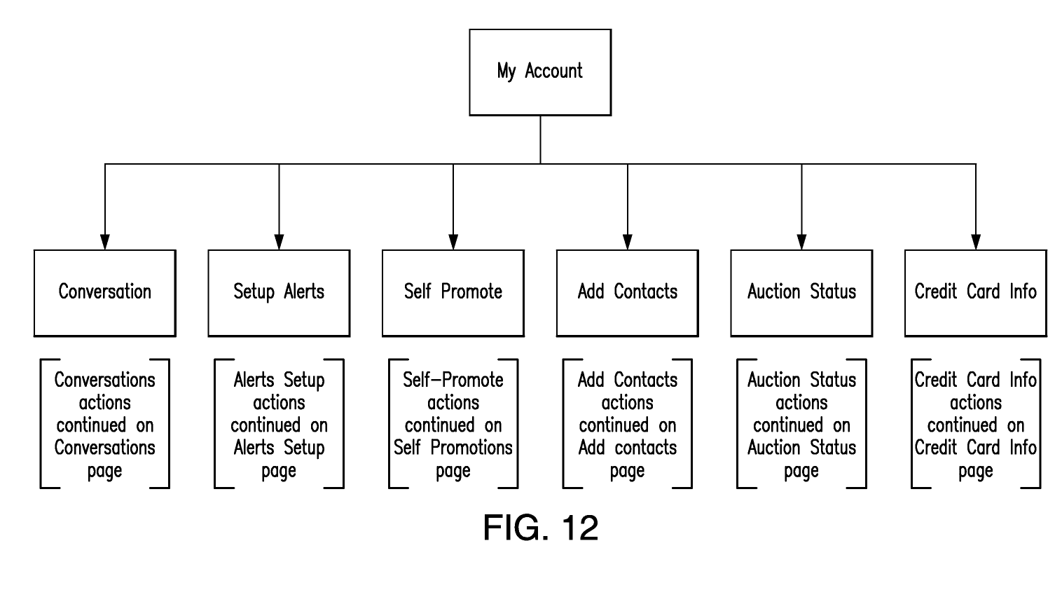

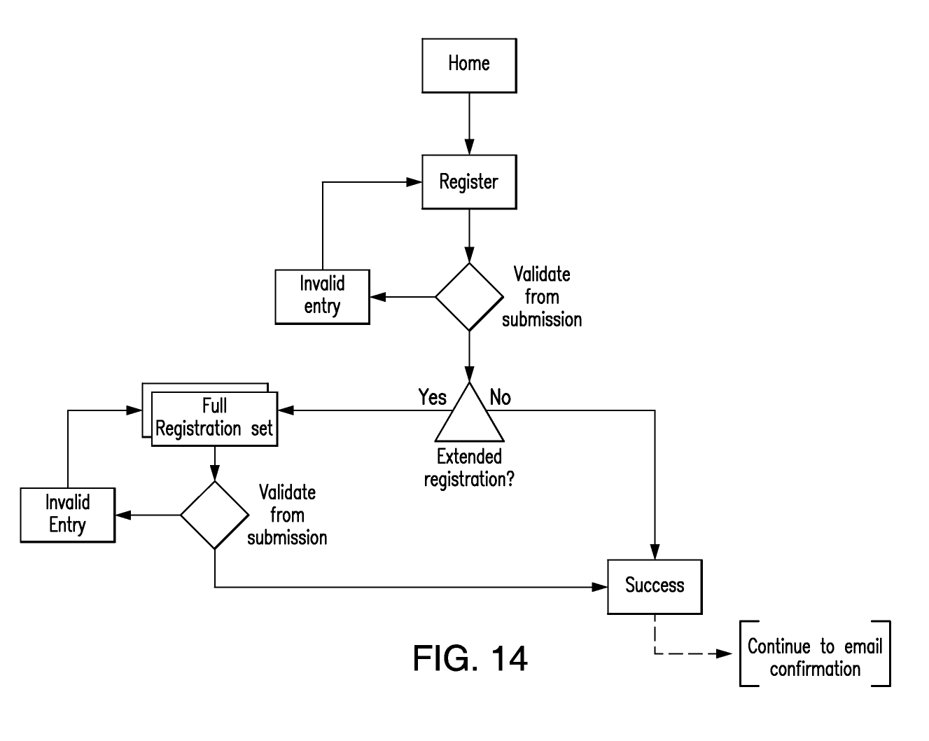

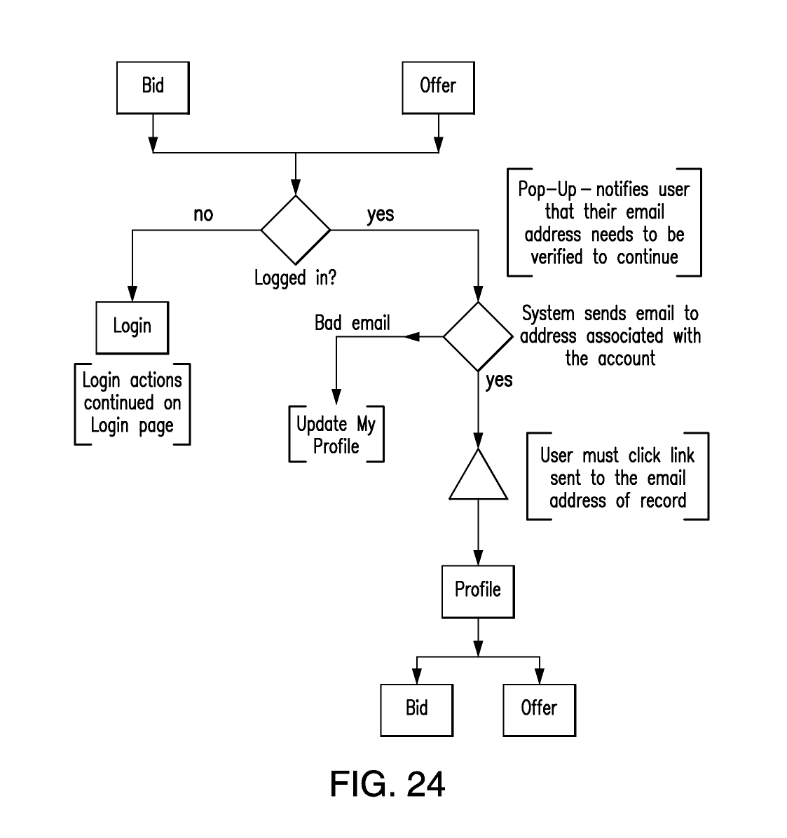

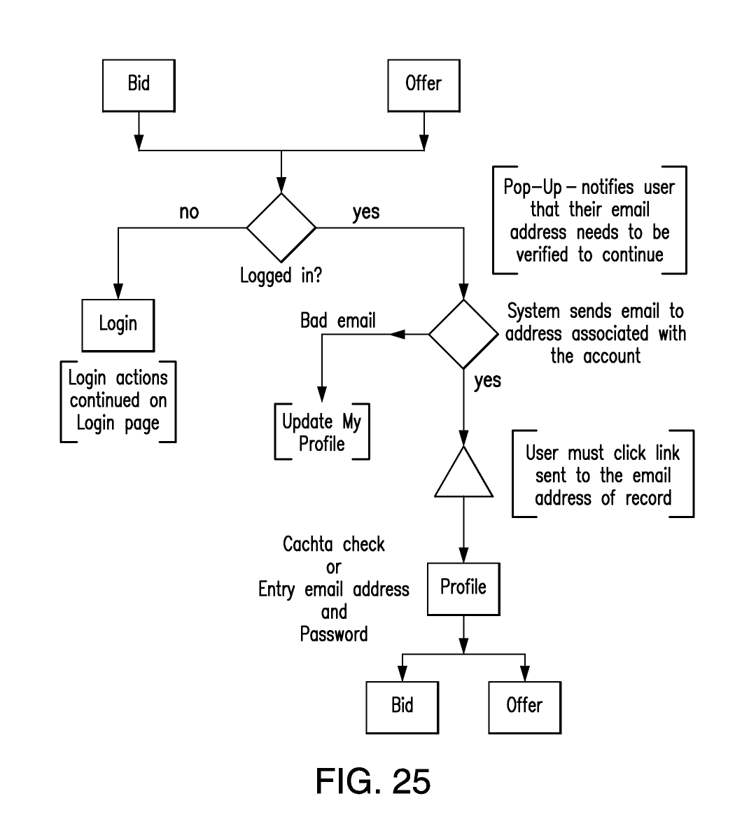

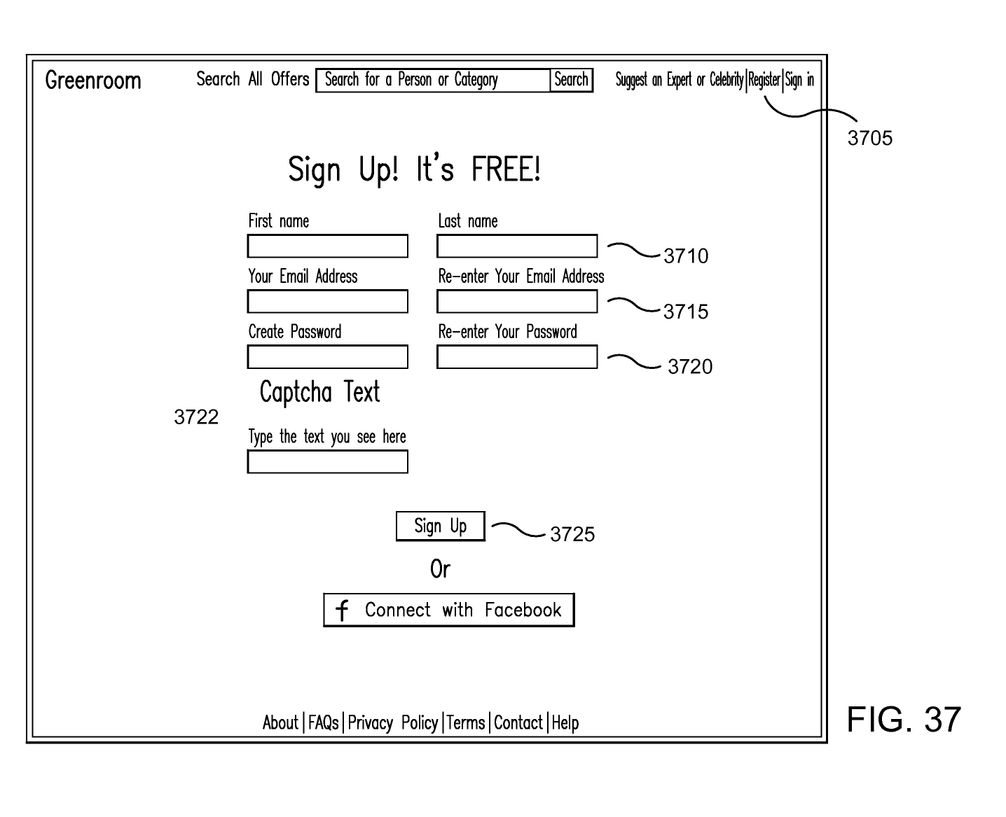

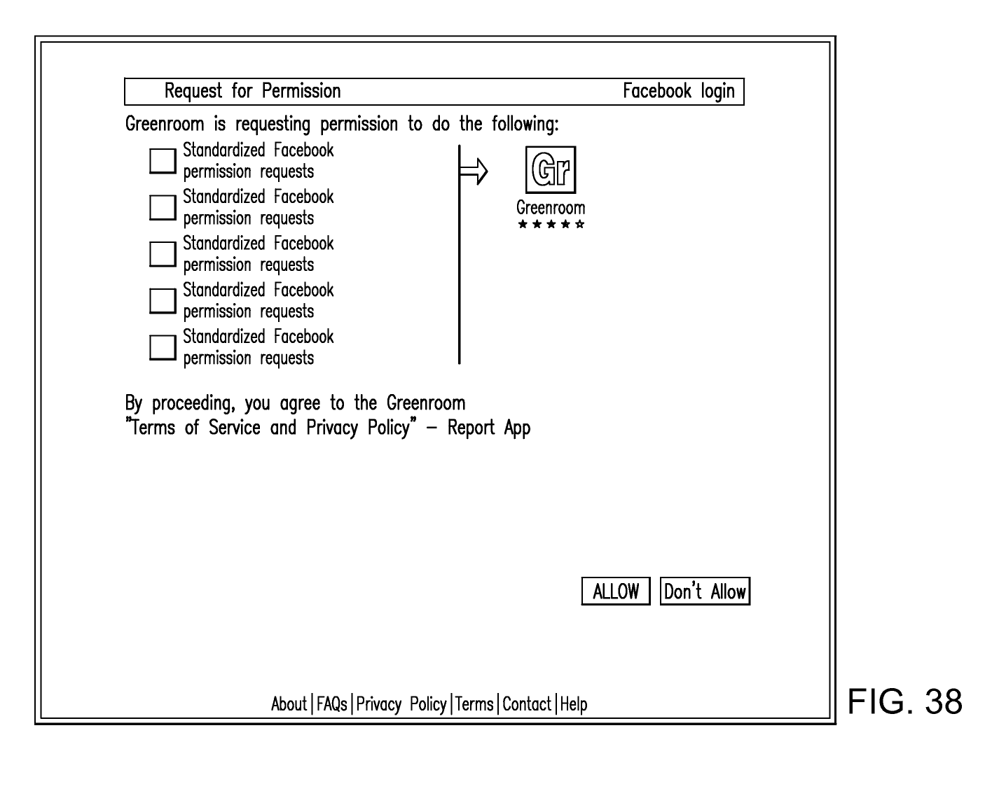

FIG. 37 shows an embodiment of a registration page. A user can generally browse and search the site without registration. In an embodiment, a simple registration process begins either when a guest selects the register link 3705 at the top right corner of any page. The registration process can also begin when a user attempts further interaction on the site. For example, in order to watch live conversations, suggest an expert and/or celebrity, place a bid, make a purchase, or request a recorded message or conversation, a guest needs to register for an account with GreenRoom. For example, FIGS. 24 and 25 show embodiments of a process for logging into an account when attempting to make a bid or offer a conversation. FIG. 12 shows an embodiment of a site map of an account page, describing the various features available to a user after registration. Information required for registration can include a name 3710, valid e-mail address 3715, and the creation of a password 3720. A captcha text box 3722 verifies the guest. FIG. 14 shows an embodiment of a registration process. After entering registration information, guests click the sign-up button 3725 to get to the “registration confirmation” page. In one embodiment, a guest can streamline the registration process by signing up using their Facebook log-in. If a guest is logged in to their Facebook account pre-registration, a list of their Facebook friends that are already GreenRoom members appears under the “Connect with Facebook” button. FIG. 38 shows an embodiment of a log-in page using Facebook. A user can select a standardized Facebook log-in page confirming the user to allow Facebook to interact with GreenRoom.

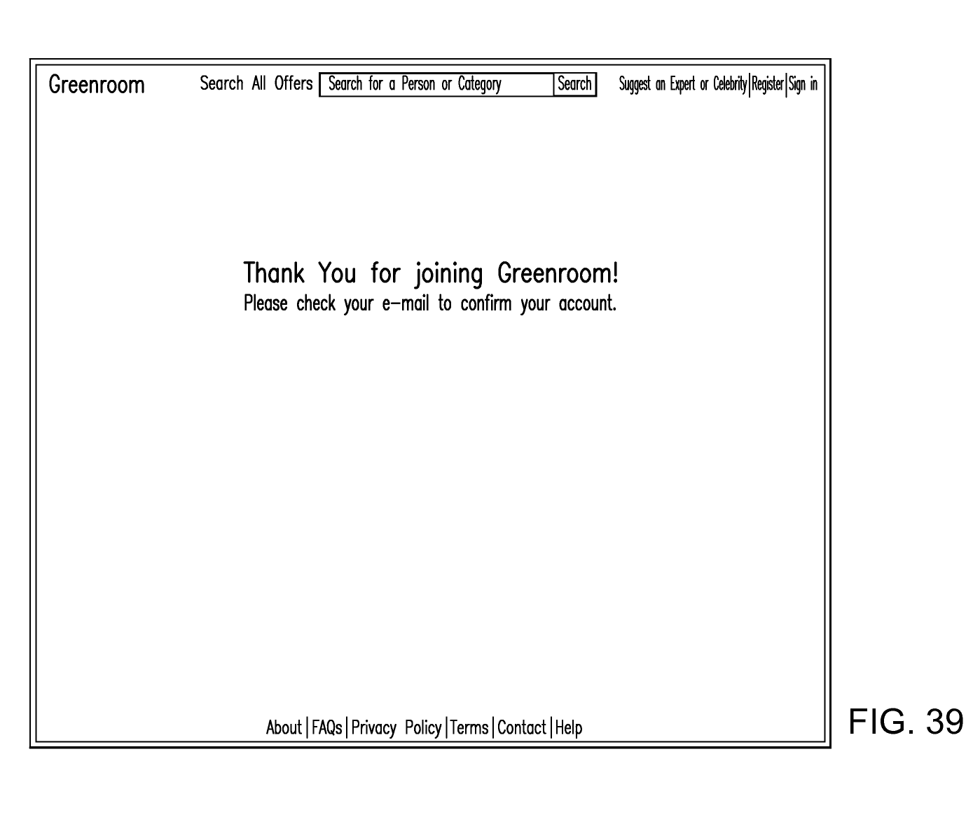

FIG. 39 shows an embodiment of a registration confirmation page. For example, when a user has filled out the registration screen and pressed the “sign up” button, a “thank you” screen indicates that the request has been processed. In an embodiment, text on this screen informs the user that an email confirmation has been sent to the email address provided. To complete the registration process, the user clicks a link in the received email. Upon selecting the link in the email, the user is redirected to the GreenRoom website. In one embodiment, in the confirmation email, a user has the opportunity to opt in for various GreenRoom updates.

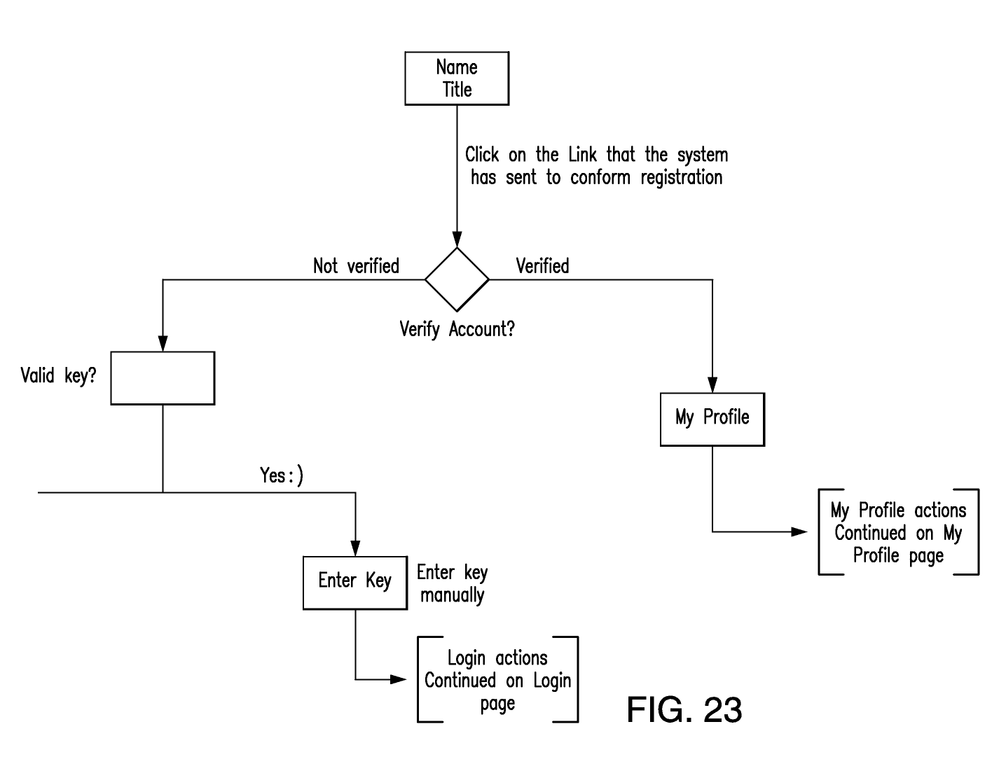

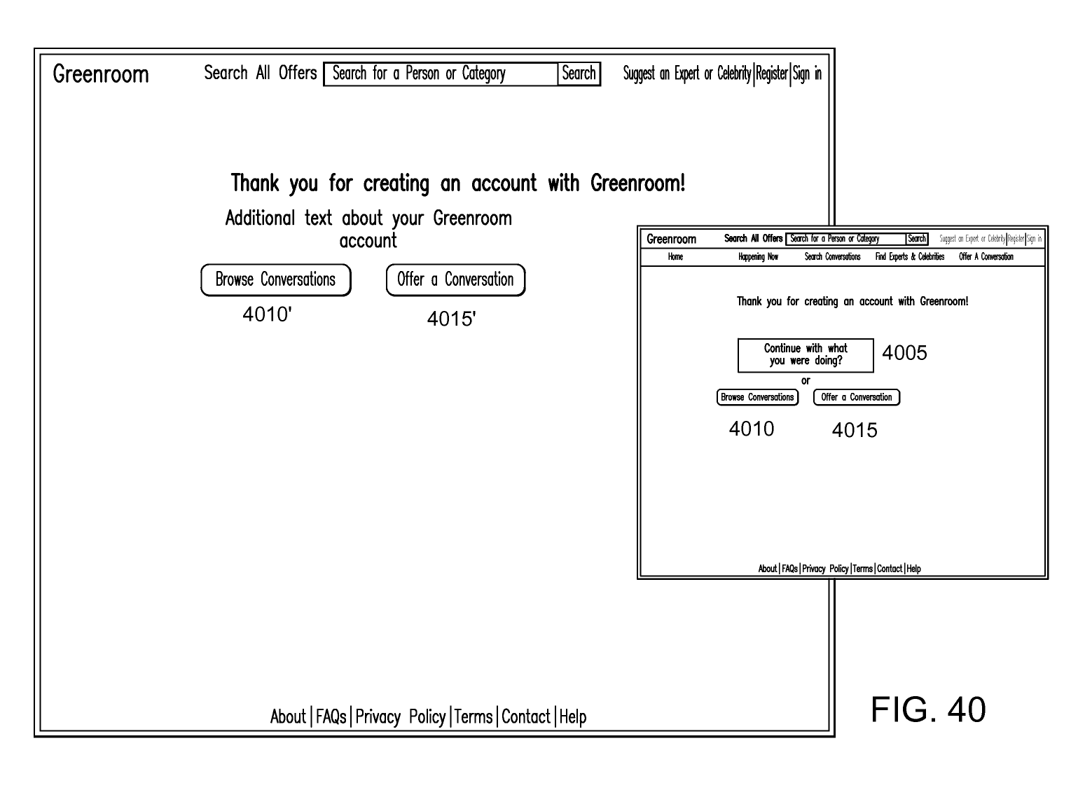

FIG. 40 shows an embodiment of a confirmation page after a user completes registration. When the user clicks on the link in the registration confirmation email, the site can redirect the user to a page on the GreenRoom site having two or three options. For example, FIG. 23 shows an embodiment of a process for verifying an account. The user can select one of: 1) continue with what they were doing 4005; 2) browse conversations 4010; and 3) offer a conversation 4015. In one embodiment, if the user was attempting to interact with the site (as described above) when registration was initiated, the user can continue with their original selection after registration. This can include, but is not limited to, watching a video, placing a bid, suggesting an expert or celebrity, making a conversation/recorded message request, or following an auction or expert/celebrity. In an embodiment, a user has two options: 1) browse conversations 4010′; and 2) offer a conversation 4015′. The “browse conversations” button 4010 and 4010′ can direct users to the homepage. The “offer a conversation” button 4015 and 4015′ can guide the user through a two-step process of filling in their account information and then filling out their profile for approval. The path to “continue what you were doing,” 4005 directs the user to where they were attempting to interact with the site unless the user was attempting to place a bid. In the instances where a user is on the path to place a bid and/or make a purchase, the user is directed to the account screen to fill in their information before proceeding to the bid screen.

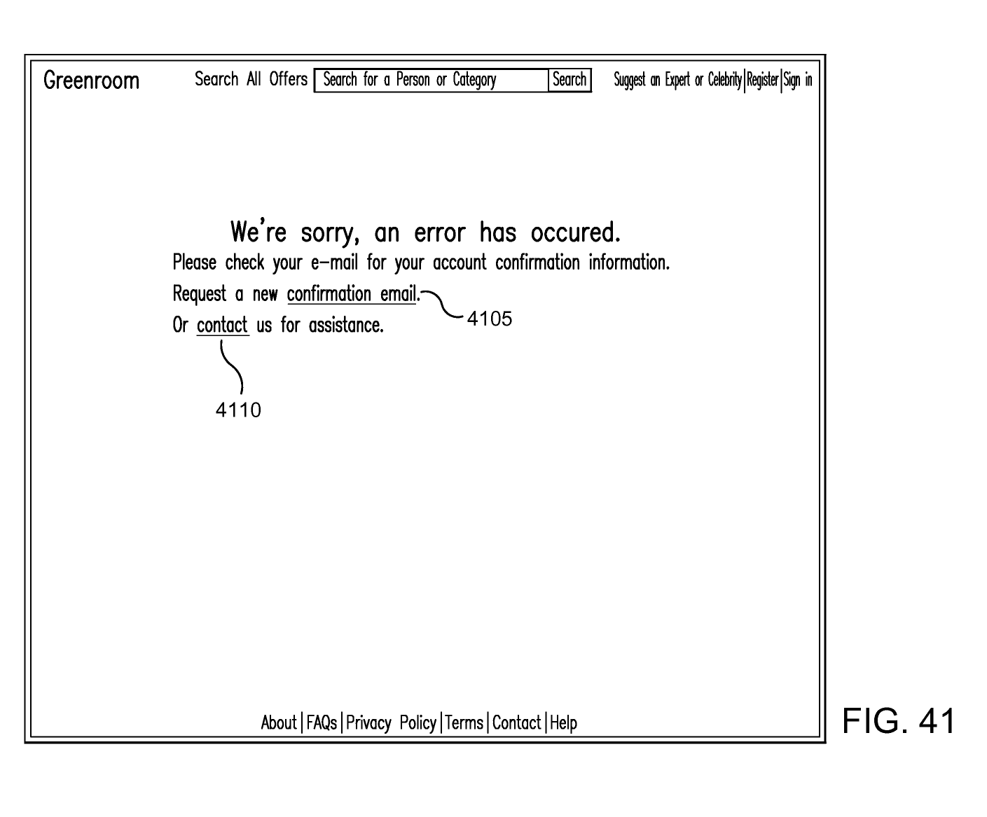

FIG. 41 shows an embodiment of an error page. In one embodiment, a guest attempting to proceed without using their email link or if their email link does not work, the user is directed to an error page. The user can either request a new confirmation email 4105 or contact GreenRoom for further assistance 4110. Requesting a new confirmation email starts the registration process over, as described in FIGS. 37 to 40.

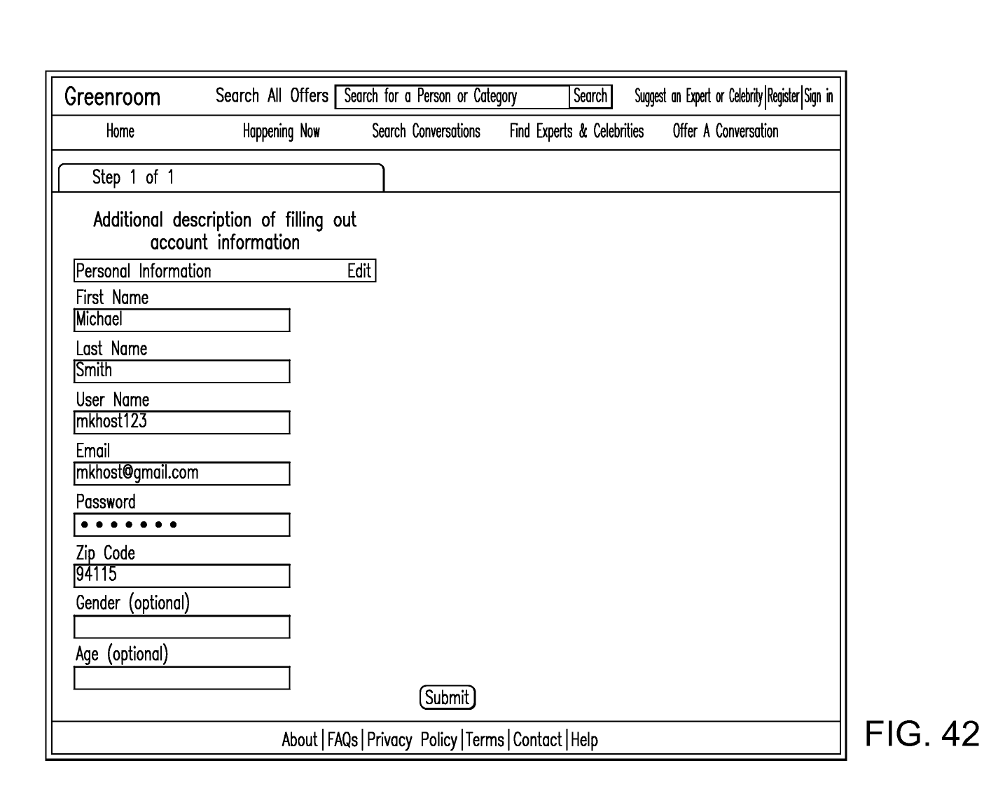

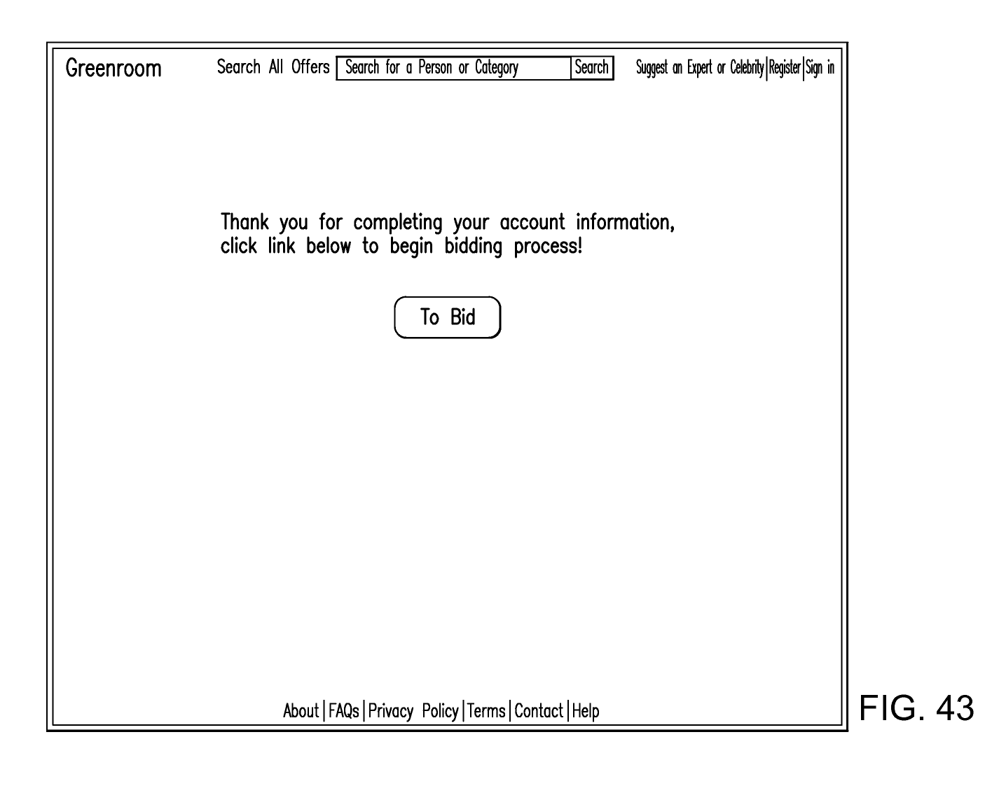

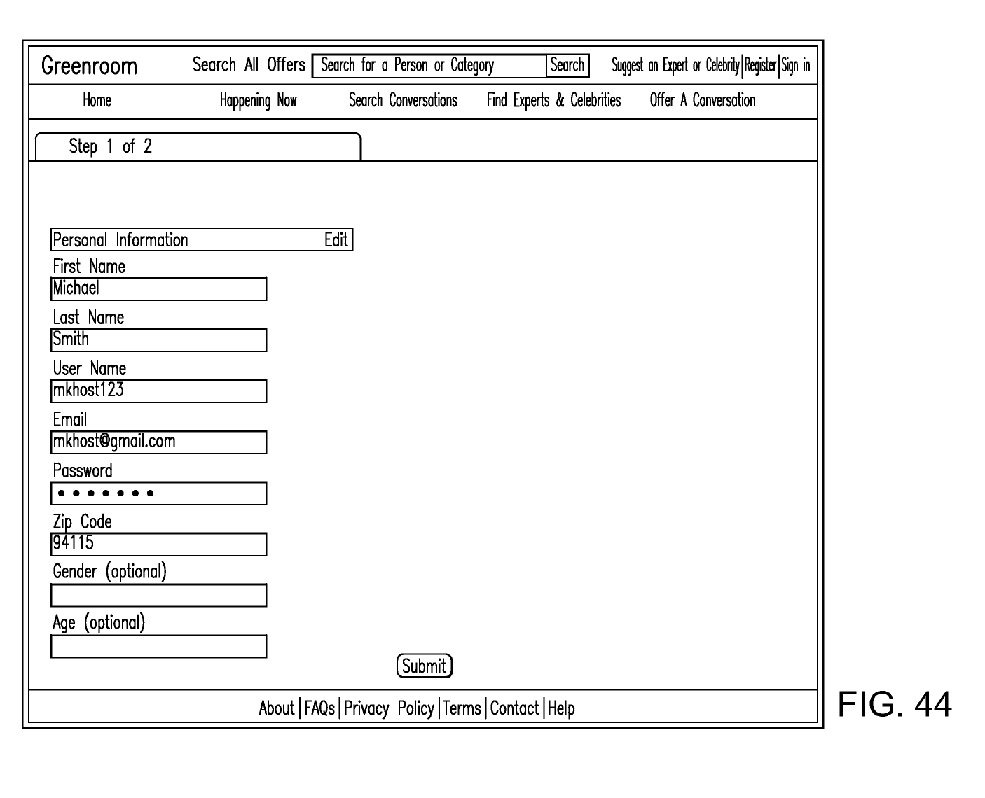

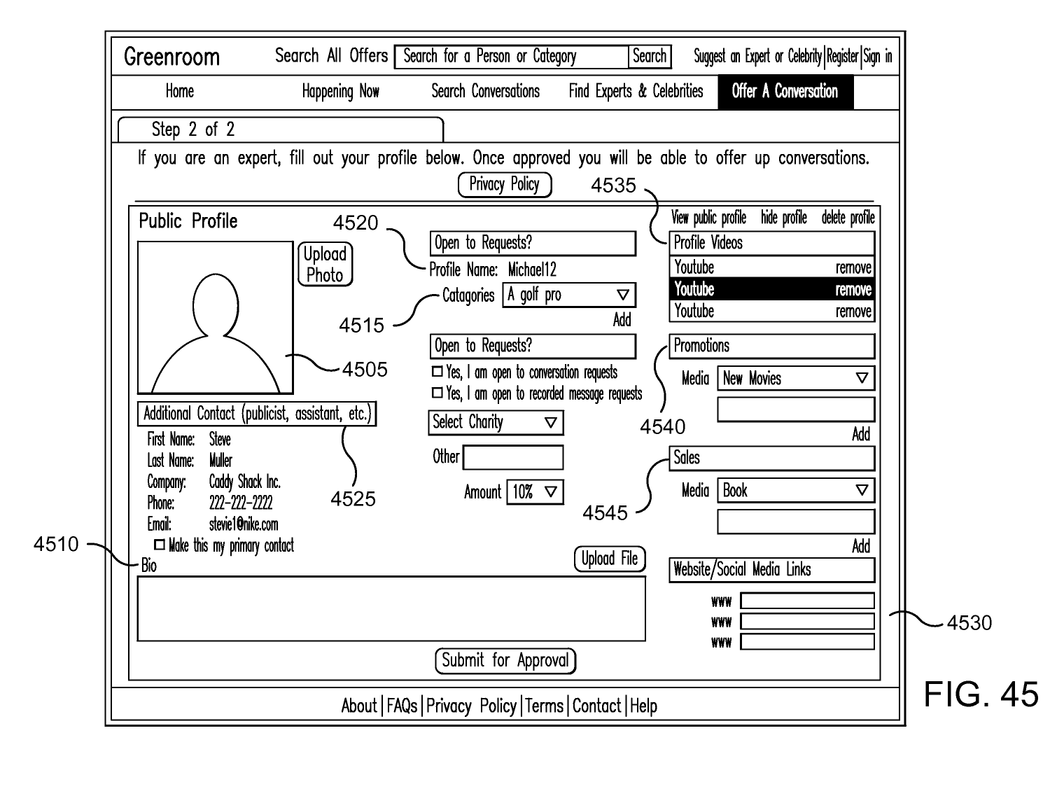

FIG. 42 shows an embodiment of an account setup page. In order to place a bid, make a purchase or offer a conversation, a user fills out their account information. Once this screen has been submitted, the user will have access to their account with the three tabs. FIG. 43 shows an embodiment of a confirmation page after submitting user account information. A thank you page can provide further direction and lead a user back into the site once the account information page has been completed. FIG. 44 shows an embodiment of an account setup page. A user attempting to offer a conversation can have a two-step process to enter account information. Account information fields can be the first step, similar to the account setup shown in FIG. 42. Creating a profile can be second step, as shown in FIG. 45.

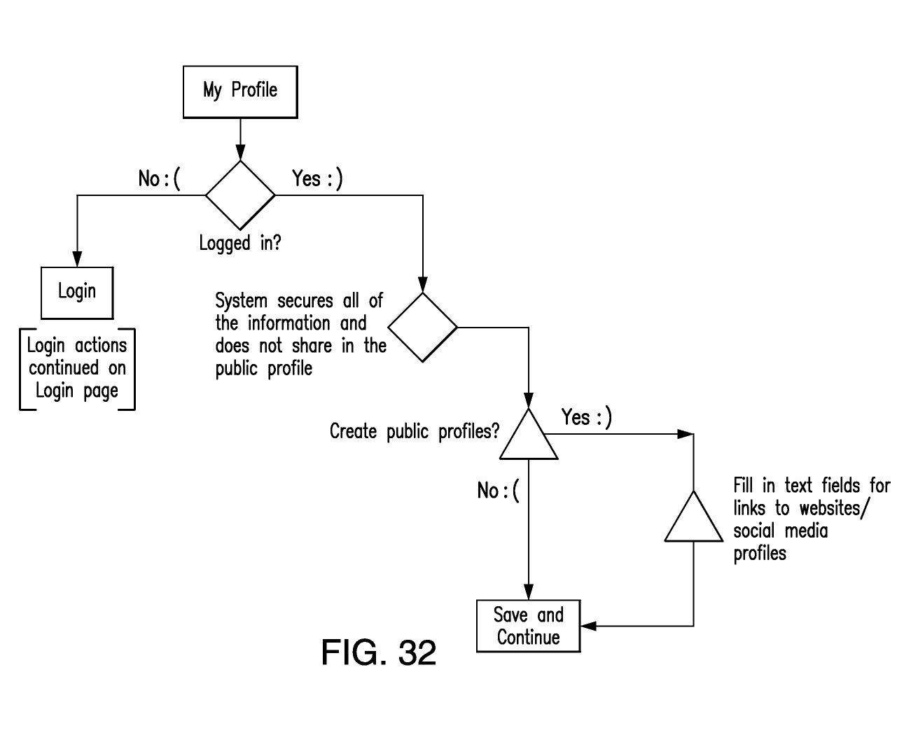

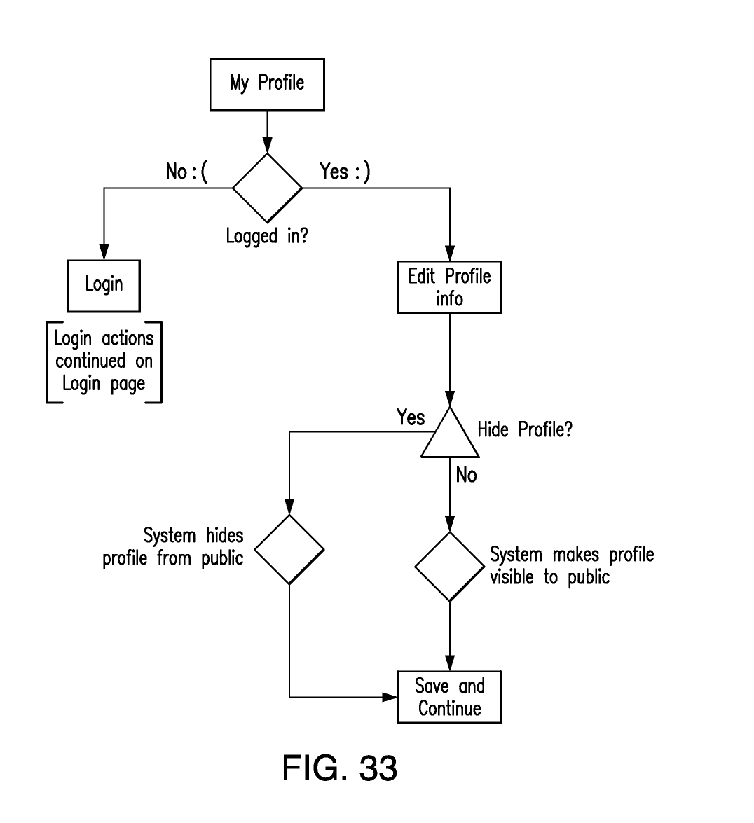

FIG. 45 shows an embodiment of a profile creation page. To offer a conversation, an expert or celebrity can fill out a profile and submit it for approval. In an embodiment, the profile is available for viewing by the general public once approved, and is searchable throughout the site. For example, FIG. 32 shows an embodiment of a process for creating a public profile. FIG. 33 shows an embodiment of a process for setting a profile as public or private. In an embodiment, the information on this screen includes a profile photo (headshot) 4505. In an embodiment, the information includes a biography 4510. The biography 4510 can be typed directly on the page or uploaded as a separate file. The biography 4510 can have a maximum character limit. In an embodiment, the information includes a dropdown menu 4515 to choose relevant categories of expertise and/or celebrity. The user can select up to three categories in the dropdown menu 4515 of expertise and/or celebrity. In an embodiment, the information includes a public profile name (real or stage name) 4520. In an embodiment, the information includes additional contact information 4525. Additional contact information 4525 can allow, for example, a publicist or similarly designated person to access and make changes on the account. In an embodiment, the information includes up to three website links 4530. The website links 4530 can include, for example, personal websites, imdb links, social media accounts, blogs, etc. In an embodiment, the information includes up to two video links 4535. The video links 4535 can include, for example, personal videos, YouTube videos, conversation videos, other legally posted online videos, etc. In an embodiment, the information includes promotions 4540 that the expert or celebrity wishes to include. The user can have up to three promotions 4540. In an embodiment, the information includes items for sale 4545 that the expert or celebrity wants to promote. The user can includes up to three items for sale 4545.

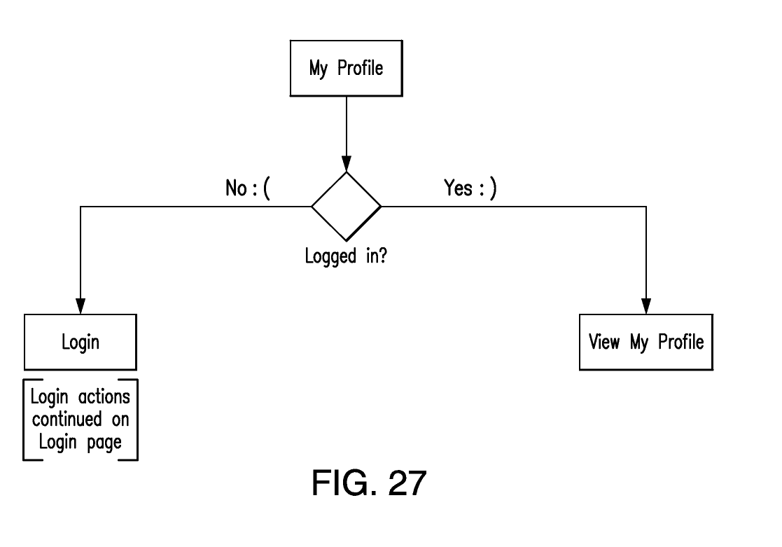

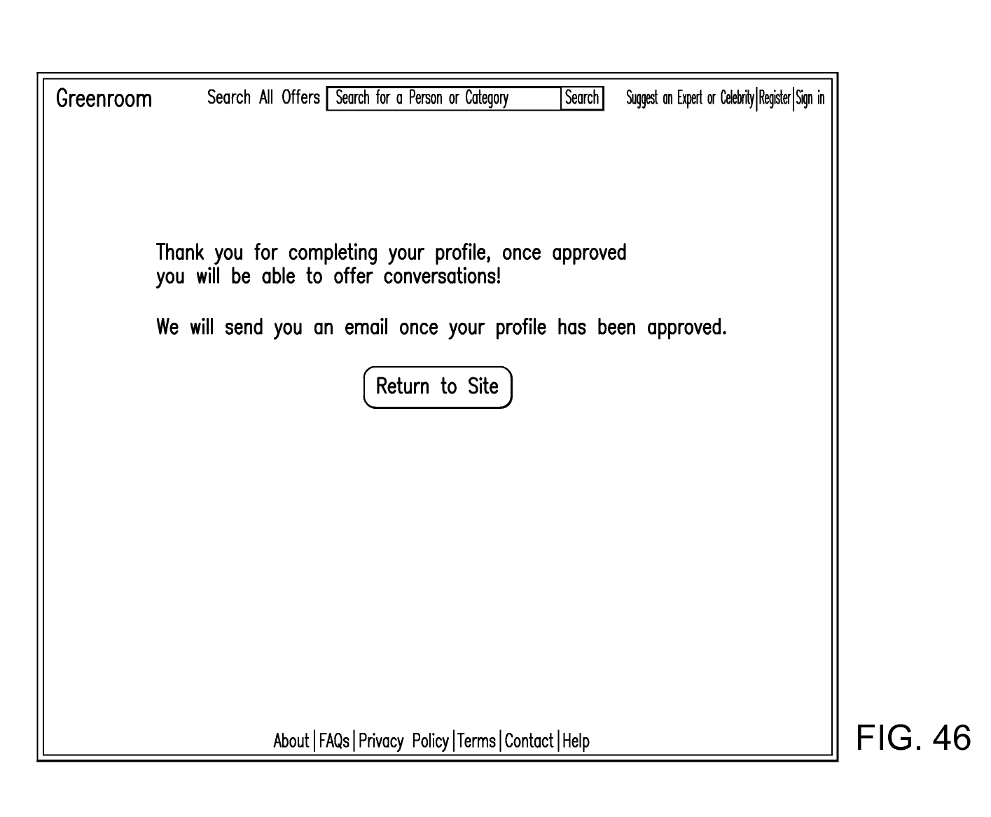

FIG. 46 shows an embodiment of a confirmation page after submitting user account and profile information. Similar to FIG. 43, a thank you screen appears and a notification is sent via email once the user profile has been accepted by GreenRoom. Upon approval, an email link directs the expert or celebrity to the “offer a conversation screen” where they can able to post conversations. In an embodiment, when viewing a profile, a user must log into an account, as shown in FIG. 27.

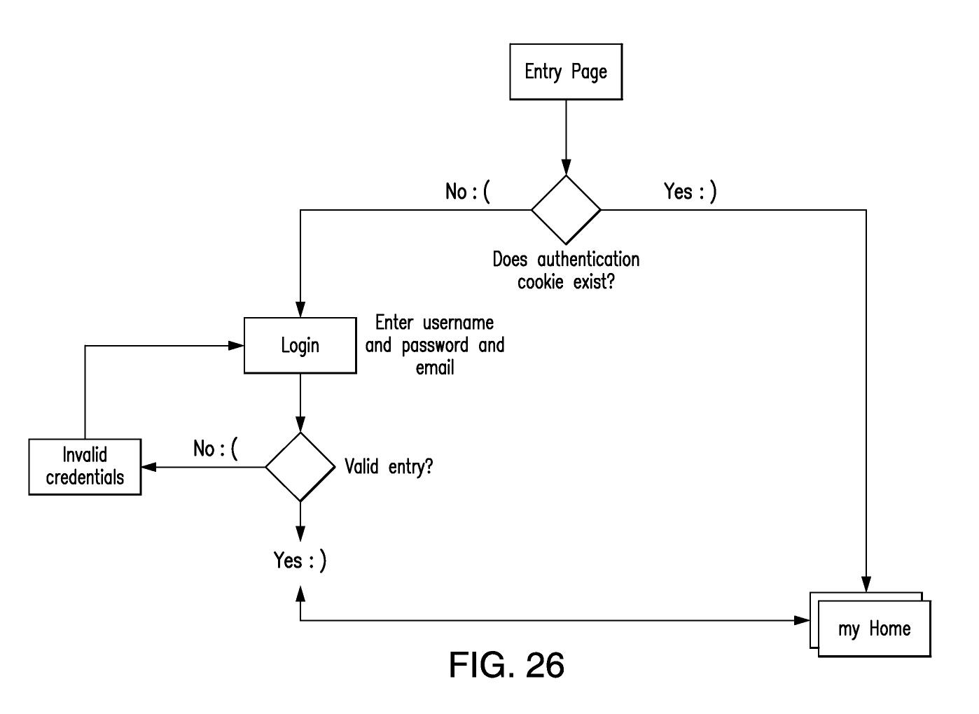

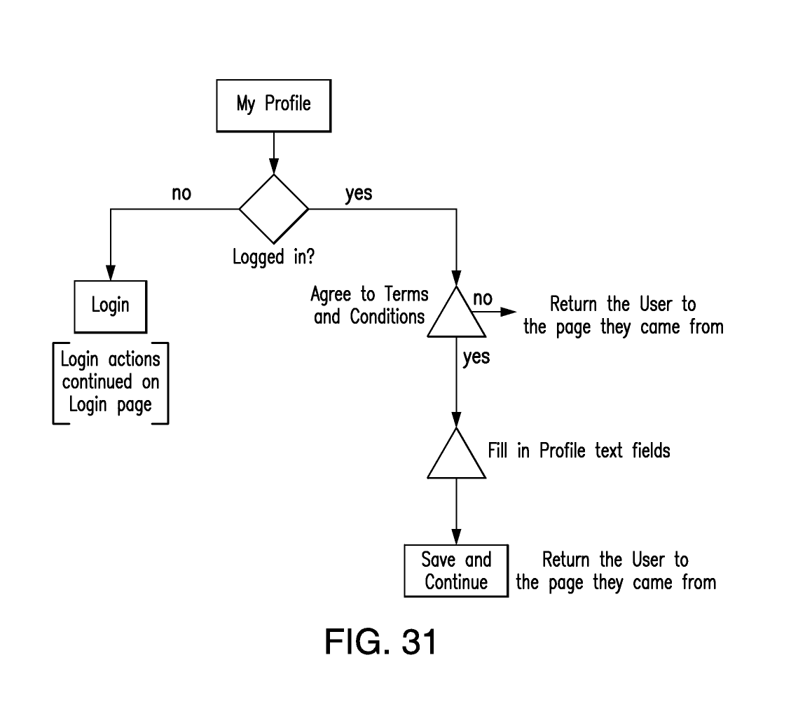

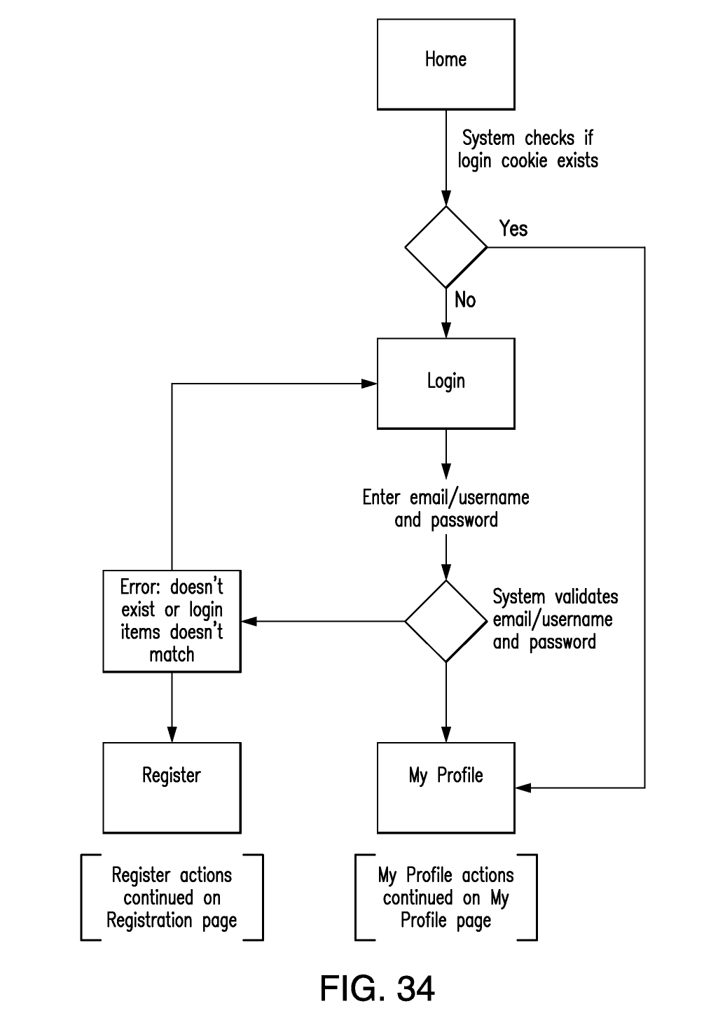

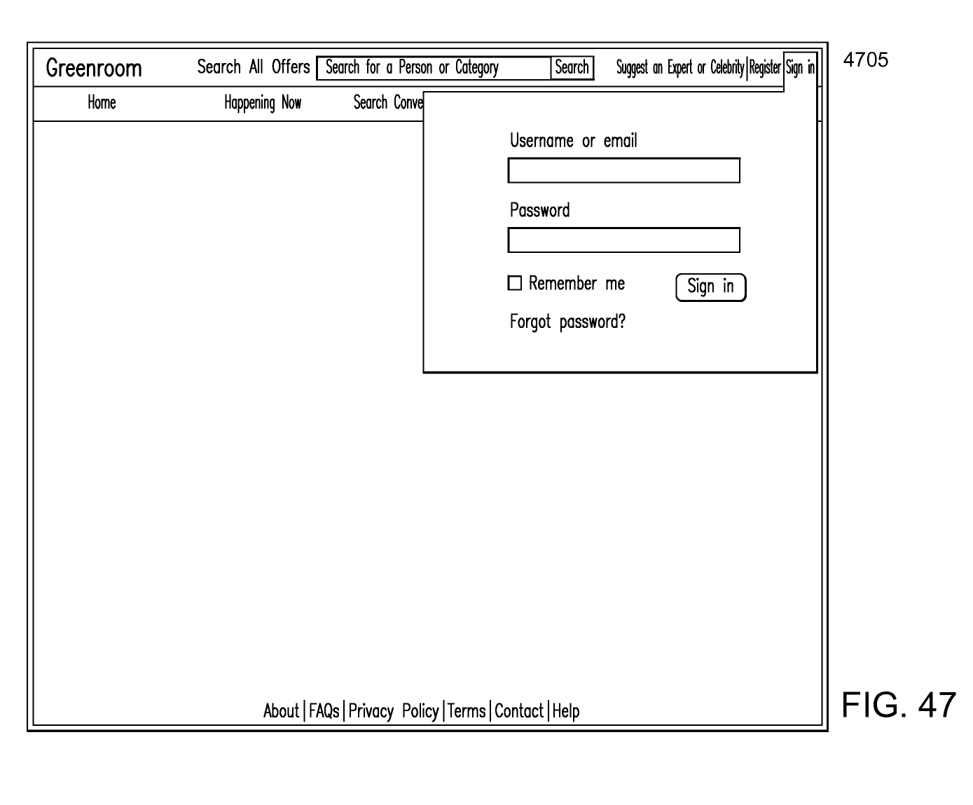

FIG. 47 shows an embodiment of a sign-in page for a registered user. A registered user can sign in to the site by clicking the sign in link 4705 at the top right corner of each page in the site. Information required for sign-in can include a user's full name, username, and/or e-mail address of the user and their Greenroom password. Sign in information can be saved and passwords can be reset if lost. For example, FIGS. 31 and 34 shows an embodiment of a process for logging into an account. Also, FIG. 26 shows an embodiment of a process for authenticating a user login attempt.

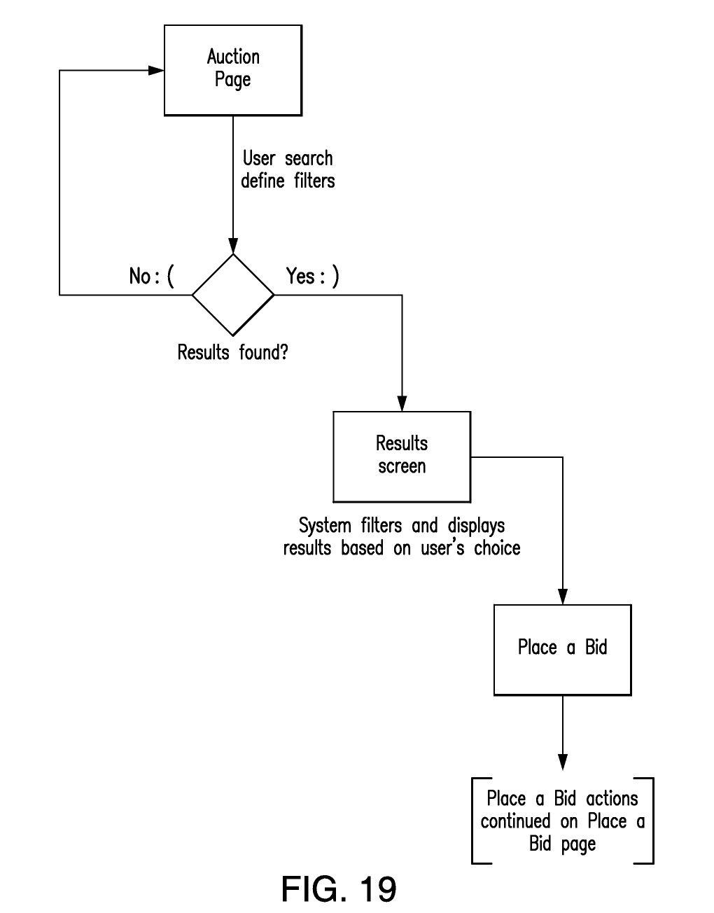

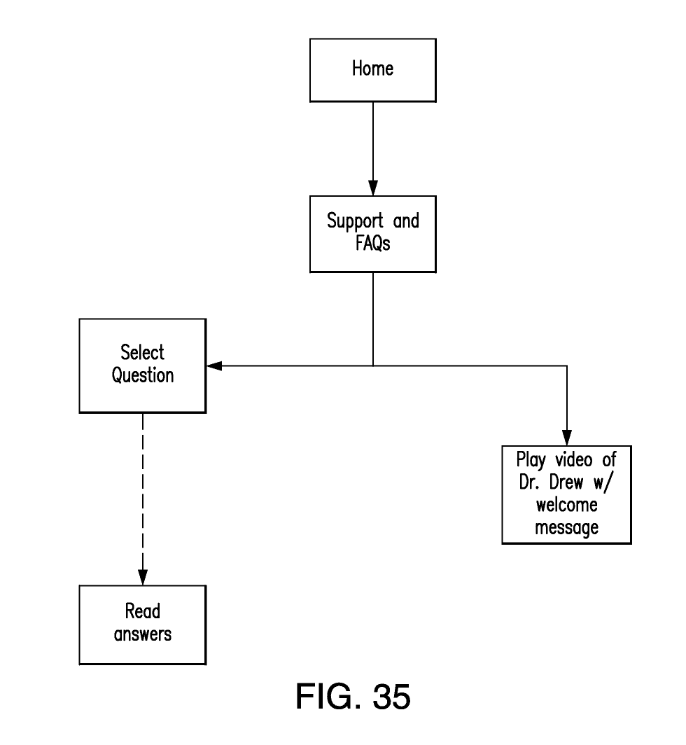

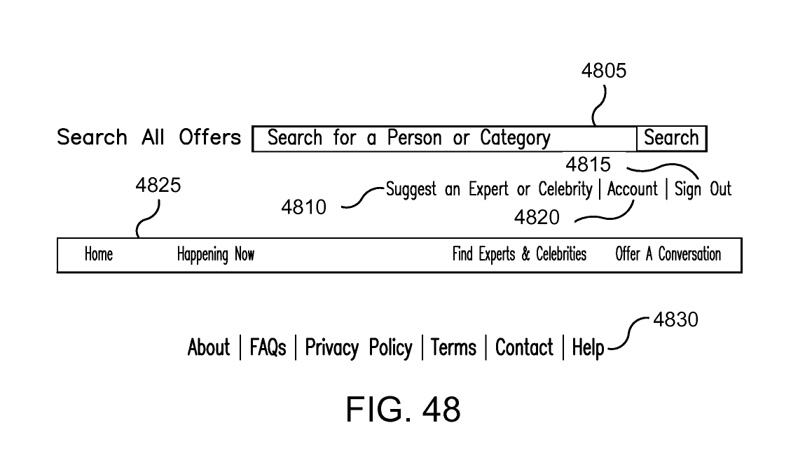

FIG. 48 shows an embodiment of a search bar provided on the page. A search bar 4805 can provide a quick way to locate a specific expert, celebrity or category. The search can appear as a heading on all pages. In one embodiment, the search designed to be a smart search, auto-populating with recommendations as the user types their query into the search field. For example, FIG. 19 shows an embodiment of a process for searching. In an embodiment, if a person's name is searched, and they have an account, their profile pops up. For example, if a category is searched, or if results are not an exact person match, results are shown in a new page, in list view. In one embodiment, results appear first as closest word match, then by current offers by time remaining, then alphabetically. Additional links can appear on the top right of the page. Top right links can include “Suggest an expert or celebrity,” 4810 and “sign in/sign out” links 4815. If signed in, an “Account” link 4820 can also be present. If signed out, a register link can be present (not shown). Main navigation categories 4825 can appear on the top of the page. Main navigation categories can include Home; Happening Now; Search Conversations; Find Experts & Celebrities; and Offer a Conversation. The current tab (category) in use can highlight when selected. Navigation links 4830 can appear on the bottom of the page. In an embodiment, links 4830 across the bottom of each page are consistent throughout the site. Bottom navigation links 4830 can include About; FAQ; Privacy Policy; Terms; Contact; and Help. For example, FIG. 35 shows an embodiment of a process for accessing FAQ.

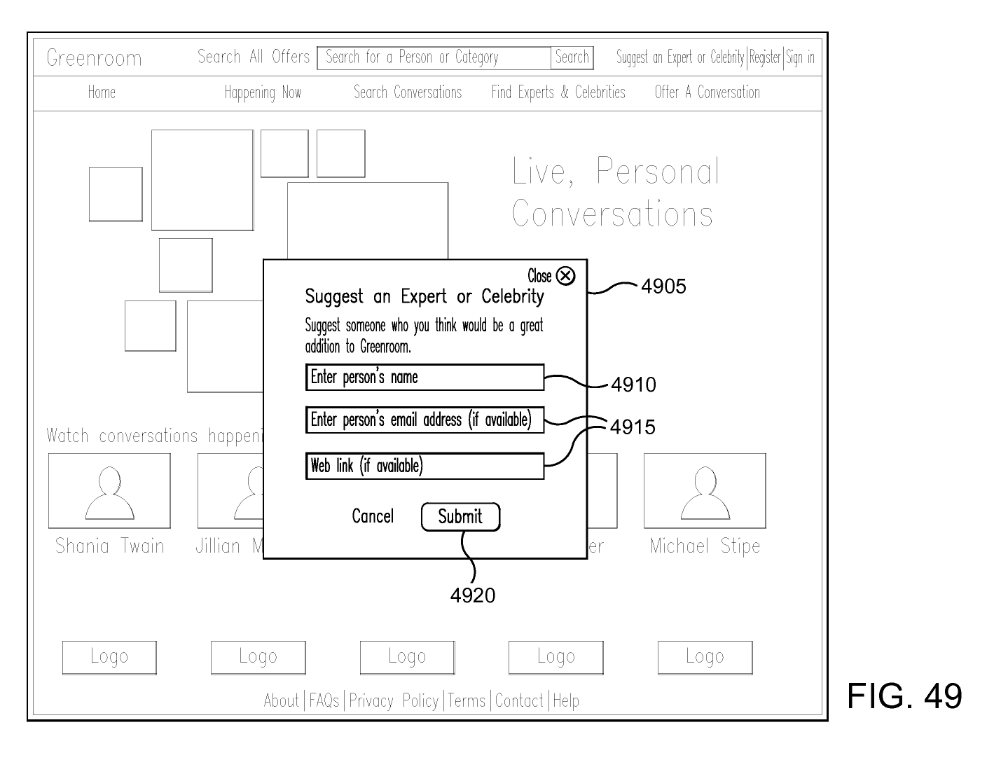

FIG. 49 shows an embodiment of suggesting an expert and/or celebrity. Any guest on the web site can suggest a new expert or celebrity to join GreenRoom. In an embodiment, a pop up screen 4905 appears from a link located at the top of the page and in the site map. In order to suggest a new expert/celebrity, the guest can type the name of the suggested person 4910 and optionally their email address and a website 4915. Providing the optional email address and website 4915 can provide information and context to the Greenroom administrators. A user can submit the request by clicking on the submit button 4920. In embodiment, guests must be registered and signed into GreenRoom in order to make a suggestion. GreenRoom can attempt to contact and invite the suggested celebrity and/or expert.

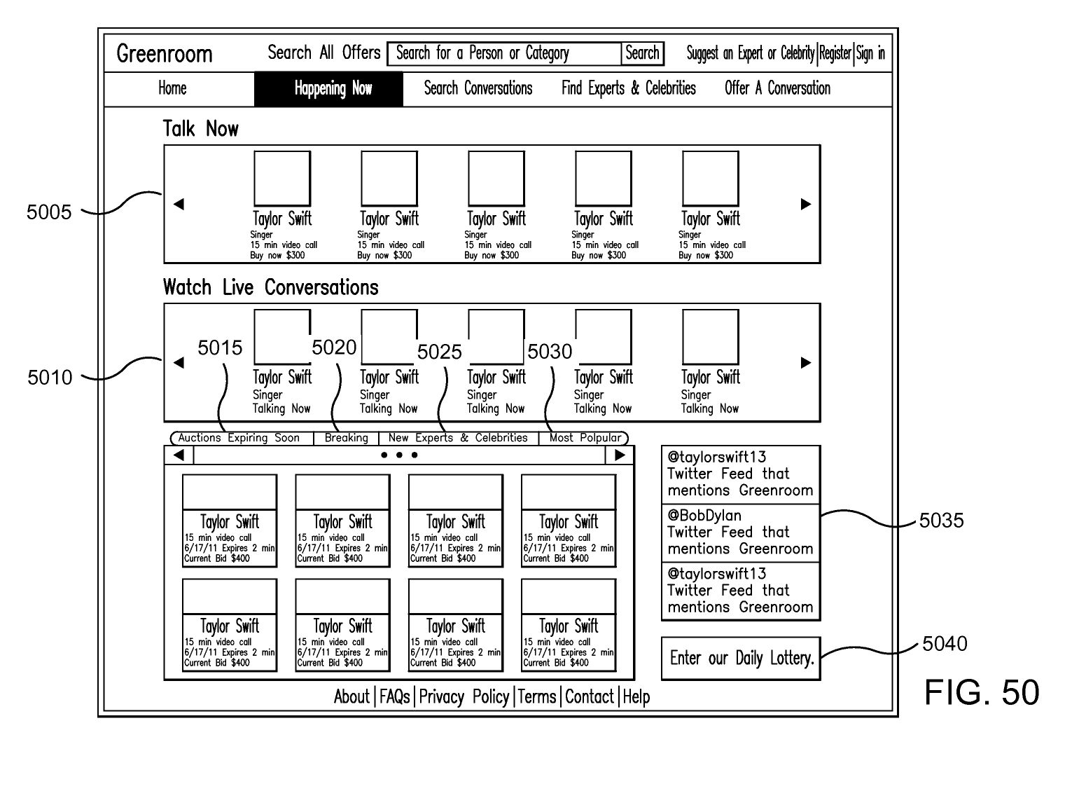

FIG. 50 shows an embodiment of a “Happening Now” page. A guest can browse a “talk now” section 5005 to find conversations that are currently available and scheduled to begin immediately following the purchase. A guest can also select one of the live conversations listed 5010, they are directed to the “live conversations” page to view others' video calls. The videos shown on this page can be in chronological order. If no videos are live and open to public viewing, the spots can be populated by upcoming conversations that fit that criteria and feature popular experts/celebrities. A guest can also search “auctions expiring soon” 5015 to bid on auctions about to expire. The auctions 5015 can be shown on this page by expiration time. A guest can also view a list of “breaking” conversations 5020 that have just been posted. In an embodiment, this list is chronological, beginning with the most recently posted, and updates upon refreshing the page. Selecting one of the options can lead the guest to the “auctions page” (described below) to view that specified opportunity as well as other newly posted opportunities. Guests can also see a list 5025 of the newest experts and celebrities to join the site. These can include guests who have recently expanded their account to become an expert or celebrity. Upon clicking on an expert or celebrity from the list 5025, the guest can be redirected to that person's public profile. A guest can also view the most popular conversations 5030. This tab 5030 can display the most popular conversations. In an embodiment, popular conversations are determined by current offers that are auction based and receiving the highest number of bids. A guest can also view Twitter feeds 5035. The twitter feed 5035 can show tweets that mention GreenRoom. This Twitter feed 5035 can be active and update constantly. Tweets can also include those that are generated from the various locations on the site that include social media distribution features. A user can also enter a lottery 5040 (described below). The user can enter the daily lottery 5040 from this page.

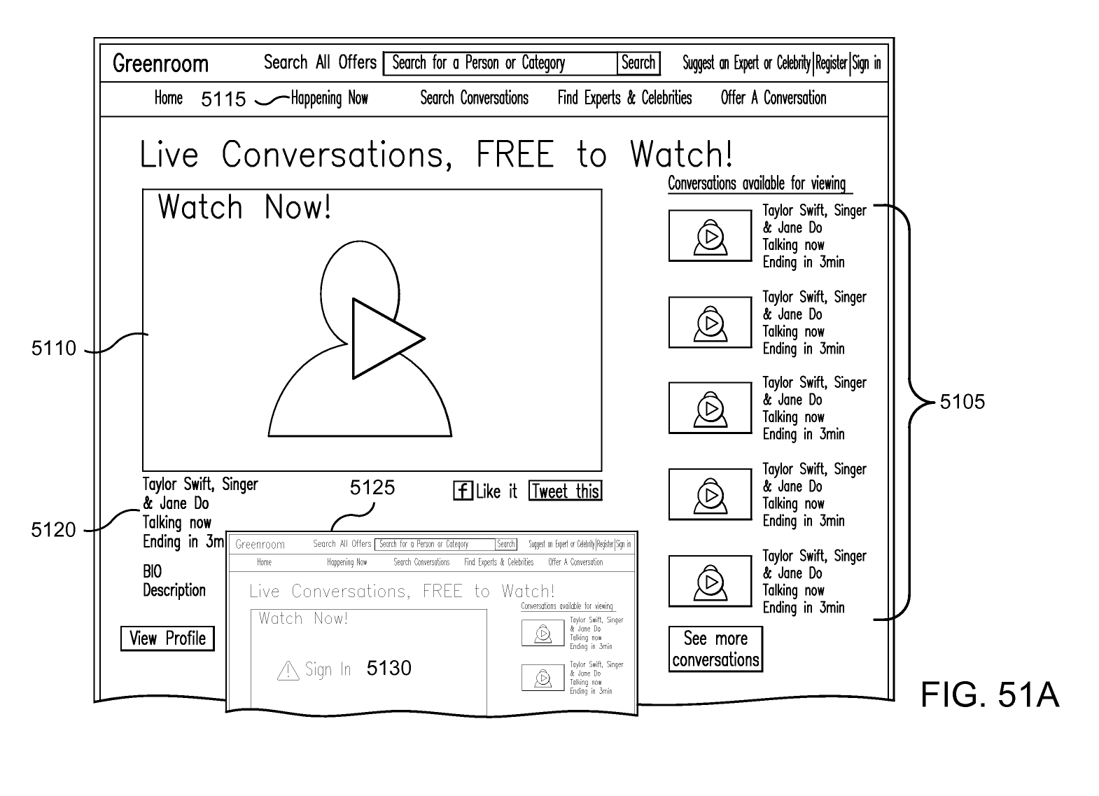

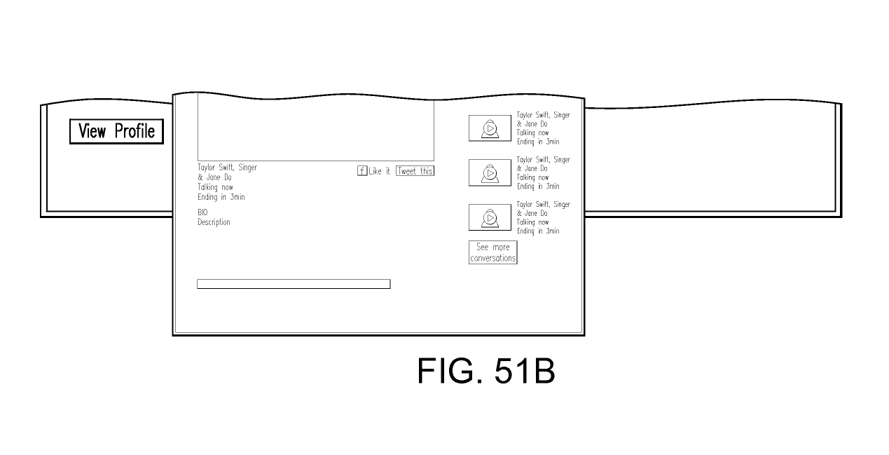

FIGS. 51A and 51B show an embodiment of a “Live, Breaking Conversations” page. This page can show conversations that are live and open for public viewing 5105. To initiate and play a video, the user can click the video screen 5110. The video screen 5110 can show both the expert or celebrity and the guest. The selected video can play at the top of the screen with all other conversations available to watch represented as smaller thumbnails below. The user names of the expert and/or celebrity and the guest who purchased the conversation 5120 can be shown under the profile. Guests can arrive at this “live conversations” page by accessing it through links on the home page and the “happening now” page 5115. Clicking on one of the featured conversations 5105 can play the live video. Guests can share a link to specific live conversations from this page via pre-populated but editable tweets or they can recommend the video on Facebook 5125. Guests can also check-in on Facebook from this page. In an embodiment, when offering a conversation, the expert and/or celebrity must select “open it to others to watch for free” in order for a conversation to be viewable by others (described below). For example, an actor holding conversations before a movie opening can also allow other users to view. This makes the winning bidder a star as well. In an embodiment, a guest must either be signed in or register for an account to view live conversations 5130. All video sessions can have a small graphic logo, at the bottom of the screen to instantly identify GreenRoom video conversations. This can be a trackable identifier for GreenRoom administrators.

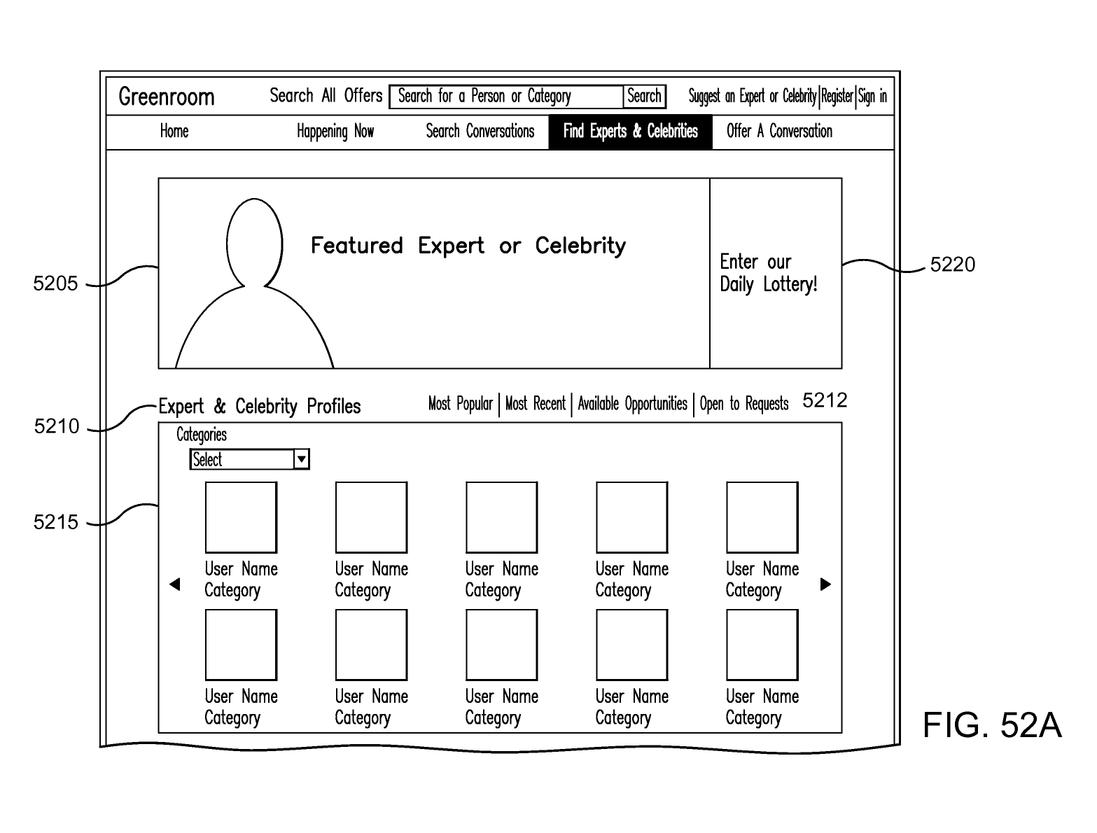

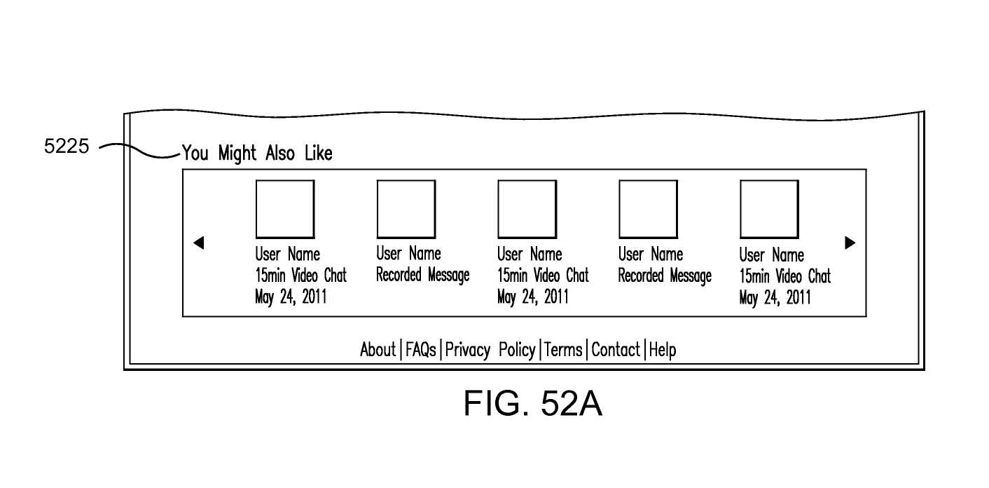

FIGS. 52A and 52B show an embodiment of how to find an expert and/or celebrity. There can be a “featured experts and celebrities” section at the top of this page in the top level navigation 3605. Experts and celebrities can be promoted 5205 here per agreements with GreenRoom. A guest can view the featured offers and select them to purchase or bid on offers. A guest can search expert and celebrity profiles 5210. Selecting a result directs the guest to the expert or celebrity's public profile page. Sorting options 5212 can include most popular, for example, experts and celebrities with the most bids or conversations purchased—historical. Sorting options 5212 can also include most recent, for example, VIPs who have most recently joined. Sorting options 5212 can also include available opportunities, for example, people who have current offers. Sorting options 5212 can also include open to requests. A guest can filter 5215 through experts and/or celebrities by industry category. A guest can enter the daily lottery 5220 from this page. The guest can view the lottery offering of the day and enter to win the conversation. Selecting the feature 5220 initiates a pop-up to register for the lottery. An embodiment can also include a “you may also like” section 5225. A guest can see a suggestion “you might also like” section to introduce them to experts and/or celebrities with current offers. This can be a basic algorithm of experts and/or celebrities with current opportunities, for example, as popular by gender.

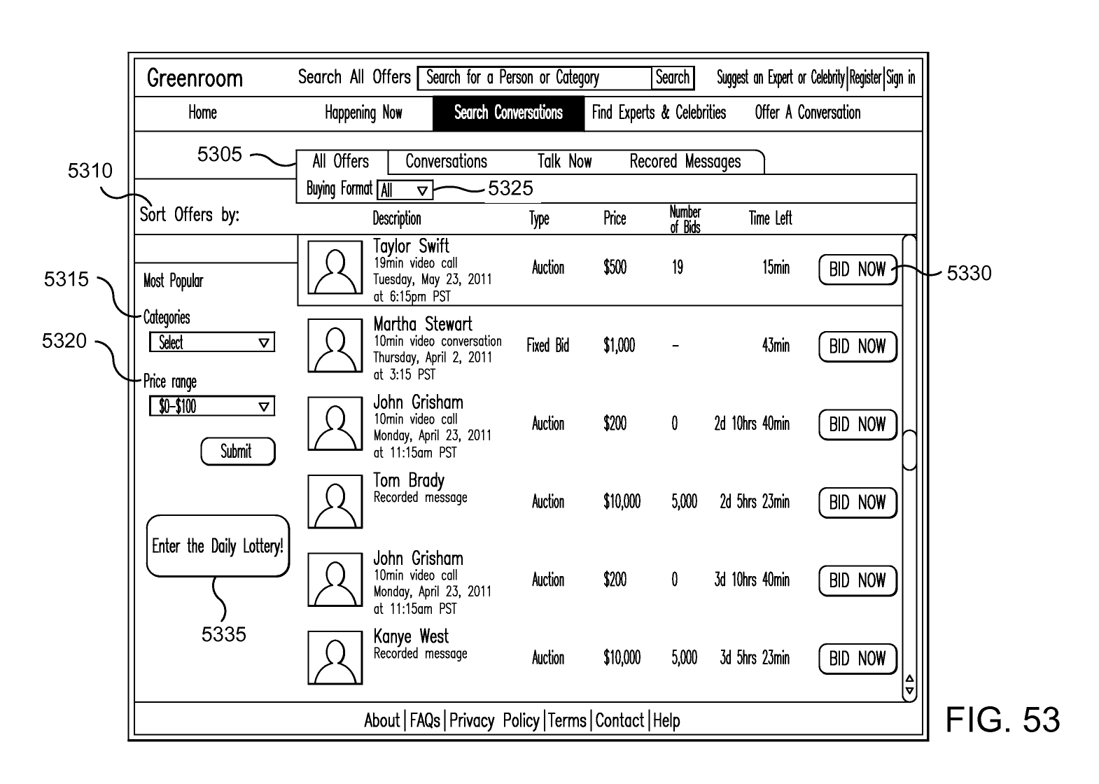

FIG. 53 shows an embodiment of how a user searches conversations. A guest can view and search offers by filtering through four tabs 5305. The tabs 5305 can include: all offers; conversations; talk now; and recorded messages. A guest can sort offers 5310 by “ending soon” to see offers about to expire or “most popular” to view offers with the most bids. Sorting offers 5310 is set by default to sort by “ending soon.” A guest can further sort these offers by description, type, price, number of bids, and time left by clicking the column headers. A guest can sort offers by selecting expert and celebrity categories from the drop-down menu 5315. A guest can sort offers by selecting a price range from the drop-down menu 5320. A guest can sort offers by selecting a buying format from the drop-down menu 5325. The options can include “auction,” “buy now” and/or “all.” A guest can select the BID NOW! and/or BUY NOW! buttons 5330 to purchase or bid on items. A guest can enter the daily lottery offering 5335 from this page.

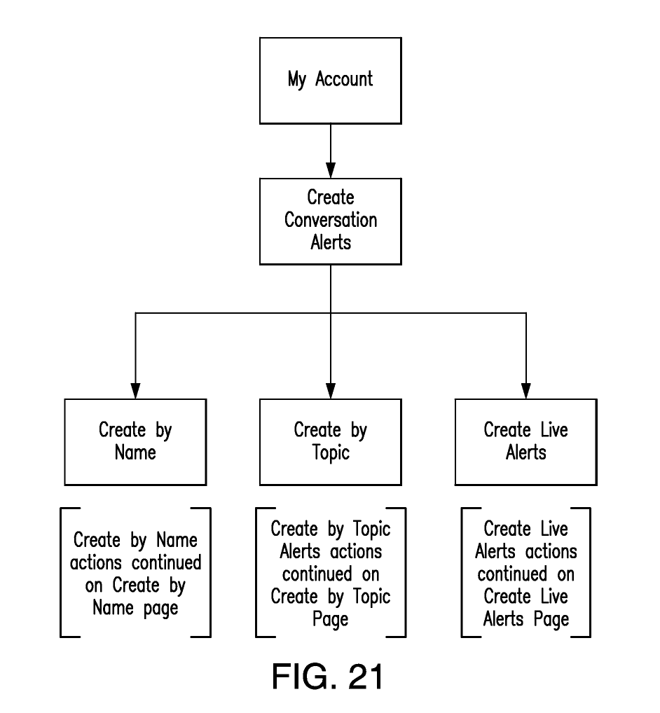

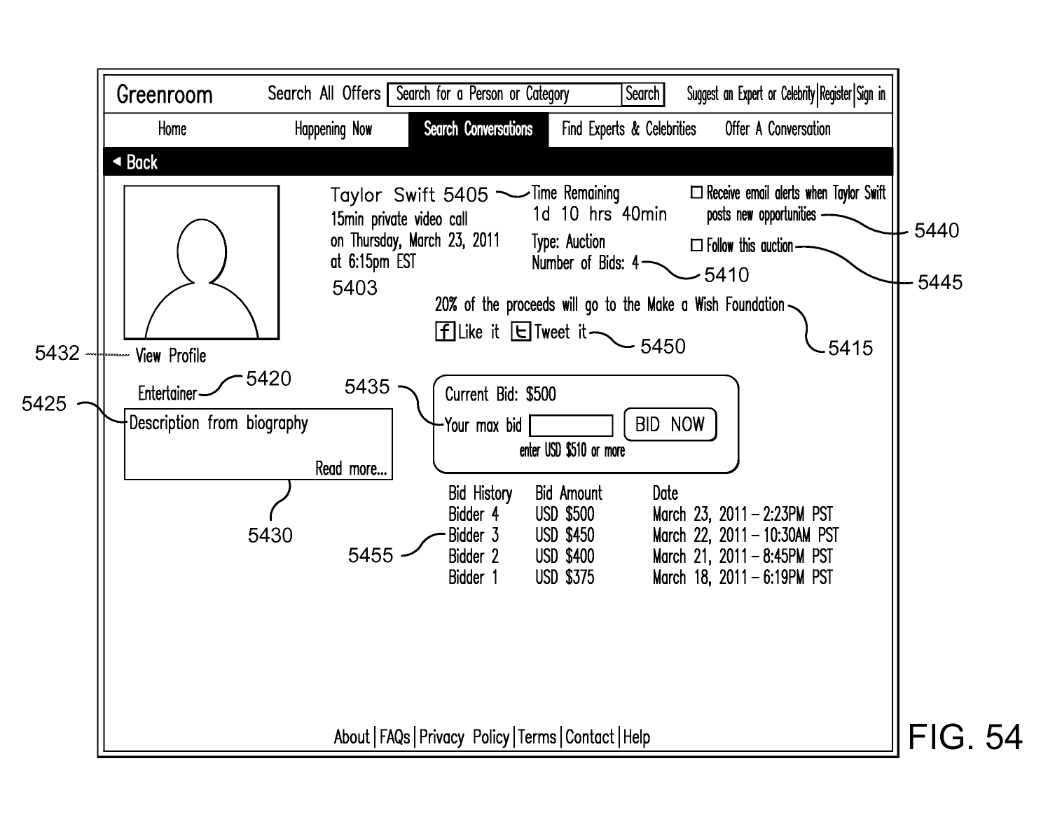

FIG. 54 shows an embodiment of an offer details page. A guest can view an offer detail by selecting an offer as described in FIG. 53 above. In an embodiment, an offer's duration, date, and time 5403 are noted at the top of the page. In an embodiment, the offer type, time remaining 5405, and number of bids 5410 are also noted at the top of the page. In an embodiment, the charity name for donation and percentage to be donated 5415 are also noted at the top of the page. In an embodiment, industry categories 5420 are included as well as a few lines from the expert or celebrity's biography 5425. The rest of the biography 5425 can be viewed if the guest clicks on the bio's “read more” link 5430. Clicking that link 5430 or the “view profile” link 5432 directs guests to the expert or celebrity's GreenRoom profile page. A guest can add a bid amount 5435 to begin their bidding process. In an embodiment, the system does not allow the guest to bid a lower amount than the current highest bid. A guest can add a specific expert or celebrity to their watch list 5440, and is notified by email whenever a new offer is posted by the expert or celebrity. A guest can “follow this auction” 5445 to receive email alerts on the offer's status. For example, FIG. 21 shows an embodiment of creating a conversation alert. A guest can share the offer on Facebook or Twitter 5450 via editable, pre-populated announcements. A guest can also view the bid history 5455 of the auction on this page, including details such as the username of previous bidders, the bid amount, and date/time of previous bids.

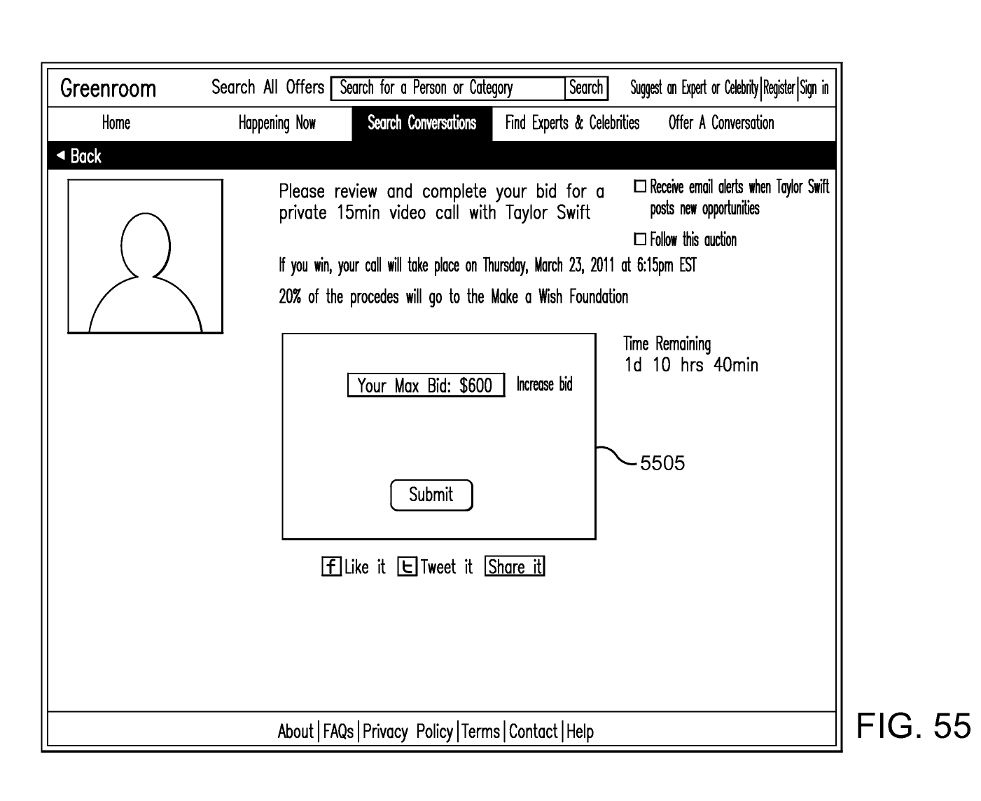

FIG. 55 shows an embodiment of a review page a user sees prior to submitting a bid. A guest can review, increase, and/or submit their bid amount on this page 5505. A guest can check the box to receive email alerts 5440 from the expert or celebrity, for example, to keep up with new postings, or “follow this auction” 5445 to receive email alerts on the offer's status.

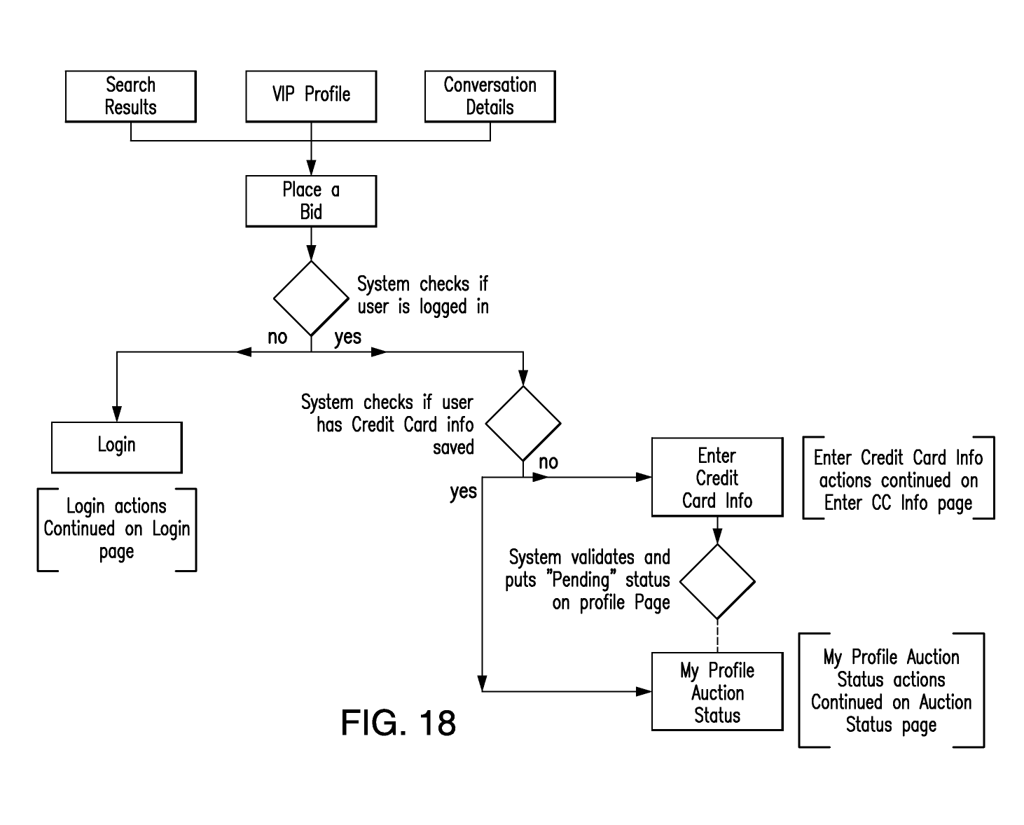

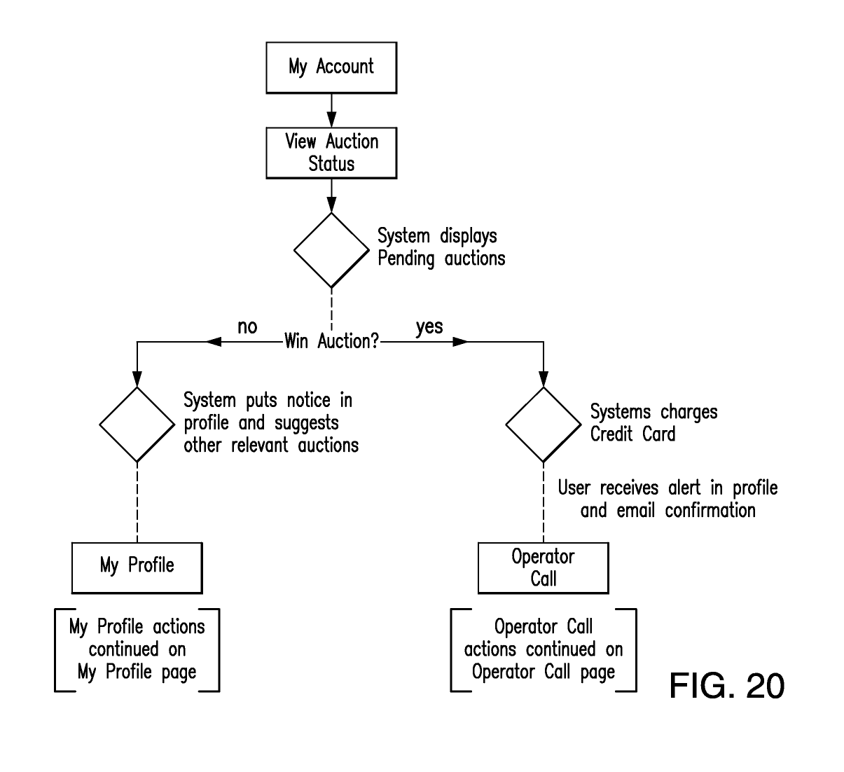

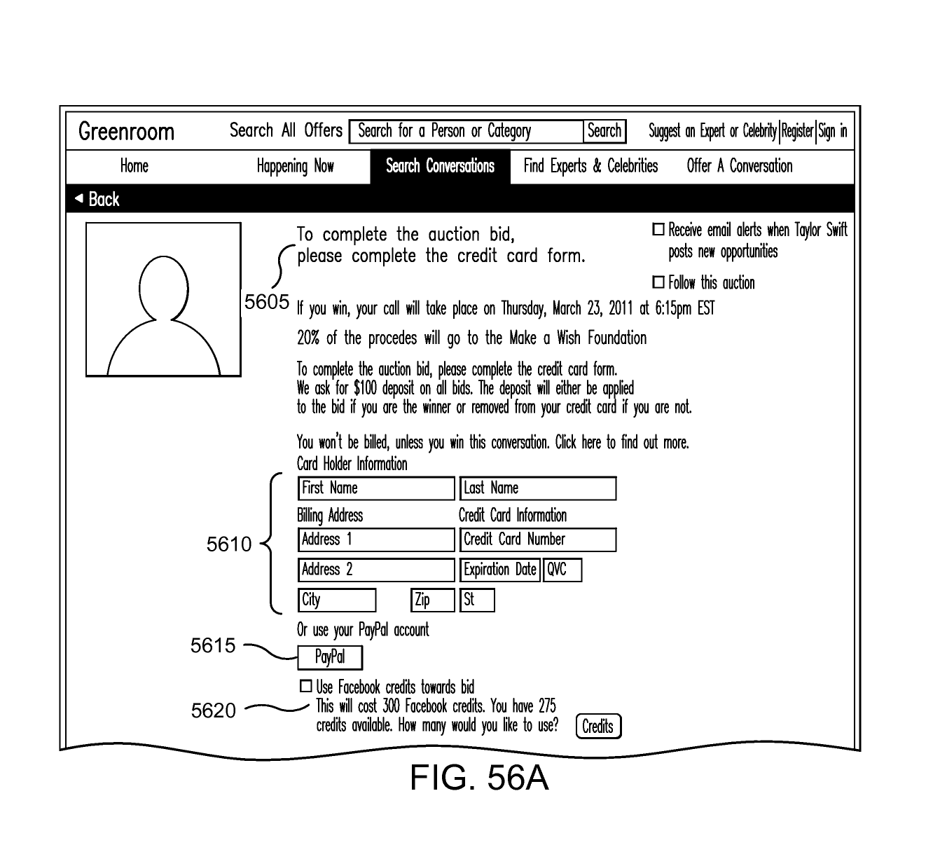

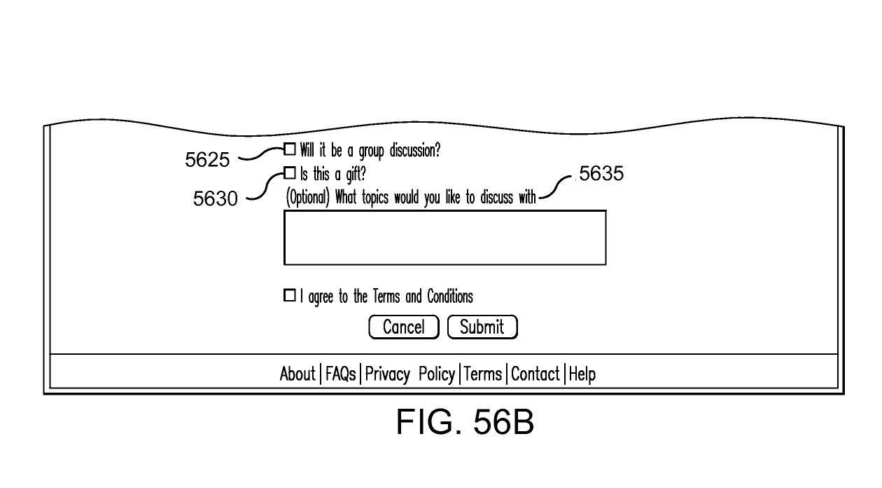

FIGS. 56A and 56B show an embodiment of a credit card information page after submitting the bid as described in FIGS. 54 and 55. A guest must enter credit card information to complete their bid 5605. The required fields to be completed include first name, last name, billing address and credit card number with an expiration date and security code 5610. For example, FIG. 18 shows an embodiment of a process for placing a bid. Conversations and messages can be purchased with a credit card, Paypal 5615 and/or Facebook credits 5620 that are applied to either a portion or the total purchase price. For example, FIG. 20 shows an embodiment of a process for auctioning a conversation. A guest can be prompted to indicate whether their call is a group discussion 5625 and/or a gift 5630. In an embodiment where the conversation is a group conversation, the bid winner receives a confirmation email when they win and where they can enter the email addresses of up to ten other participants. The additional participants receive access codes and/or invitations to join GreenRoom if they are not already members. When the participants are members they can receive their access codes. In embodiments, a winning confirmation email also asks for information about the person receiving the conversation as a gift. In an embodiment, when a conversation is won, guests can optionally enter the desired conversation topics 5635 for their call. The information entered is visible to both parties during the conversation. A guest can submit the information on this page to finalize their bid. The guest receives a confirmation email with further details and the status of their bid. A guest can share their bids on public offers directly to Facebook and Twitter with pre-populated, editable announcements (not shown). Both the winner of the auction and the expert and/or celebrity can receive automatic email reminders leading up to the call.

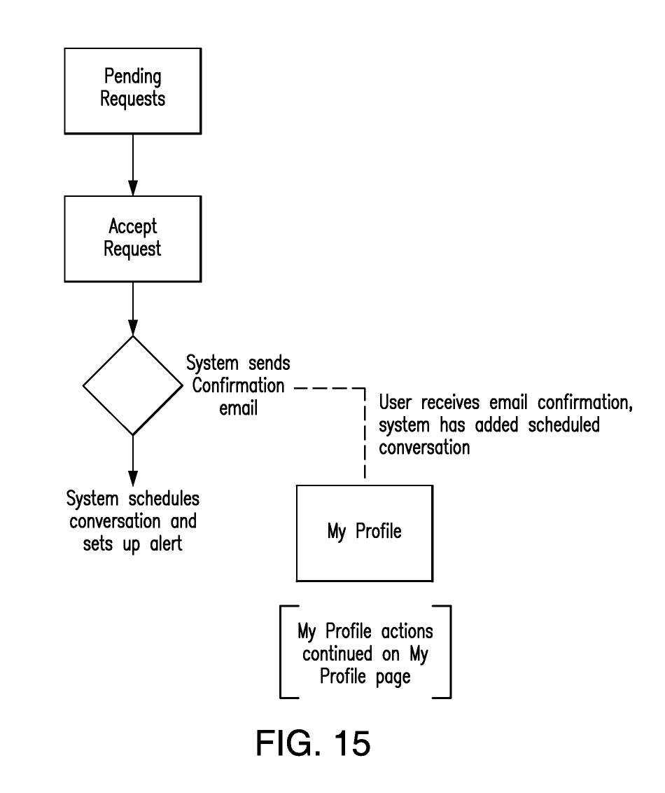

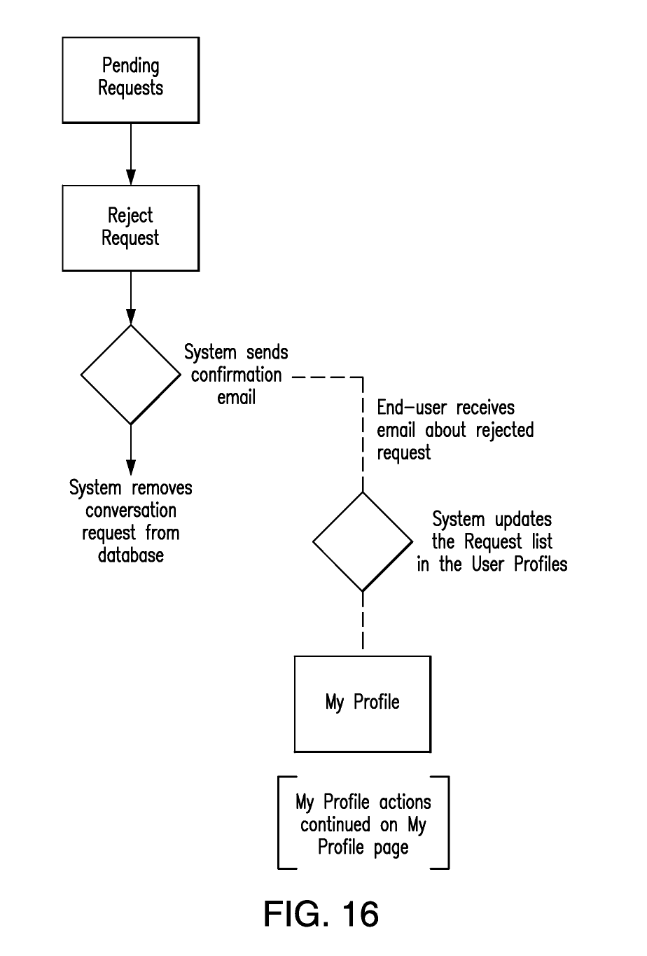

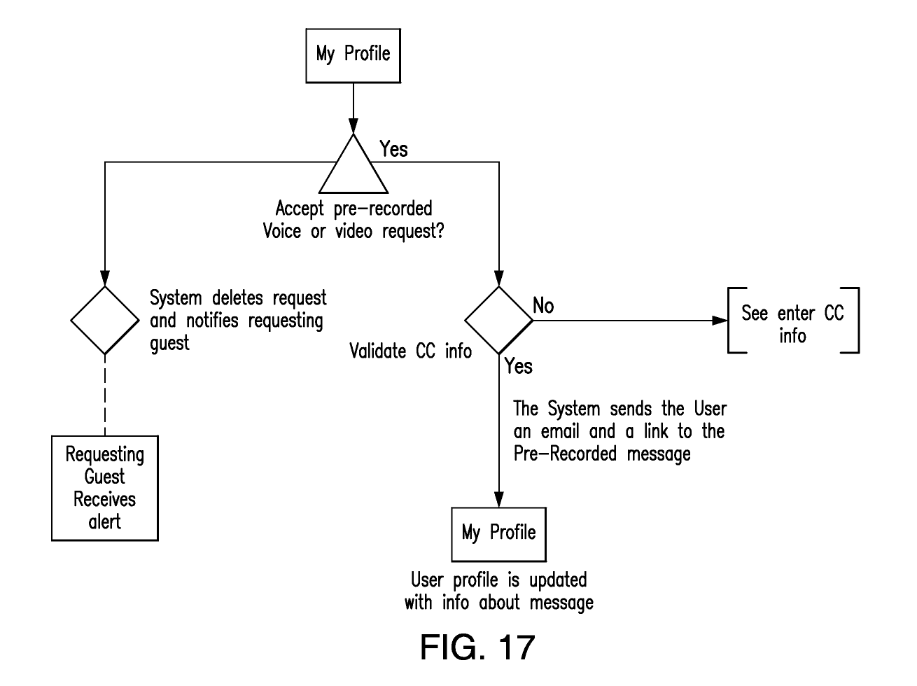

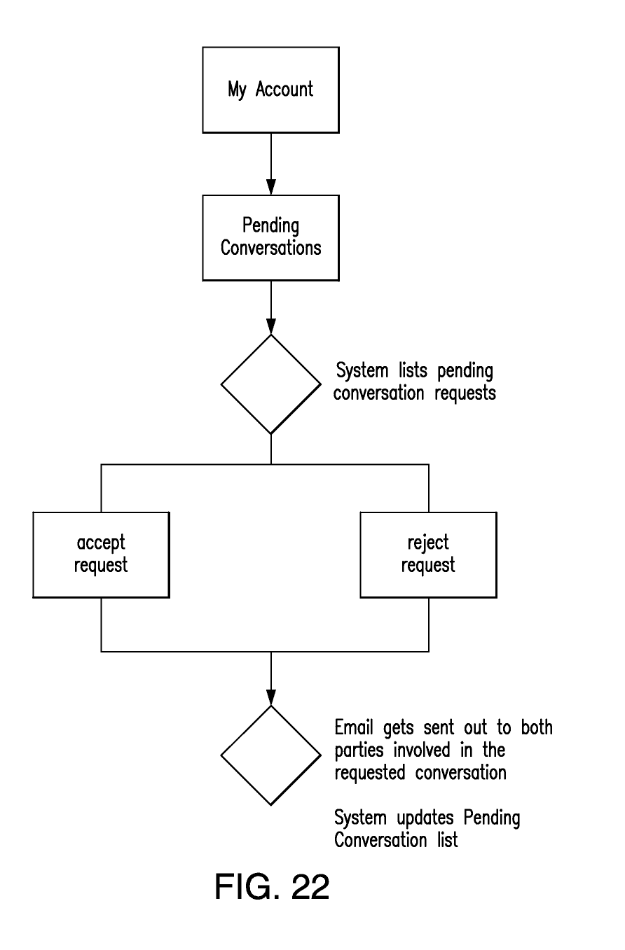

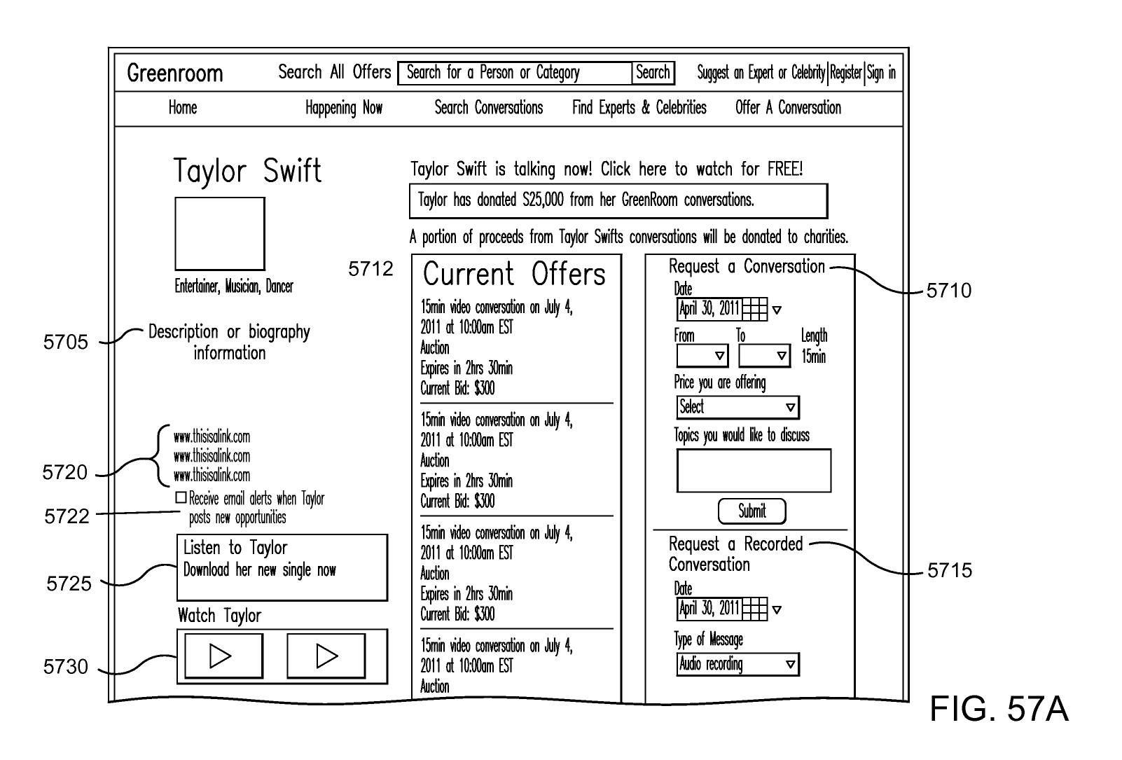

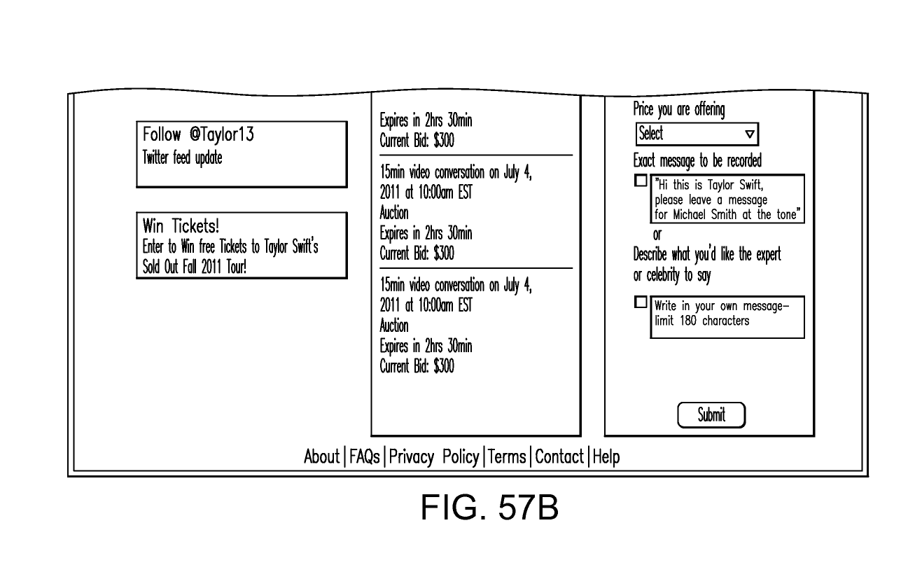

FIGS. 57A and 57B show an embodiment of a public profile page for an expert and/or celebrity. Expert and/or celebrity profiles can include their industry categories and biography 5705. In embodiments, a guest can request a conversation or recorded message 5710 from this page if the expert and/or celebrity has chosen to be open to these requests. The guest can propose a date, time, length, price, and/or topics they would like to discuss. Users send the expert and/or celebrity a requested time and fee. For example, a guest can request a conversation for a kid's birthday party on Sunday at 4 pm, or a book group. Experts and/or celebrities can accept or deny these requests from the Schedule Tab of their account (described below). For example, FIG. 15 shows an embodiment of a process for accepting a request, and FIG. 16 shows an embodiment of a process for rejecting a request. FIG. 22 shows an embodiment for accepting or rejecting a request for a pending conversation. The guest can receive a confirmation email if their conversation has been accepted or not. In embodiments, a guest can request a recorded message 5715 from experts and/or celebrities. The guest can choose a recorded message or customize a message themselves. FIG. 17 shows an embodiment of a process for accepting or rejecting a request for a recorded message. The options to request a conversation 5710 and request a recorded message 5715 do not appear in an expert and/or celebrity's profile if the expert and/or celebrity does not offer these requests. In embodiments, current offers 5712 from the expert and/or celebrity are viewable on this page. By selecting an offer, the guest is directed to the auction details page for more information and to place a bid and/or make a purchase. In embodiments, a guest can view and access website links 5720 supplied by the expert and/or celebrity. Generally, the page can show up to three website links 5720. The guest can opt to receive email alerts 5722 to be notified when the expert or celebrity posts a new offer. The guest can view promotions and sales 5725 listed by the expert or celebrity. The guest can watch embedded videos 5730 chosen and supplied by the expert and/or celebrity. Generally, the page can show up to two embedded videos. In embodiments, the videos 5730 include public GreenRoom conversation videos. In embodiments, the videos 5730 include videos other than GreenRoom conversation videos. A guest can share the expert or celebrity's public facing profile on Facebook or Twitter with pre-populated announcements with editing capabilities (not shown).

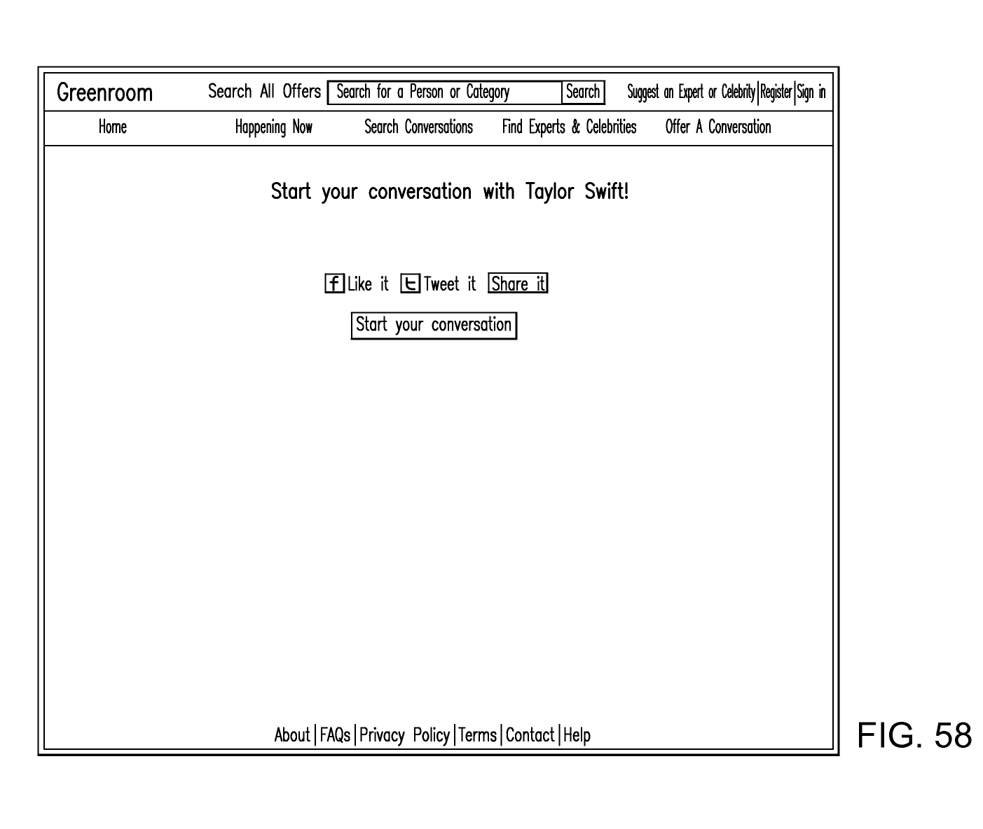

FIG. 58 shows an embodiment of a page to begin a conversation with an expert and/or celebrity. A guest can click a link in their email to begin their scheduled conversation. A guest can also click from within their account to begin their scheduled conversation. A guest can use Facebook “like it” to tell their friends that they “like” their conversation. The guest can then comment about it on Facebook. In embodiments, clicking on “Share it” gives the guest the opportunity to share with their friends that they are starting a conversation with an expert and/or celebrity. In embodiments, “Tweet it” allows the guests to tell their followers on Twitter about the start of their conversation.

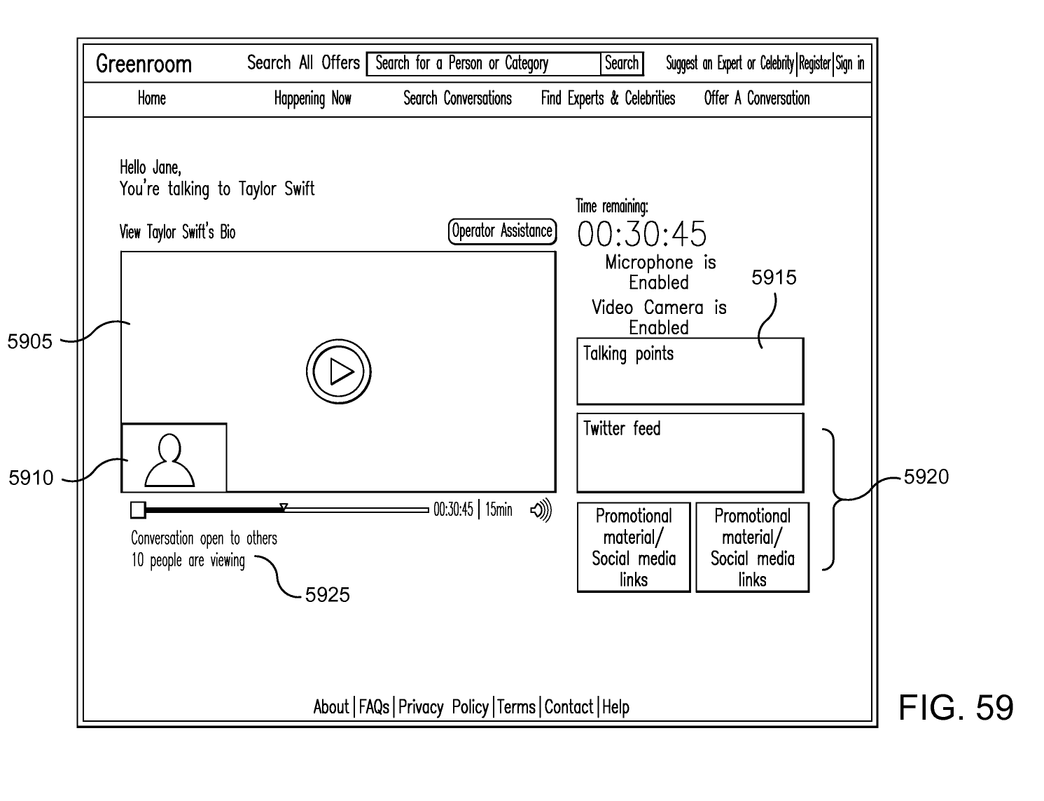

FIG. 59 shows an embodiment of a video call conversation page of a user. In embodiments, an operator initiates a conversation. A guest logs in to engage video chat 5905, for example, a video call. The operator can access every call for the duration unless it is designated as a private call (described below). The guest can view themselves in small video in the corner of screen 5910. As described above, talking points 5915 entered earlier by a guest when they purchased the conversation can appear to the right of the video screen. All parties can view this list 5915 during the conversation, including, for example, the operator, expert and/or celebrity, and guest. The guest can also view the expert and/or celebrity's promotional material, Twitter feed, and the expert and/or celebrity supplied social media links and websites 5920. In embodiments, the conversation is open to other users 5925. When the call is open for others to watch, it becomes viewable to the public for free. The guest and expert and/or celebrity can view the number of people watching from this screen. In embodiments, the text 5925 reads: “This conversation is (or is not) open to others for viewing” and/or “this conversation is (or is not) private.” For group conversations, a text box can allow others in the group to type questions to the expert and/or celebrity. In embodiments, this chat option does not appear in one-on-one conversations.

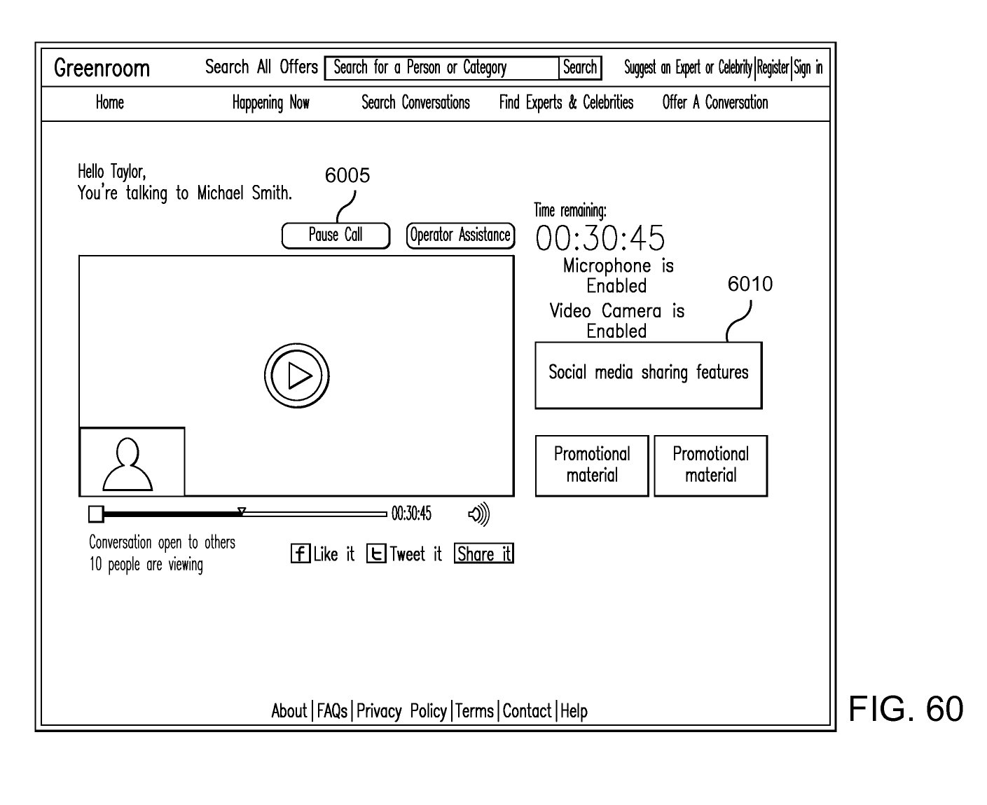

FIG. 60 shows an embodiment of a video call conversation page of an expert and/or celebrity. In embodiments, the call screen 5905 for an expert or celebrity is the same as a guest's with the addition of social media sharing features 6010, a pause call button 6005 and the absence of a Twitter stream. The expert and/or celebrity can flag a conversation. When flagged, the operator returns promptly and ends the call before its scheduled conclusion.

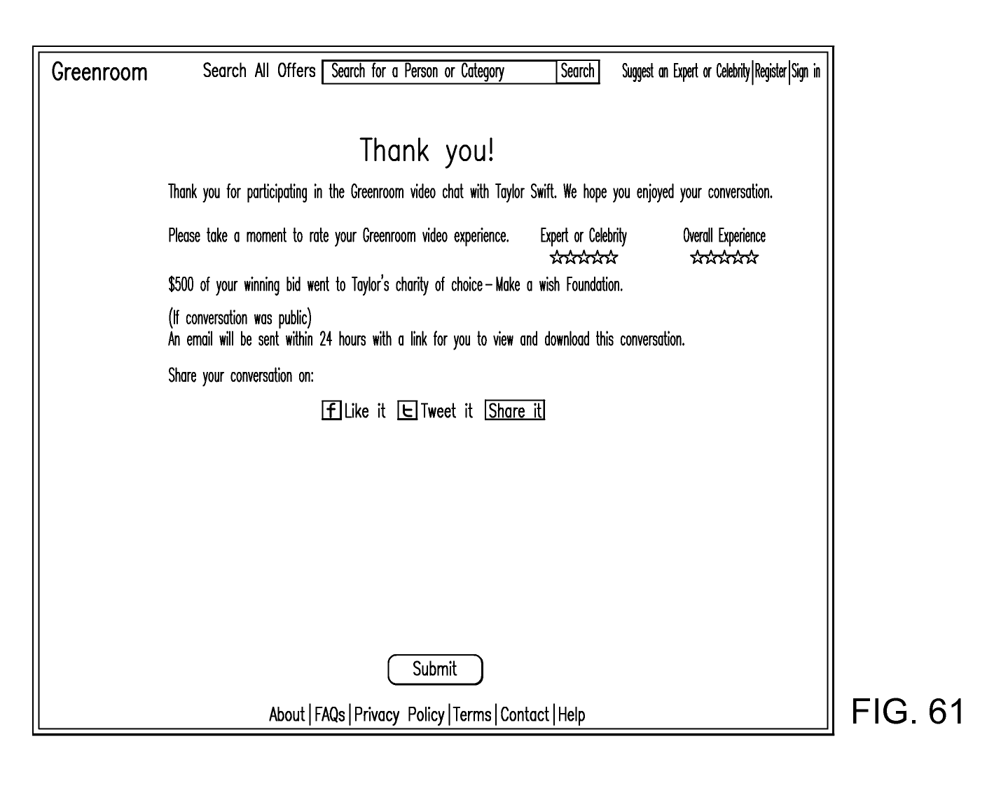

FIG. 61 shows an embodiment of a Thank You screen at the end of the conversation. The Thank You page appears at the end of every call and has an opportunity to rate the call. Experts, celebrities, and guests can rate their conversations. In an embodiment, a guest is notified of the amount of money that was donated to charity from their conversation. In embodiments, if the call is public, the expert or celebrity is notified that an email will be sent within 24 hours with a link to view and/or download this video. In embodiments, guests, experts and celebrities can share their live conversations on Facebook or Twitter with pre-populated announcements. In embodiments, guests are directed back to the “happening now” page after completing this screen.

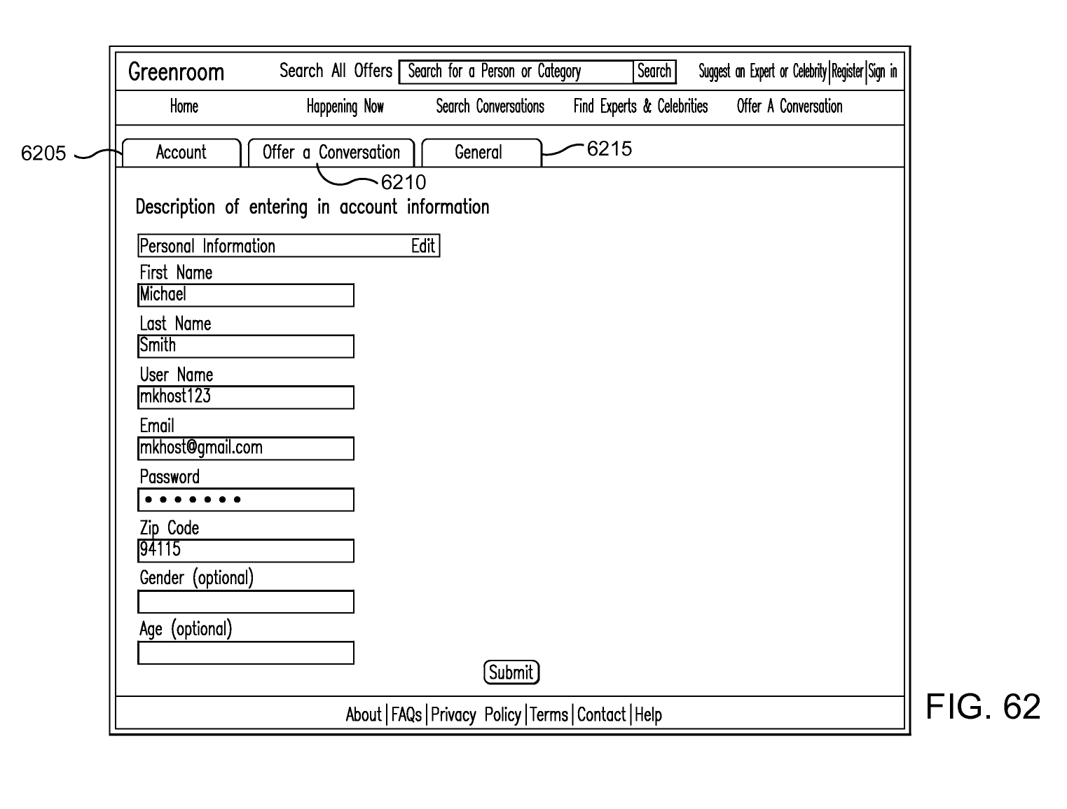

FIG. 62 shows an embodiment of an account page for experts, celebrities, and/or guests. In embodiments, experts, celebrities, and/or guests have three sections to manage their account: 1) Account; 2) Offer a Conversation; and 3) Calendar. The Account Tab 6205 includes private information. The Calendar tab 6215 can allow experts, celebrities, and/or guests to view their calendar. The Offer a Conversation tab 6210 can allow experts and/or celebrities to offer a conversation.

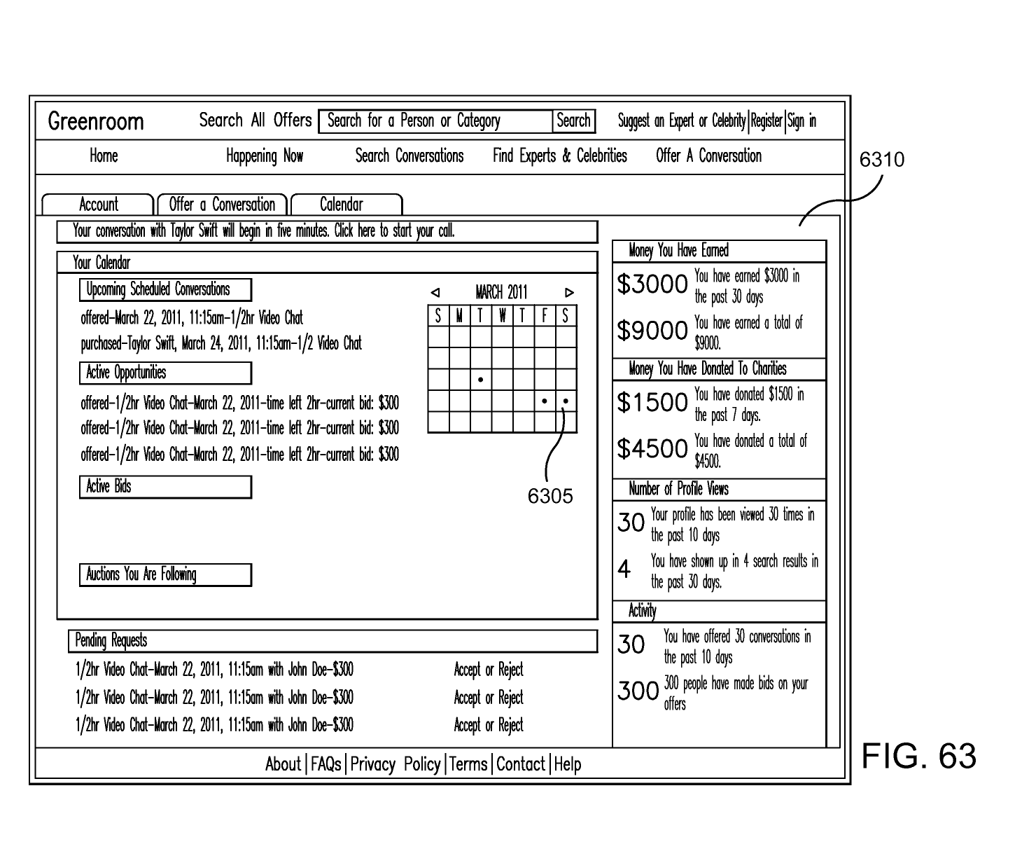

FIG. 63 shows an embodiment of a calendar page for experts, celebrities, and/or guests. On the Calendar tab 6215 in FIG. 63, one or more dots 6305 on the calendar can denote scheduled conversations. The dots 6305 can be selected to view upcoming conversation details. In embodiments, a screen pop-out gives more information about the conversation including the date; time; conversation bid price; charity name; and/or amount to charity. In embodiments, an expert and/or celebrity can reschedule an offered conversation from the calendar pop-out. The expert or celebrity can reschedule conversations by selecting the scheduled call and entering three new dates and times that they are available. The guest is notified by email and can accept one of the three proposed dates. The expert or celebrity is notified of the new conversation date. In embodiments, the guest can also contact GreenRoom call an 800 number to receive assistance with rescheduling or request a refund. In embodiments, experts and/or celebrities can be charged for each call they re-schedule. In embodiments, experts and/or celebrities can watch the activity of their account. Side bar information 6310 showing account activity can be shown on the Calendar tab 6215. In embodiments, the side bar information 6310 is present if the expert and/or celebrity has offered a conversation. Account activity can include how many conversations they have offered and how many bids have been placed on their conversations. In embodiments, the expert and/or celebrity can see the number of people searching for them and viewing their profile. Experts and/or celebrities can see how much money they have earned from GreenRoom and how much they have donated to charity.

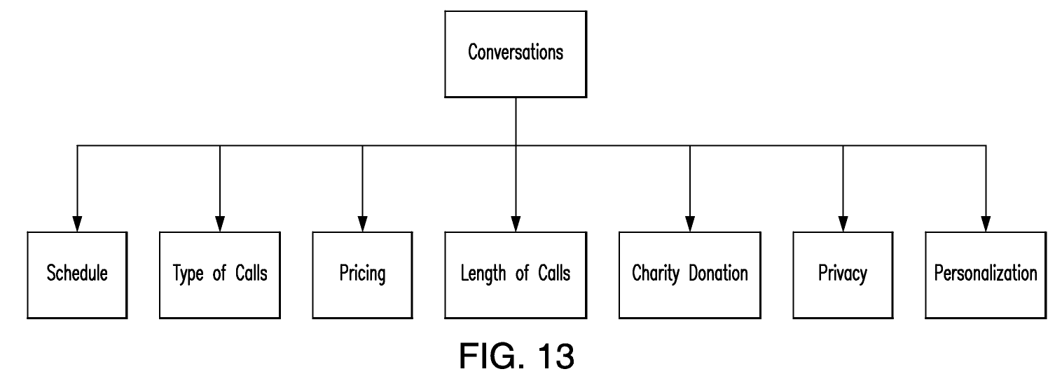

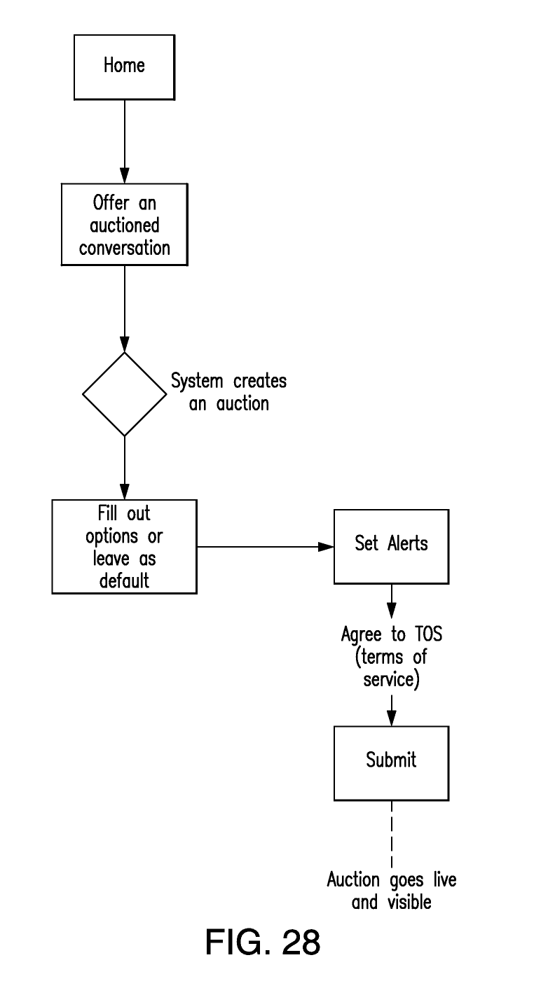

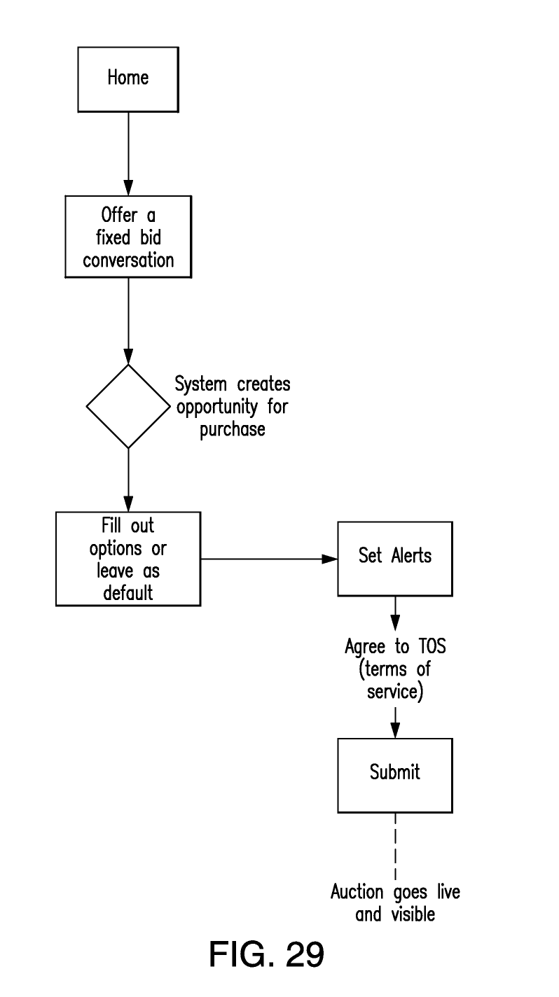

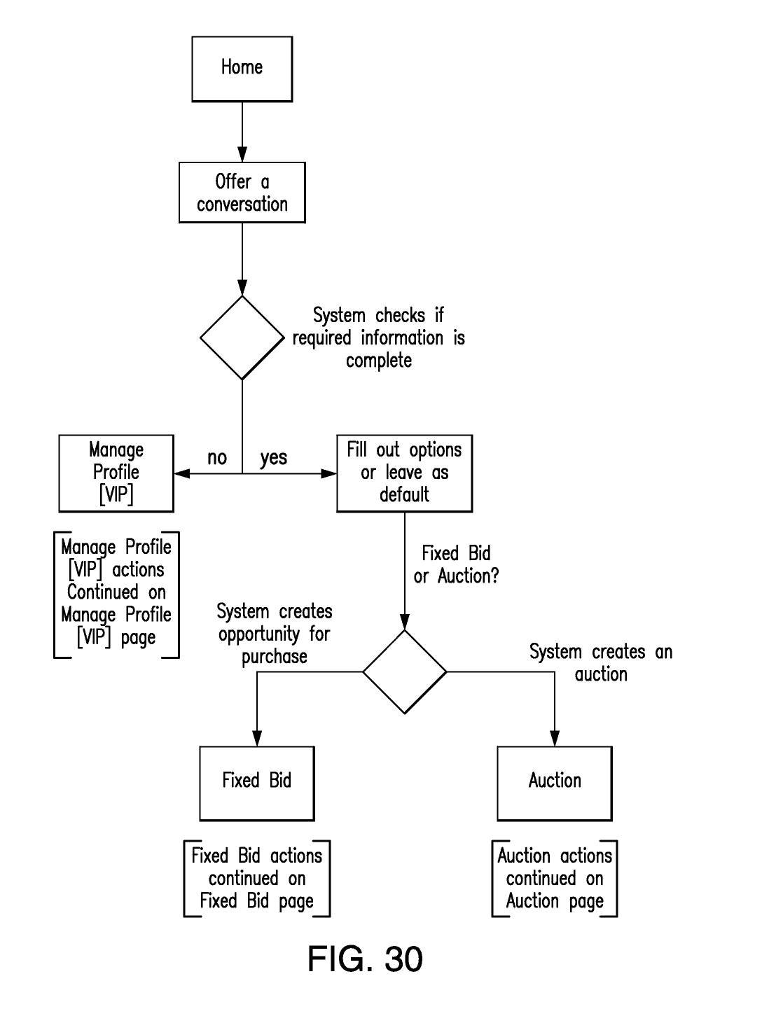

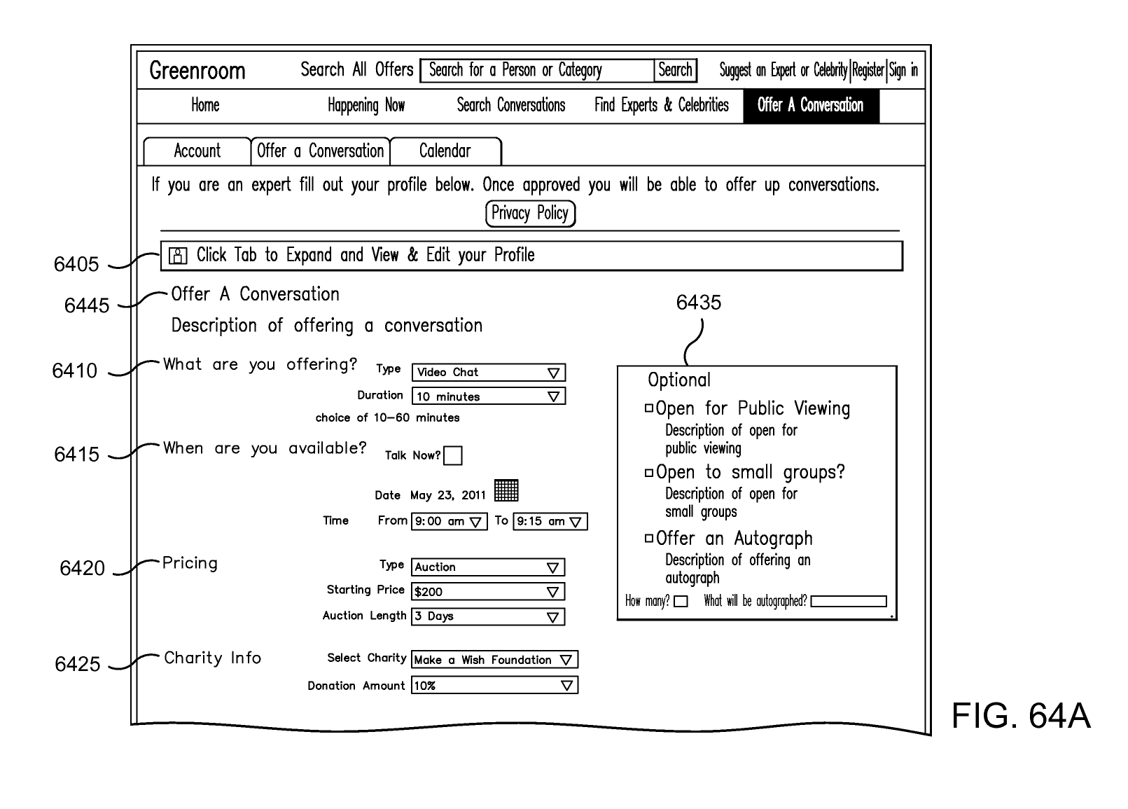

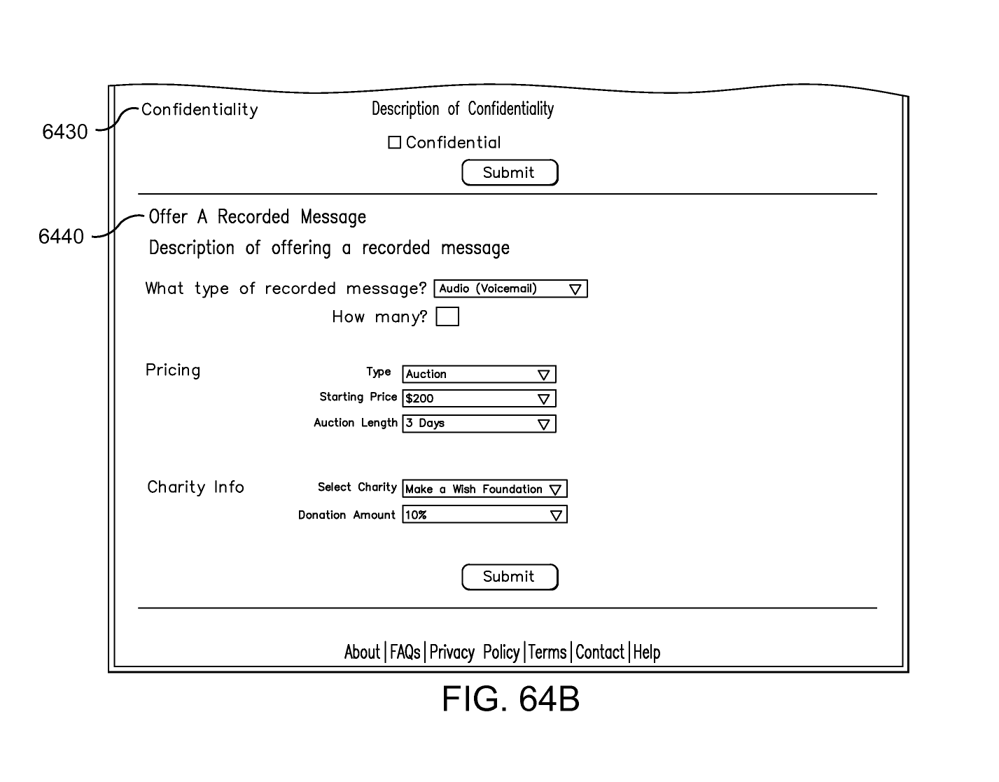

FIGS. 64A and 64B show an embodiment of a page for an expert and/or celebrity to offer a conversation. In an embodiment, the expert and/or celebrity can offer a conversation using the Offer a Conversation tab 6210. As shown in FIG. 13, several conversation actions are available to select. In embodiments the expert and/or celebrity's profile is editable from this page, as described above with respect to FIG. 45. The profile is collapsible 6405, with the “Offer a Conversation” 6445 and “Offer a Recorded Message” 6440 options below. In embodiments, to offer a conversation, an expert and/or celebrity describes the offer. The description of the offer can include “What are you offering?” 6410. The type of offer can include a type of chat and duration of the chat to select from a drop down menu. The description of the offer can include “When are you available?” 6415. The expert and/or celebrity can select to talk now, or alternatively, a date and time can be selected. The description of the offer can include the pricing 6420. The pricing 6420 can include the type, for example, an auction and/or a fixed price. FIG. 28 shows an embodiment of a process for offering an auctioned conversation. FIG. 29 shows an embodiment of a process for offering a fixed bid conversation. FIG. 30 shows an embodiment of a process for offering a conversation. The pricing 6420 can include a starting price. The pricing 6420 can include an auction length. The description of the offer can include information about a charity 6425. Charity information 6425 can include designating a specific charity. Charity information 6425 can include selecting a donation amount, and/or percentage, from drop down menus. The description of the offer can include confidentiality 6430. Confidentiality settings 6430 can be selected. For example, if the expert and/or celebrity offers a private call, no operator is on the line. The expert and/or celebrity can submit the offer after entering in the description of the offer. The expert and/or celebrity can also select additional conversation details 6435 for their offer. An expert and/or celebrity can select an “Open for Public Viewing” option. “Open for Public Viewing” can allow other guests to watch a conversation. An expert and/or celebrity can select an “Open to Small Groups” option. “Open to Small Groups” can allow up to ten guests to participate in a conversation. An expert and/or celebrity can select an “Offer an Autograph” option. “Offer an Autograph” can allow the expert and/or celebrity to provide an autograph during the call. An expert and/or celebrity can also offer a recorded message 6440. Options for offering a recorded message include choosing a type, for example, video or audio. Another option for offering a recorded message can include choosing pricing information. Another option for offering a recorded message can include choosing charity information.

Embodiments of the present invention provide for a codec, device, and/or computer program for encoding and/or decoding a digital data stream and/or signal to effect the various connections of the present invention.

The various computer languages and applications described herein may utilize Ruby on Rails, Async processing, cloud formation from Amazon.com, Javascript, and Puppet. The embodiments can utilized a load balancer from Amazon or other provider to handle a heavy load of users of the social media site.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine read able (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms. The methods and systems described herein can also be implemented using cloud-based storage and facilities and tools.

Although the present invention has been described with reference to particular examples and embodiments, it is understood that the present invention is not limited to those examples and embodiments. The present invention includes variations from the specific examples and embodiments described herein. The examples and embodiments described herein may be used with and without each other in varying combinations. Except to the extent necessary or inherent in the processes themselves, no particular order to steps or stages of methods and/or processes described in this disclosure, including the figures, is implied. In many cases, the order of process steps may be varied without changing the purpose, effect or import of the methods described.

What is claimed is:

1. A system for communication, comprising:
via the Internet, initializing a connection by a first entity to a service;
connecting the first entity with a second entity via the Internet;
connecting the first entity with a third entity;
connecting the second entity with a third entity;
wherein, the third entity controls the communication access between the first and second entities.

2. A method for communication, comprising:
initializing a connection by a first entity to a service via the Internet;
connecting the first entity with a second entity via the Internet;
connecting the first entity with a third entity;
connecting the second entity with a third entity;
wherein, the third entity controls the communication access between the first and second entities.
